(19) United States
(12) Patent Application Publication
(10) Pub. No.: US 2025/0104083 A1
(43) Pub. Date: Mar. 27, 2025

(54) SYSTEM AND NON-TRANSITORY STORAGE MEDIUM

(71) Applicant: TOYOTA JIDOSHA KABUSHIKI KAISHA, Toyota-shi (JP)

(72) Inventors: Teruyoshi FUJIWARA, Toyota-shi (JP); Iwao NITTA, Nagoya-shi (JP); Ryota SUZUKI, Ikeda-shi (JP)

(73) Assignee: TOYOTA JIDOSHA KABUSHIKI KAISHA, Toyota-shi (JP)

(21) Appl. No.: 18/826,833

(22) Filed: Sep. 6, 2024

(30) Foreign Application Priority Data
Sep. 22, 2023 (JP) 2023-159262

(51) Int. Cl. G06Q 20/40

(52) U.S. Cl. CPC G06Q 20/405; G06Q 20/4014

(57) ABSTRACT

In a system, a first terminal of a proxy individual of a first target receives authority imparting information from a terminal of a proxy requesting individual of the first target. A second terminal of a target individual of a second target requests verification of an agency in response to a request from the first terminal. According to success of the verification, at least one of the first terminal and the second terminal transmits a linking demand toward a management server. The management server sets a correspondence relation between the proxy requesting individual and the target individual according to authentication for the proxy requesting individual being successful to enable proxy exercise of an authority of the proxy requesting individual by the proxy individual via the target individual.

### CROSS REFERENCE TO THE RELATED APPLICATION

This application claims the benefit of Japanese Patent Application No. 2023-159262, filed on Sep. 22, 2023, which is hereby incorporated by reference herein in its entirety.

### BACKGROUND

### Technical Field

The present disclosure relates to a system and a program.

### Description of the Related Art

Japanese Patent Application Laid-Open No. 2022-140747 proposes a charge collection system for collecting a charge for a service from a user of a vehicle using a medium such as a card. Specifically, the charge collection system proposed by Japanese Patent Application Laid-Open No. 2022-140747 is configured to allocate billing of a usage fee for a freeway by a target rent-a-car to a target user based on an ID of an ETC (Electronic Toll Collection System) card, a company of the rent-a-car, a date and time of use of the rent-a-car, and a correspondence relation (billing information, registration information, settlement information, and use information) of the user of the rent-a-car.

### SUMMARY

An object of the present disclosure is to provide a technique for, while ensuring security, tracking a use relation between a first target and a second target and, while the use relation is established, imparting a proxy authority to a proxy individual.

A system according to a first aspect of the present disclosure includes a management server, a first terminal of a proxy individual of a first target, and a second terminal of a target individual of a second target. The first terminal is configured to receive, from a terminal of a proxy requesting individual of the first target, authority imparting information for notifying imparting of an agency, perform data exchange between the first terminal and the second terminal when a use relation occurs between the proxy individual and the target individual, and give authority verification information to the second terminal in the data exchange to request verification of the agency. The second terminal is configured to verify the agency using the authority verification information in response to the request from the first terminal. At least one of the first terminal and the second terminal is configured to transmit a linking demand including an authentication request for the proxy requesting individual toward the management server according to success of the verification by the second terminal. The management server is configured to set, according to authentication for the proxy requesting individual responding to the authentication request being successful, a correspondence relation between the proxy requesting individual and the target individual to thereby enable proxy exercise of an authority of the proxy requesting individual by the proxy individual via the target individual.

A program according to a second aspect of the present disclosure is a program for causing a first terminal of a proxy individual of a first target to execute: receiving, from a terminal of a proxy requesting individual of the first target, authority imparting information for notifying imparting of an agency; performing data exchange between the first terminal and a second terminal of a target individual when a use relation occurs between the proxy individual and the target individual; giving authority verification information to the second terminal in the data exchange to request verification of the agency; and transmitting, according to success of the verification by the second terminal, a linking demand including an authentication request of the proxy requesting individual toward a management server, transmitting the linking demand in cooperation with the second terminal, or causing the second terminal to transmit the linking demand to thereby cause the management server to set, according to authentication for the proxy requesting individual responding to the authentication request being successful, a correspondence relation between the proxy requesting individual and the target individual to enable proxy exercise of an authority of the proxy requesting individual by the proxy individual via the target individual.

A program according to a third aspect of the present disclosure is a program for causing a second terminal of a target individual of a second target to execute: performing data exchange between the second terminal and a first terminal of a proxy individual of a first target when a use relation occurs between the proxy individual and the target individual; receiving a request for verification of an agency involving authority verification information from the first terminal in the data exchange; verifying the agency using the authority verification information in response to the request from the first terminal; and transmitting, according to success of the verification, a linking demand including an authentication request of the proxy requesting individual toward a management server, transmitting the linking demand in cooperation with the first terminal, or causing the first terminal to transmit the linking demand to thereby cause the management server to set, according to authentication for the proxy requesting individual responding to the authentication request being successful, a correspondence relation between the proxy requesting individual and the target individual to enable proxy exercise of an authority of the proxy requesting individual by the proxy individual via the target individual.

According to the present disclosure, it is possible to provide a technique for, while ensuring security, tracking a use relation between a first target and a second target and, while the use relation is established, imparting a proxy authority to a proxy individual.

### BRIEF DESCRIPTION OF THE DRAWINGS

FIG. 1 schematically illustrates an example of a scene to which the present disclosure is applied;

FIG. 2 schematically illustrates an example of a scene to which the present disclosure is applied;

FIG. 3A schematically illustrates an example of linking information according to an embodiment;

FIG. 3B schematically illustrates an example of user information according to the embodiment;

FIG. 3C schematically illustrates an example of mobile body information according to the embodiment;

FIG. 4 schematically illustrates an example of data exchange according to the embodiment;

FIG. 5A schematically illustrates an example of a verification process for an agency according to the embodiment;

FIG. 5B schematically illustrates an example of a verification process for an agency according to the embodiment;

FIG. 6 schematically illustrates an example of a linking release process according to the embodiment;

FIG. 7A schematically illustrates an example of a linking release process by a proxy requesting individual according to the embodiment;

FIG. 7B schematically illustrates an example of a linking release process by the proxy requesting individual according to the embodiment;

FIG. 8 schematically illustrates an example of use continuation check processing according to the embodiment;

FIG. 9 schematically illustrates an example of a use scene of linking information according to the embodiment;

FIG. 10A schematically illustrates an example of a hardware configuration of a management server according to the embodiment;

FIG. 10B schematically illustrates an example of a hardware configuration of a first server according to the embodiment;

FIG. 10C schematically illustrates an example of a hardware configuration of a second server according to the embodiment;

FIG. 10D schematically illustrates an example of a hardware configuration of a first terminal according to the embodiment;

FIG. 10E schematically illustrates an example of a hardware configuration of a second terminal according to the embodiment;

FIG. 10F schematically illustrates an example of a hardware configuration of a terminal according to the embodiment;

FIG. 11 schematically illustrates an example of software configurations of devices according to the embodiment;

FIG. 12A illustrates an example of a processing procedure of linking setting according to the embodiment;

FIG. 12B illustrates an example of a processing procedure of linking release according to the embodiment;

FIG. 13A schematically illustrates an example of a processing process of authentication in the case in which a first authentication method is adopted;

FIG. 13B schematically illustrates an example of a processing process of authentication in the case in which the first authentication method is adopted;

FIG. 14A schematically illustrates an example of a processing process of authentication in the case in which a second authentication method is adopted;

FIG. 14B schematically illustrates an example of a processing process of authentication in the case in which the second authentication method is adopted;

FIG. 15A schematically illustrates an example of a processing process of authentication in the case in which a 3-1-th authentication method is adopted;

FIG. 15B schematically illustrates an example of a processing process of authentication in the case in which the 3-1-th authentication method is adopted;

FIG. 16A schematically illustrates an example of a processing process of authentication in the case in which a 3-2-th authentication method is adopted; and

FIG. 16B schematically illustrates an example of a processing process of authentication in the case in which the 3-2-th authentication method is adopted.

### DESCRIPTION OF THE EMBODIMENTS

With the system proposed by Japanese Patent Application Laid-Open No. 2022-140747, a user can perform payment of a freeway toll by the ETC even if the user does not carry an ETC card of the user. However, the present inventors have found that the system of the related art has the following problems.

According to diversification of MaaS (Mobility as a Service), from the viewpoint of efficiency of settlement and convenience of, for example, use of a prescription, a demand for, while ensuring security, tracking use of a mobile body by another person responding to a request of a user and imparting proxy authority to the other person while the other person is using the mobile body is considered to occur.

For example, a case is assumed in which, when a prescription is issued to a certain person (a requesting person/a proxy requesting individual), an authority for exercising the issued prescription by proxy is imparted to another person (a requested person/a proxy individual) who uses the mobile body. In this case, it is assumed that, while the other person is using the mobile body, the certain person asks the other person to acquire a drug by proxy using the prescription. In contrast, in the system of the related art, a correspondence relation between a date and time of use and a user can be retained as use information according to a contrast or a reservation of a rent-a-car. However, since the date and time of use depends on the contract or the reservation, the use information does not always match an actual use of the rent-a-car by the user. In addition, in a vehicle (for example, a private vehicle) used without involving a contrast or a reservation, generation of use information is not assumed in the first place. Further, since use information is generated in response to a request of a user, the use information merely indicates use of the user. It is difficult to track use of another person. Therefore, in the system of the related art, it is difficult to, while ensuring security, track use of the mobile body by the other person responding to the request of the user and impart a proxy authority to the other person while a use relation is established. Note that this problem occurs not only in a scene in which a vehicle is used. The same problem can occur in a scene in which a mobile body (for example, an aircraft or a ship) other than the vehicle is used and a scene in which a plurality of types of mobile bodies are used. Further, the same problem can occur in all use scenes other than the use of the mobile body.

In contrast, a system according to a first aspect of the present disclosure includes a management server, a first terminal of a proxy individual of a first target, and a second terminal of a target individual of a second target. The first terminal is configured to receive, from a terminal of a proxy requesting individual of the first target, authority imparting information for notifying imparting of an agency, perform data exchange between the first terminal and the second terminal when a use relation occurs between the proxy individual and the target individual, and give authority verification information to the second terminal in the data exchange to request verification of the agency. The second terminal is configured to verify the agency using the authority verification information in response to the request from the first terminal. At least one of the first terminal and the second terminal is configured to transmit a linking demand including an authentication request for the proxy requesting individual toward the management server according to success of the verification by the second terminal. The management server is configured to set, according to success of authentication for the proxy requesting individual responding to the authentication request, a correspondence relation between the proxy requesting individual and the target individual to thereby enable proxy exercise of an authority of the proxy requesting individual by the proxy individual via the target individual.

In the first aspect of the present disclosure, it is possible to track, with setting of the correspondence relation (linking) between the proxy requesting individual of the first target and the target individual of the second target, the use relation between the proxy individual and the target individual responding to the request of the proxy requesting individual. In addition, it is possible to ensure security with verification processing for the agency and authentication processing for the proxy requesting individual of the first target. The proxy exercise of the authority of the proxy requesting individual by the proxy individual via the target individual is enabled according to the setting of the correspondence relation between the proxy requesting individual and the target individual. Accordingly, the proxy individual can exercise at least a part of the authority of the proxy requesting individual by proxy. Therefore, according to the first aspect of the present disclosure, it is possible to, while ensuring security, track the use relation between the first target and the second target and, while the use relation is established, impart, to the proxy individual, the proxy authentication for exercising at least a part of the authority of the proxy requesting individual by proxy.

Note that a mode of the present disclosure may not be limited to the example explained above. As another mode of the system according to the aspect, an aspect of the present disclosure may be an information processing device, an information processing method, a program, or a storage medium readable by a machine such as a computer, the storage medium storing such a program, that implement all or some of the constituent elements explained above. Here, the recording medium readable by the machine is a medium that accumulates information such as a program with electrical, magnetic, optical, mechanical, or chemical action. The information processing device may be at least any one of the management server, the first terminal, and the second terminal according to the aspect explained above. The system according to the aspect explained above may further include at least one of a first server involved in authentication for the first target and a second server involved in authentication for the second target.

For example, a program according to a second aspect of the present disclosure is a program for causing a first terminal of a proxy individual of a first target to execute: receiving, from a terminal of a proxy requesting individual of the first target, authority imparting information for notifying imparting of an agency; performing data exchange between the first terminal and a second terminal of a target individual when a use relation occurs between the proxy individual and the target individual of a second target; giving authority verification information to the second terminal in the data exchange to request verification of the agency; and transmitting, according to success of the verification by the second terminal, a linking demand including an authentication request of the proxy requesting individual toward a management server, transmitting the linking demand in cooperation with the second terminal, or causing the second terminal to transmit the linking demand to thereby cause the management server to set a correspondence relation between the proxy requesting individual and the target individual according to success of authentication for the proxy requesting individual responding to the authentication request to enable proxy exercise of an authority of the proxy requesting individual by the proxy individual via the target individual.

For example, a program according to a third aspect of the present disclosure is a program for causing a second terminal of a target individual of a second target to execute: performing data exchange between the second terminal and a first terminal of a proxy individual of a first target when a use relation occurs between the proxy individual and the target individual; receiving a request for verification of an agency involving authority verification information from the first terminal in the data exchange; verifying the agency using the authority verification information in response to the request from the first terminal; and transmitting, according to success of the verification, a linking demand including an authentication request of the proxy requesting individual toward a management server, transmitting the linking demand in cooperation with the first terminal, or causing the first terminal to transmit the linking demand to thereby cause the management server to set a correspondence relation between the proxy requesting individual and the target individual according to success of authentication for the proxy requesting individual responding to the authentication request to enable proxy exercise of an authority of the proxy requesting individual by the proxy individual via the target individual.

An embodiment according to an aspect of the present disclosure (hereinafter described as “the present embodiment” as well) is explained below with reference to the drawings. However, the present embodiment explained below is merely exemplification of the present disclosure in all points. Various improvements or modifications may be made without departing from the scope of the present disclosure. In implementation of the present disclosure, a specific configuration corresponding to the embodiment may be adopted as appropriate. Note that data appearing in the present embodiment is explained by a natural language. However, more specifically, the data is designated by a pseudo language, a command, a parameter, a machine language, or the like recognizable by a computer.

### 1 Application Example

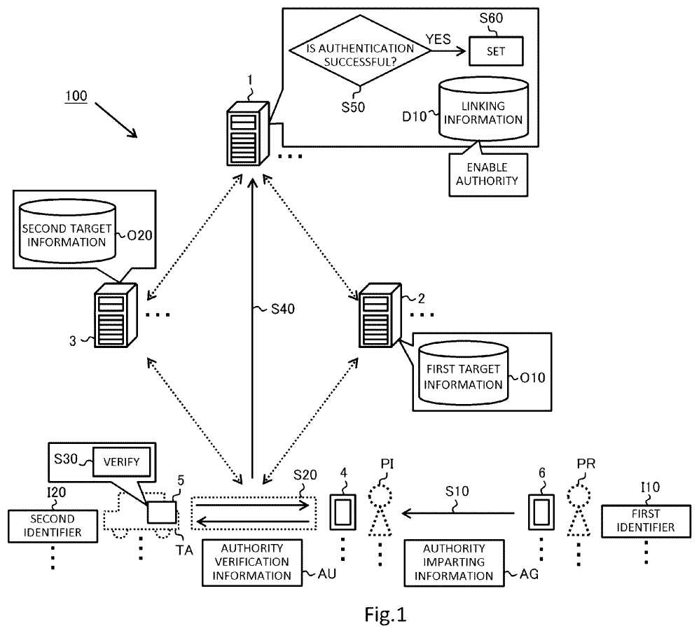

FIG. 1 schematically illustrates an example of a scene to which the present disclosure is applied. A system 100 according to the present embodiment is configured by a management server 1, a first terminal 4, and a second terminal 5. The management server 1 is one or more computers configured to record a correspondence relation (linking) between a first target and a second target. The first terminal 4 corresponds to a proxy individual PI of the first target. The second terminal 5 corresponds to a target individual TA of the second target. A terminal may be given to each individual of the first target. A terminal may be given to each individual of the second target as well. The first terminal 4 is an example of the terminal of the first target. The second terminal 5 is an example of the terminal of the second target.

In the present embodiment, a terminal 6 of a proxy requesting individual PR of the first target receives setting concerning imparting of an agency including designation of the proxy individual PI. The proxy individual PI may be designated from another individual of the first target as appropriate. When the setting concerning the imparting of the agency is performed, the terminal 6 directly or indirectly transmits authority imparting information AG for notifying the imparting of the agency to the first terminal 4. In response to the transmission, the first terminal 4 receives the authority imparting information AG from the terminal 6 (step S10). Note that the indirectly transmitting the authority imparting information AG may include transmitting the authority imparting information AG via an external computer. The terminal 6 is an example of the terminal of the first target. The system 100 may include the terminal 6.

When a use relation occurs between the proxy individual PI and the target individual TA, the first terminal 4 performs data exchange between the first terminal 4 and the second terminal 5 (step S20). In the data exchange, the first terminal 4 gives authority verification information AU to the second terminal 5 to request verification of the agency. In response to the request from the first terminal 4, the second terminal 5 verifies the agency using the authority verification information AU (step S30). According to success of the verification by the second terminal 5, at least one of the first terminal 4 and the second terminal 5 transmits a linking demand including an authentication request for the proxy requesting individual PR to the management server 1 (step S40). The authentication for the proxy requesting individual PR may be performed as appropriate in the linking demand.

According to reception of the linking demand and success of authentication for the proxy requesting individual PR in authentication processing responding to the authentication request, the management server 1 sets a correspondence relation (linking) between the proxy requesting individual PR and the target individual TA (step S50 and step S60). In an example, the management server 1 may generate linking information D10 indicating setting of a correspondence relation between the first target (the proxy requesting individual PR) and the second target (the target individual TA) and may store the generated linking information D10. Accordingly, the management server 1 enables proxy exercise of an authority of the proxy requesting individual PR by the proxy individual PI via the target individual TA.

Note that, in setting processing for the correspondence relation, authentication processing for at least one of the proxy individual PI of the first target and the target individual TA of the second target may be executed together with the authentication processing for the proxy requesting individual PR. A series of processing from the data exchange to the linking setting may be executed in real time according to the occurrence of the use relation. The set correspondence relation (linking) may be released at any timing. In an example, the correspondence relation may be released according to extinction of the use relation.

If the individuals for which the correspondence relation is set can be specified, an expression form of the information (the linking information D10) indicating the setting of the correspondence relation may not be particularly limited and may be set as appropriate according to an embodiment. In an example, a first identifier I10 may be given to the individuals of the first target. The individuals of the first target may be identified by the first identifier I10. Similarly, a second identifier I20 may be given to the individuals of the second target. The individuals of the second target may be identified by the second identifier I20. Setting of a correspondence relation between the proxy requesting individual PR and the target individual TA may be configured by setting a correspondence relation between the first identifier I10 given to the proxy requesting individual PR and the second identifier I20 given to the target individual TA. That is, the setting of the correspondence relation may be expressed using the first identifier I10 and the second identifier I20.

As explained above, in the present embodiment, according to the setting of the correspondence relation (linking) between the proxy requesting individual PR of the first target and the target individual TA of the second target, it is possible to track a use relation between the proxy individual PI and the target individual TA in response to a request of the proxy requesting individual PR. In addition, it is possible to ensure security according to the verification processing for the agency by the authority verification information AU and the authentication processing for the proxy requesting individual PR. Further, the proxy exercise of the authority of the proxy requesting individual PR by the proxy individual PI via the target individual TA is enabled according to the setting of the correspondence relation between the proxy requesting individual PR and the target individual TA. Accordingly, the proxy individual PI can exercise at least a part of the authority of the proxy requesting individual PR by proxy. Therefore, according to the present embodiment, it is possible to track the use relation between the first target and the second target while ensuring security and impart a proxy authority for exercising at least a part of the authority of the proxy requesting individual PR by proxy to the proxy individual PI while the use relation is established.

### (Targets)

If the use relation can be established, the first target and the second target may not be respectively particularly limited and may be selected as appropriate according to an embodiment. The first target and the second target may be respectively any things such as objects, humans, or other organisms. Such things may include virtual things. The use relation being established may be a realistic or virtual relation occurring between at least two things, for example, one using the other, one owning the other, one being coupled to the other, or one being connected to the other. The system 100 of the present disclosure may be used in any scene in which a correspondence relation between two or more things is tracked.

Note that, in the present embodiment, concerning the first target, setting of a correspondence relation by proxy of the proxy individual PI responding to a request from the proxy requesting individual PR is allowed. In contrast, concerning the second target, such setting of the correspondence relation by proxy may be allowed or may not be allowed. When a form in which proxy is not allowed concerning the second target is adopted, of the first target and the second target, one target that allows linking setting by proxy may be selected as the first target and the other target that does not allow the linking setting by proxy may be selected as the second target.

### (First Server/Second Server)

In an example, in order to indicate details of the individuals (including the proxy requesting individual PR and the proxy individual PI) of the first target, first target information O10 concerning the first target may be used. The first target information O10 may include the first identifier I10. The first target information O10 may include information (registered specific information and the like) used for authentication for the first target. Similarly, in order to indicate details of the individuals (including the target individual TA) of the second target, second target information O20 concerning the second target may be used. The second target information O20 may include the second identifier I20. The second target information O20 may include information used for authentication for the second target. The first target information O10 and the second target information O20 may be retained in any storage region. At least parts of the first target information O10 and the second target information O20 may be retained to be accessible from at least any one of the management server 1, an external server, and the terminals (4 and 5).

The first target information O10 and the second target information O20 may be managed as appropriate. In the example illustrated in FIG. 1, a first server 2 may be configured to manage the first target information O10 and a second server 3 may be configured to manage the second target information O20. The first server 2 and the second server 3 may be respectively configured by one or more server devices. The first target information O10 may be stored such that a memory resource disposed on at least one of the inside and the outside of the first server 2 can be accessed from the first server 2. The second target information O20 may be stored such that a memory resource disposed on at least one of the inside and the outside of the second server 3 can be accessed from the second server 3. The memory resource on the inside may include, for example, a RAM (Random Access Memory), an auxiliary storage device, or a storage medium. The memory resource on the outside may include, for example, an external storage device or an external computer (NAS: Network Attached Storage). In another example, the respective kinds of target information (O10 and O20) may be stored in the memory resource of the management server 1.

A unit for managing the respective kinds of target information (O10 and O20) may not be particularly limited and may be determined as appropriate according to an embodiment. At least one of the first target information O10 and the second target information O20 may be collectively (integrally) managed or may be dispersedly (individually) managed for each certain group. Server devices configuring the servers (2 and 3) may be disposed by one or more operating institutions (entities). At least one of the first server 2 and the second server 3 may be disposed by a plurality of operating institutions. When at least one of the first server 2 and the second server 3 is disposed by the plurality of operating institutions, the target information may be shared (that is, collectively managed) or may be dispersedly managed by each of the operating institutions.

Note that the first server 2 may be involved in the authentication for the first target (the proxy requesting individual PR and the proxy individual PI). The being involved in the authentication may include determining success of the authentication (being directly involved) and being indirectly involved (for example, providing information for determining success of the authentication). When success of the authentication for the first target is determined, the first server 2 is an example of an external server (an external authentication server) that determines success of the authentication for the first target. Similarly, the second server 3 may be involved in the authentication for the second target (the target individual TA). When success of the authentication for the second target is determined, the second server 3 is an example of an external server (an external authentication server) that determines success of the authentication for the second target.

### (Identifiers)

In an example, the identifiers (I10 and I20) may be used in order to identify the individuals of the targets (including the proxy requesting individual PR of the first target, the proxy individual PI of the first target, and the target individual TA of the second target). If the individuals of the targets can be identified, a data format and a configuration of the identifiers (I10 and I20) may not be particularly limited and may be selected as appropriate according to an embodiment. In an example, the identifiers (I10 and I20) may be configured by symbol strings including numbers and characters. In another example, as the identifiers (I10 and I20), specific information such as identification information uniquely imparted to the individuals or information deriving from the terminals (4, 5, and 6) may be used. The uniquely imparted identification information may be, for example, a car registration number, a vehicle identification number (VIN), or a personal ID number. When IC tags are imparted to the individuals, the uniquely imparted identification information may include information retained by the IC tags. The information deriving from the terminals (4, 5, and 6) may be, for example, a MAC address (Media Access Control address) or terminal identification information (IMEI: International Mobile Equipment Identifier, IMSI: International Mobile Subscriber Identity, MEID: Mobile Equipment Identifier, ICCID: Integrated Circuit Card ID, another serial number, or the like).

### (Management Server)

The management server 1 may be configured to set a correspondence relation between relevant individuals of the first target and the second target according to a linking demand from at least one of the terminal of the first target and the terminal of the second target. In the present embodiment, the terminal of the first target may include the first terminal 4 of the proxy individual PI and the terminal of the second target may include the second terminal 5 of the target individual TA. The setting a correspondence relation between the first target and the second target may include setting a correspondence relation between the proxy requesting individual PR and the target individual TA according to a linking demand from at least one of the first terminal 4 of the proxy individual PI of the first target and the second terminal 5 of the target individual TA of the second target. Note that, besides the case of the proxy by the proxy individual PI, the setting a correspondence relation between the first target and the second target may include setting a correspondence relation between the relevant individuals of the first target and the second target in response to a linking demand from at least one of the terminals of the relevant individuals of the first target and the second target. This processing of linking setting of a normal route not depending on proxy may be the same as linking setting of a proxy route except processing concerning setting of an agency and a proxy of verification and the like. In the following explanation concerning the proxy route, the first terminal 4 and the second terminal 5 may be respectively replaced with the terminals of the relevant individuals of the first target and the second target. Accordingly, the processing of the normal route may be configured.

The linking demand may be communicated by any route. In an example, the management server 1 may directly receive the linking demand from at least one of the first terminal 4 and the second terminal 5 or may indirectly receive the linking demand via an external server. That is, the transmitting the linking demand toward the management server 1 may be configured by directly transmitting the linking demand to the management server 1 or indirectly transmitting the linking demand to the management server 1 via the external server. The external server may include, for example, the first server 2 and the second server 3. In an example, the indirectly transmitting the linking demand may be configured by causing an external computer to simply relay the linking demand. In another example, the indirectly transmitting the linking demand may be configured by transmitting a request for processing involved in linking to the external computer, for example, requesting the servers (2 and 3) to authenticate the targets and causing the servers (2 and 3) to transmit an authentication result to the management server 1, and causing the external computer to transmit some information to the management server 1 according to a result of execution of the processing. That is, the linking demand may be transmitted from the external computer to the management server 1 as a result of data communication for another purpose to the external computer. At least one of the first terminal 4 and the second terminal 5 transmitting the linking demand may include the first terminal 4 transmitting the linking demand, the first terminal 4 and the second terminal 5 transmitting the linking demand in cooperation, and the second terminal 5 transmitting the linking demand.

The management server 1 may receive a linking demand (a request for linking setting) according to occurrence of a use relation and set a correspondence relation between the relevant individuals of the first target and the second target according to the received linking demand. The management server 1 may receive a release demand (a request for linking release) according to extinction of the use relation and release the correspondence relation as appropriate according to the received release demand. The linking demand and the release demand may be configured to designate a relevant individual of a processing target with any method.

In a typical example, the linking demand and the release demand may respectively include the first identifier I10 and the second identifier I20 to be configured to designate the relevant individual of the processing target. In the embodiment explained above, the linking demand transmitted from at least one of the first terminal 4 of the proxy individual PI and the second terminal 5 of the target individual TA may include the first identifier I10 of the proxy requesting individual PR and the second identifier I20 of the target individual TA to be configured to designate linking target individuals (the proxy requesting individual PR and the target individual TA). However, a method of designating the relevant individual of the processing target may not be limited to such an example and may be changed as appropriate according to an embodiment. In another example, by using alternative information in at least one of the linking demand and the release demand, at least one of the first identifier I10 and the second identifier I20 may be omitted. For example, an identifier may be imparted as alternative information to a combination (linking setting) of relevant individuals of the first target and the second target. The imparting of the identifier may be performed at any timing such as an initial linking setting time. At least one of the linking demand and the release demand may include this identifier to be configured to designate the relevant individuals of the targets set as processing targets without including at least one of the first identifier 110 and the second identifier I20.

The management server 1 may be configured by one or more server devices. In the present embodiment, the management server 1 may be configured to record, as the linking information D10, information concerning occurrence and extinction of a correspondence relation between the first target and the second target. The linking information D10 may be stored in a memory resource disposed on at least one of the inside and the outside of the management server 1. The memory resource on the inside may include, for example, a RAM, an auxiliary storage device, or a storage medium. The memory resource on the outside may include, for example, an external storage device or an external computer (NAS or the like).

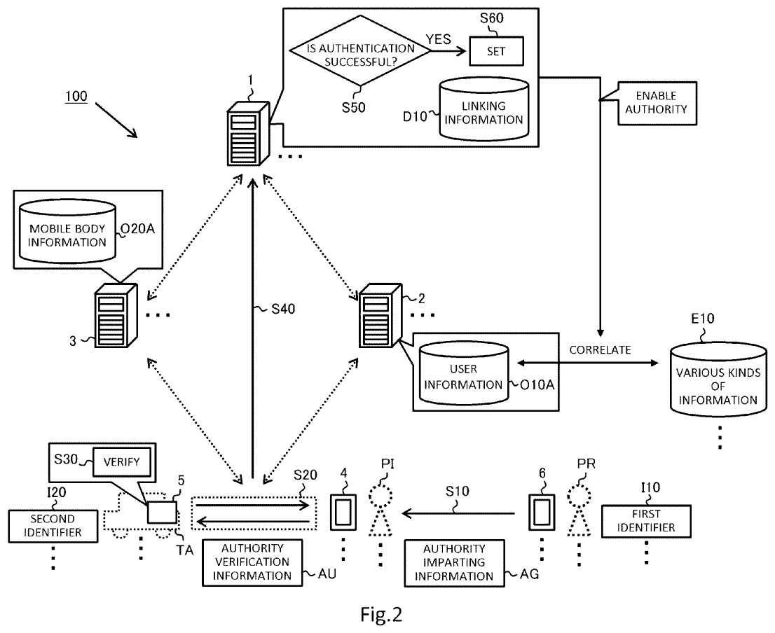

The obtained linking information D10 may be used in various scenes. In an example, the linking information D10 may be used to track a relation between the first target and the second target. As a specific example, the linking information D10 may be used to, while a correspondence relation between the first target and the second target is set, make it possible to exercise an authority linked with one of the first target and the second target (the first target information O10 and the second target information O20) from the other. That is, the linking information D10 may be used to enable, according to linking of the first target and the second target, an authority of one of the first target and the second target to be exercised from the other (FIG. 2 referred to later). In the present embodiment, the linking information D10 may be used to enable, according to linking of the proxy requesting individual PR of the first target and the target individual TA of the second target, the proxy individual PI to exercise at least a part of an authority of the proxy requesting individual PR by proxy via the target individual TA.

In an example of the present embodiment, the linking information D10 may include information concerning the first identifier I10 and the second identifier 120 of relevant individuals in order to indicate a combination of the first target and the second target for which a correspondence relation is set. The management server 1 may acquire the identifiers (I10 and I20) of the targets as appropriate. In an example, the management server 1 may not retain information concerning the first identifier I10 and the second identifier I20 for which a correspondence relation is set and may acquire the information every time from at least any one of the servers (2 and 3) and the terminals (4 and 5). In another example, the management server 1 may retain, in advance, information concerning at least one of the first identifier I10 and the second identifier I20 for which a correspondence relation is set. In an example of the present embodiment, when a correspondence

relation is set by a proxy of the proxy individual PI, the linking information D10 may further include information concerning the proxy. The information concerning the proxy may include, for example, identification information of the proxy individual PI and information (an expiration date, an effective authority, or the like) concerning an agency. In an example, in order to identify a designated proxy individual PI, the information concerning the proxy may include the first identifier I10 of the proxy individual PI. The information concerning the proxy may be communicated to the management server 1 as appropriate. The information concerning the proxy may be directly or indirectly transmitted to the management server 1 from at least one of the first terminal 4 and the terminal 6. The information concerning the proxy may be transmitted from the terminal 6 to the management server 1 via at least one of the first terminal 4 and the second terminal 5. When the terminal 6 designates the proxy individual PI in an external server such as the first server 2, the information concerning the proxy may be directly or indirectly transmitted from the external server to the management server 1. In another example, the linking information D10 may not include the information concerning the proxy. The information concerning the proxy may be retained in information other than the linking information D10 such as the first target information O10. The information concerning the proxy may be managed by the external server such as the first server 2.

Note that a relation between operating institutions of the management server 1 and the servers (2 and 3) may be optional. In an example, the operating institution of the management server 1 may overlap the operating institution of at least one of the first server 2 and the second server 3. In another example, the operating institution of the management server 1 may be different from the operating institutions of the first server 2 and the second server 3. The system 100 of the present disclosure may be produced by the management server 1 being connected to the terminals (4 and 5) via a network and the terminals (4 and 5) being respectively disposed in a state of capable of executing the information processing explained above according to an intention of the operating institution of the management server 1. When the servers (2 and 3) are involved in information processing (for example, authentication processing) relating to linking, the servers (2 and 3) may be interpreted as being included in the system 100. In this case, the system 100 of the present disclosure may be produced by the management server 1 being further connected to the servers (2 and 3) via the network and the servers (2 and 3) being further disposed in a state of capable of executing the information processing relating to linking. Further, the terminal 6 of the proxy requesting individual PR of the first target may be interpreted as being included in the system 100.

### (Terminals)

The first terminal 4 relates to the proxy individual PI of the first target. The second terminal 5 relates to the target individual TA of the second target. The terminal 6 relates to the proxy requesting individual PR of the first target. In an example, the terminals (4, 5, and 6) may accompany the individuals (PI, TA, and PR) corresponding thereto. The accompanying may include temporarily or permanently being disposed on the inside or the outside of a target, being carried by a target (a human), and being carried by a human involved in a target (an object). The being disposed may include being loaded. The being loaded may include, besides being always placed on a target, at least temporarily being placed on the target when the target is used. The loading may include a user of the target carrying the target. At least any one of the first terminal 4, the second terminal 5, and the terminal 6 may be the individuals (PI, TA, and PR) themselves corresponding thereto. The terminals (4, 5, and 6) may be configured by one or more computers. Concerning the terminals (4, 5, and 6), a plurality of terminals may be used as terminals of the same individual, for example, one user shares an account among the plurality of terminals. In this case, the plurality of terminals used in the same individual may be interpreted as one terminal of one individual.

In the embodiment explained above, the first terminal 4 of the proxy individual PI of the first target receives, from the terminal 6 of the proxy requesting individual PR of the first target, the authority imparting information AG for notifying imparting of an agency. When the use relation occurs between the proxy individual PI and the target individual TA of the second target, the first terminal 4 performs data exchange between the first terminal 4 and the second terminal 5 of the target individual TA. In the data exchange, the first terminal 4 gives the authority verification information AU to the second terminal 5 to request verification of the agency. According to success of the verification by the second terminal 5, the first terminal 4 transmits a linking demand including a verification request for the proxy requesting individual PR toward the management server 1, transmits the linking demand in cooperation with the second terminal 5, or causes the second terminal 5 to transmit the linking demand. Accordingly, the first terminal 4 causes the management server 1 to set a correspondence relation between the proxy requesting individual PR and the target individual TA according to success of the authentication for the proxy requesting individual PR responding to the authentication request to enable proxy exercise of the authority of the proxy requesting individual PR by the proxy individual PI via the target individual TA.

In the embodiment explained above, when the use relation occurs between the proxy individual PI of the first target and the target individual TA, the second terminal 5 of the target individual TA of the second target performs data exchange between the second terminal 5 and the first terminal 4 of the proxy individual PI. In the data exchange, the second terminal 5 receives a request for verification of an agency involving the authority verification information AU from the first terminal 4. The second terminal 5 verifies the agency using the authority verification information AU in response to the request from the first terminal 4. According to success of the verification, the second terminal 5 transmits a linking demand including an authentication request for the proxy requesting individual PR, transmits the linking demand in cooperation with the first terminal 4, or causes the first terminal 4 to transmit the linking demand. Accordingly, the second terminal 5 causes the management server 1 to set a correspondence relation between the proxy requesting individual PR and the target individual TA according to success of the authentication for the proxy requesting individual PR responding to the authentication request to enable proxy exercise of the authority of the proxy requesting individual PR by the proxy individual PI via the target individual TA.

In the embodiment explained above, the terminal 6 of the proxy requesting individual PR of the first target receives setting concerning imparting of an agency including designation of the proxy individual PI. Information processing for setting concerning a proxy may be executed on the terminal 6 or may be executed on an external computer such as the first server 2 via the terminal 6. The proxy individual PI may be designated as appropriate. In a typical example, the terminal 6 may store an address book and may receive selection of the proxy individual PI from an individual (for example, a user) registered in the address book. In another example, the terminal 6 may access a list of the first target via the external computer such as the first server 2 and receive selection of the proxy individual PI from individuals registered in the list. The designation of the proxy individual PI may be automatically performed by computer processing or may be manually performed by at least partially including user operation.

When the proxy individual PI is designated, the terminal 6 performs data exchange with the terminal (the first terminal 4) of the designated proxy individual PI and gives the authority imparting information AG for notifying imparting of an agency to the first terminal 4. Accordingly, the first terminal 4 receives the authority imparting information AG from the terminal 6. If the imparting of the agency can be notified, a configuration of the authority imparting information AG may not be particularly limited and may be selected as appropriate according to an embodiment. In an example, the authority imparting information AG may include the authority verification information AU. In another example, the authority imparting information AG may be configured by information for simply notifying the imparting of the agency. The data exchange between the terminal 6 and the first terminal 4 may be performed by wireless or wired data communication or may be performed by a method other than the data communication such as reading of a two-dimensional code. In an example, when the data communication is adopted, the data exchange between the terminal 6 and the first terminal 4 may be performed by a short mail, an electronic mail, notification in a communication system application (for example, an application of a social networking service), or the like. The terminal 6 may directly give the authority imparting information AG to the first terminal 4 or may indirectly transmit the authority imparting information AG via the external computer such as the first server 2. Accordingly, the terminal 6 of the proxy requesting individual PR may cause the first terminal 4 of the proxy individual PI to execute processing for imparting an authority to be authenticated by proxy and setting a correspondence relation between the first terminal 4 and the second target.

Note that the setting concerning the imparting of the agency may include various kinds of setting relating to the agency other than the designation of the proxy individual PI. In an example, the setting concerning the imparting of the agency may include setting of at least one of an expiration date and an effective authority. Accordingly, at least one of the expiration date and the effective authority may be set in the agency. When the expiration date is set in the agency, the management server 1 may be configured to release the correspondence relation between the proxy requesting individual PR and the target individual TA according to arrival of the expiration date. When the effective authority is set in the agency, the management server 1 may be configured to release the correspondence relation between the proxy requesting individual PR and the target individual TA according to exercise or extinction of the effective authority by the proxy individual PI. By setting at least one of the expiration date and the effective authority, it is possible to provide a restriction for the agency to be imparted to the proxy individual PI. Note that the setting of at least one of the expiration date and the effective authority may be automatically performed by computer processing or may be manually performed by at least partially including user operation.

Information concerning the agency (agency information) in which the information concerning the proxy individual PI, the expiration date, the effective authority, and the like are set may be managed as appropriate. The agency information may be managed by at least any one of the management server 1, the external computer (for example, the first server 2), the first terminal 4, the second terminal 5, and the terminal 6. In an example, the setting processing concerning the proxy may be executed on the first server 2. The first server 2 may generate the agency information according to the execution of this setting processing. The first server 2 may manage the agency information in correlation with the first target information O10. The first server 2 may notify the agency information to the management server 1 as appropriate. In another example, the information (for example, the first identifier I10) concerning the proxy individual PI may be transmitted from the first terminal 4. In another example, the agency information may be generated according to the setting processing on the terminal 6. The agency information may be transmitted from the terminal 6 to the first server 2 and managed in the first server 2 in correlation with the first target information O10. In another example, the agency information may be notified from the first server 2 or the terminal 6 to the management server 1 through at least one of the first terminal 4 and the second terminal 5 and managed in the management server 1 in correlation with the linking information D10. For example, the agency information may be transmitted together with a linking demand. In another example, the agency information may be directly or indirectly transmitted from the terminal 6 to the management server 1 not through at least one of the first terminal 4 and the second terminal 5. In this case, the management server 1 may associate the linking demand received from at least one of the first terminal 4 and the second terminal 5 and the agency information as appropriate. Data association may be specified by any method. In an example, both of data of the linking demand and data of the agency information may include shared information for specifying the association. The shared information may be configured by information having relationship of, for example, coinciding or a corresponding relation being established. In an example, the shared information may be configured by the first identifier I10 of at least one of the proxy requesting individual PR and the proxy individual PI. In another example, the shared information may be configured by temporary information such as a random number, a timestamp, or a hash value. Note that timing for setting the effective authority and the expiration date may not be limited to the same time as timing for designating the proxy individual PI. At least one of the effective authority and the expiration date may be set to any timing until the correspondence relation is released.

### Operation Examples

The first target and the second target may be selected as appropriate. In an example, one of the first target and the second target may be a user. Of the first terminal 4 and the second terminal 5, one terminal corresponding to the user may be a user terminal relating to the user. The other of the first target and the second target may be an object to be used to be used by the user. Of the first terminal 4 and the second terminal 5, one terminal corresponding to the object to be used may be a loading terminal to be loaded on the object to be used. According to an example of the present embodiment, it is possible to track a use relation between the user and the object to be used. In an example, the first target may be the user and the second target may be the object to be used. The proxy individual PI of the first target may be a proxy user and the proxy requesting individual PR of the first target may be a proxy requesting user.

If the object to be used can be used by the user, a type of the object to be used may not be particularly limited and may be selected as appropriate according to an embodiment. In an example, the object to be used may be a mobile body (mobility). According to an example of the present embodiment, a use relation between the user and the mobile body can be tracked. Note that a type of the mobile body may be selected as appropriate. The mobile body may be, for example, a vehicle, a railroad vehicle, an aircraft (an airplane, a drone, or the like), or a ship.

The mobile body may be at least one of a manned aircraft that is manually controlled and an unmanned aircraft that is automatically controlled. When the mobile body is a vehicle, a type of the vehicle may be optionally selected. The type of the vehicle may be selected from, for example, a motorcycle, a tricycle, and a four-wheeled vehicle. The vehicle may include a private vehicle, a rent-a-car, a shared car, a taxi, a bus, and the like. The vehicle may be at least one of an automatic driving vehicle and a manual driving vehicle. The loading terminal may be called a mobile body terminal.

FIG. 2 schematically illustrates an example of a scene to which the system 100 of the present disclosure is applied. In the example illustrated in FIG. 2, the first target is the user and the second target is the mobile body. In the following explanation concerning a case illustrated in FIG. 2, for convenience, “first” is treated as relating to the user and “second” is treated as relating to the mobile body.

However, a correspondence relation between the “first” and the “second” may not be limited to the example illustrated in FIG. 2. The “first” and the “second” may be changed. That is, the second target may be the user and the first target may be the mobile body.

When the first target is the user, an example of the first terminal 4 is a user terminal carried by the proxy user and an example of the terminal 6 is a user terminal carried by a proxy requesting user. The user terminals may be any computers such as portable terminals (smartphones or the like), dedicated devices (electronic key devices or the like), or other computer devices. An account of the user may be shared among a plurality of computers. Accordingly, the computers sharing the account may be used as user terminals (the first terminal 4 and the terminal 6) of the same user.

An example of the first identifier I10 is a user identifier (a user ID or a My ID). The user identifier may be, for example, an ID of a user account, a personal ID number, or identification information (for example, a MAC address, or terminal identification information) of a user terminal. An example of the first target information O10 is user information O10A. The user information O10A may include any information concerning the user. In an example, the user information O10A may include information concerning an authority of the user corresponding thereto (a corresponding individual of the user) to be correlated with various kinds of information E10 for exercising the authority. The various kinds of information E10 may include, for example, information of public personal authentication, settlement information, and other service system information. The information of the public personal authentication may include, for example, a personal ID number. The settlement information may include, for example, information of a credit card, information of Internet banking, and information of electronic settlement. The other service system information may include, for example, information concerning an electronic prescription (an insurer number, prescription information, and the like). The various kinds of information E10 may be managed by an external system or may be managed in the system 100. Note that the first server 2 may be disposed by a public institution, a neutral institution, companies (a vehicle manufacturer, a service operation company, and the like), or the like. The first server 2 may be called a user ID server, a My ID server, or the like.

On the other hand, when the second target is the mobile body, an example of the second terminal 5 is a mobile body terminal (a loading terminal). The mobile body terminal may be, for example, a terminal attached to the inside or the outside of the mobile body, a terminal carried by a human (for example, a driver or a conductor) involved in operation of the mobile body, or equipment (for example, a ticket gate) disposed in a facility of the mobile body. When the mobile body is a vehicle, the mobile body terminal may be called an in-vehicle terminal.

An example of the second identifier I20 is a mobile body identifier (a mobile body ID or a car ID). The mobile body identifier may be, for example, an ID of a mobile body account, identification information (for example, a car registration number or vehicle identification number) uniquely imparted to a target mobile body, or identification information of a mobile body terminal. An example of the second target information O20 is mobile body information O20A. The mobile body information O20A may include any information concerning a mobile body. In the example illustrated in FIG. 2, according to linking setting between the proxy requesting user and the target mobile body, the proxy user may be enabled (activated) to exercise, via the target mobile body, at least some of authorities of the various kinds of information E10 correlated with the user information O10A of the proxy requesting user. Note that the second server 3 may be disposed by a public institution, a neutral institution, companies (a vehicle manufacturer, a service operation company, and the like), or the like. The second server 3 may be called a mobile body ID server, a car ID server, or the like.

The mobile body is an example of an object to be used. A form illustrated in FIG. 2 may be applied to any case in which a user (an occupant) of the object to be used dynamically fluctuates. The object to be used may be, other than the mobile body, for example, a rental thing or a lodging facility. The rental thing may include a rental office, a rental space, and the like.

The system 100 may be configured to set a correspondence relation (linking) between a relevant user (the first identifier I10) and a relevant individual (the second identifier I20) of the object to be used according to a use start of the object to be used. The system 100 may be configured to release the correspondence relation (linking) between the relevant individuals according to a use end. The start and the end of the use may be detected by any method at timing such as timing of getting in and out of the vehicle or lending and returning of the object to be used. In an example, at least one of the start and the end of the use may be detected according to execution of data exchange between terminals of the user and the object to be used (in the proxy case, the first terminal 4, and the second terminal 5). Note that the object to be used can be divided into at least two types

including an object that can be repeatedly used for a long time and an object that can be temporarily used. For convenience of explanation, the former is referred to as “object to be always used” and the latter is referred to as “object to be temporarily used”. An example of the object to be always used is a property of the user such as a private car. An object repeatedly used for a long time is desirably selected as the object to be always used. An example of the object to be temporarily used is an object owned by a person other than the user such as a rent-a-car, a shared car, a mobile body of a public transportation, a rental thing, or a lodging facility. The mobile body of the public transportation is, for example, a taxi, a bus, a railroad vehicle, an airplane, or a ship.

In the system 100, the type (the object to be always used or the object to be temporarily used) of the object to be used may be distinguished or may not be distinguished. When the type of the object to be used is distinguished, the system 100 may discriminate the type of the object to be used with any method. In an example, the target information (the mobile body information or the like) may include information indicating the type of the object to be used. The system 100 may discriminate the type of the object to be used with this information. In another example, the type of the object to be used may be discriminated from an identifier or information such as attribute information. In another example, the information indicating the type of the object to be used may be included in information transmitted from at least one of the first terminal 4 and the second terminal 5 toward the management server 1. The system 100 may discriminate the type of the object to be used with this information. In another example, when an operating institution of a server (in the example illustrated in FIG. 2, the second server 3) that treats information concerning the object to be used is determined according to the type of the object to be used, the type of the object to be used may be discriminated according to a department of the operating institution of the server. The system 100 may switch, for example, processing of linking setting, a condition for linking release, a management method for the linking information D10, and a form of authentication processing or the like according to the discriminated type of the object to be used.

Note that an application scene of the system 100 of the present disclosure may not be limited to the scene in which the relation between the user and the object to be used is tracked. In another example, both of the first target and the second target may be robot devices configured to autonomously operate according to automatic control. The robot device may include mobile bodies such as an automatic driving vehicle and a drone. In a scene in which two or more robot devices autonomously perform interaction, the system 100 of the present disclosure may be used to track occurrence and extinction of a relation among the robot devices. In this case, the system 100 may execute the processing of the linking setting by the proxy in order for one robot device (the proxy individual PI) to exercise an authority of another robot device (the proxy requesting individual PR) by proxy.

### (Linking Information)

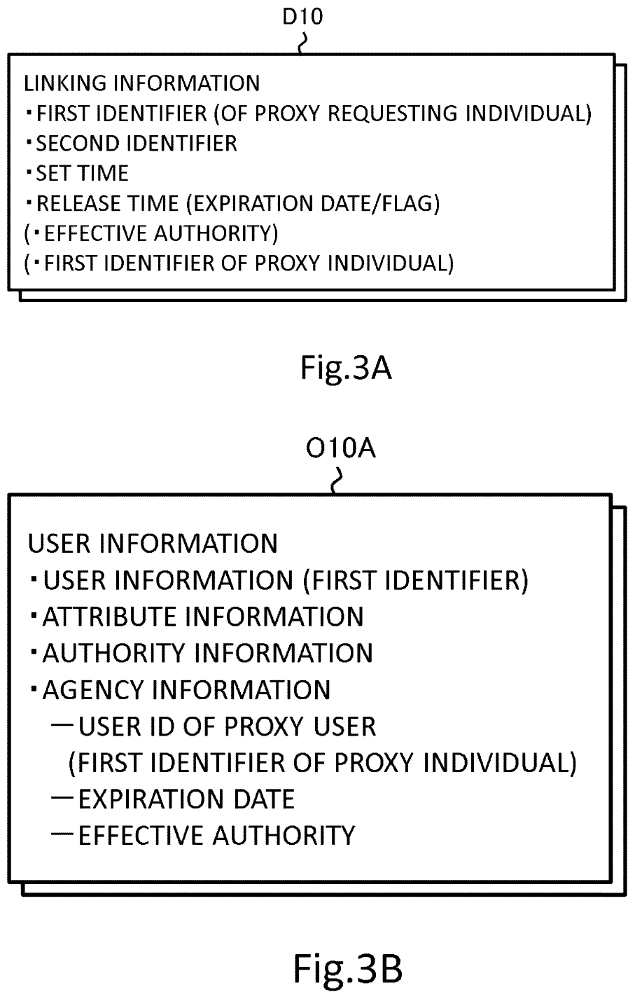

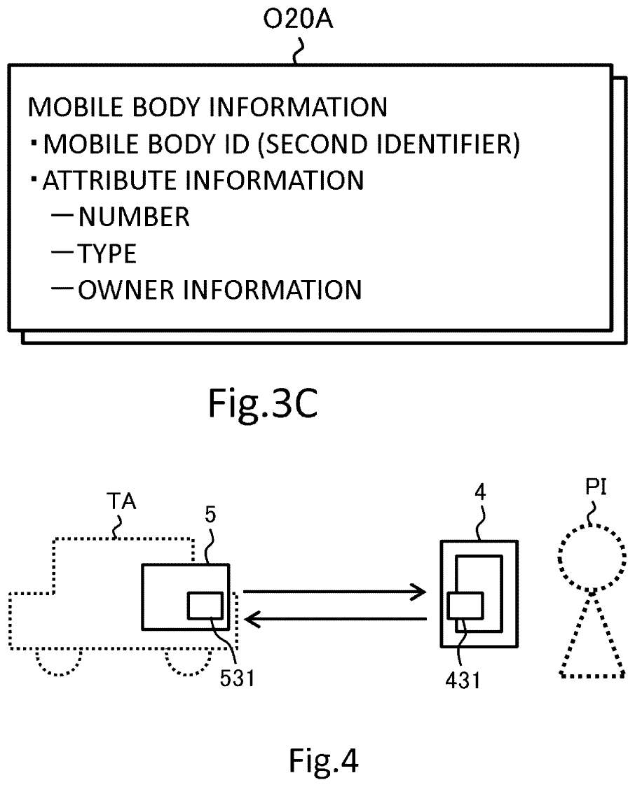

FIG. 3A schematically illustrates an example of the linking information D10 according to the present embodiment. In the example illustrated in FIG. 3A, it is assumed that a form in which setting of a correspondence relation is expressed using the first identifier I10 and the second identifier I20 is adopted. The linking information D10 includes the first identifier I10, the second identifier I20, setting time, and release time. The first identifier I10 and the second identifier I20 indicate a relevant individual of the first target and a relevant individual of the second target for which a correspondence relation (linking) is set. When the correspondence relation is set in the case of the proxy explained above, the linking information D10 includes the first identifier I10 of the proxy requesting individual PR. The setting time indicates time when the correspondence relation has been set. The setting time may be configured by a timestamp. The release time indicates time when the correspondence relation has been released. A value of the release time may be added when processing for releasing the correspondence relation is executed. A method of expressing the release may not be limited to such an example. In another example, the release time may be replaced with at least one of an expiration date and a flag. The expiration date indicates a period in which the setting of the correspondence relation is effective. In this case, according to whether the setting of the correspondence relation is before the expiration date, it is indicated whether the setting of the correspondence relation is effective (that is, whether the correspondence relation is set or released). When the correspondence relation is set in the case of the proxy explained above, the expiration date may be set by the proxy requesting individual PR. The flag indicates whether the correspondence relation has been released. The flag may be set when the processing for releasing the correspondence relation is executed. In still another example, the linking information D10 may include at least one of the expiration date and the flag together with a field of the release time. When the correspondence relation is set in the case of the proxy and an effective authority is further set, the linking information D10 may further include information indicating the set effective authority. In order to identify the designated proxy individual PI, the linking information D10 may further include the first identifier I10 of the designated proxy individual PI. Information of the expiration date, the effective authority, and the first identifier I10 of the proxy individual PI is an example of information (agency information) concerning a set agency.

Note that, if the setting of the correspondence relation can be indicated, the configuration of the linking information D10 may not be limited to the example illustrated in FIG. 3A and may change as appropriate according to an embodiment. In another example, the linking information D10 may further include information indicating the type (the object to be always used or the object to be temporarily used) of the object to be used. The type of the object to be used may not always be identified by separate information. For example, the type of the object to be used may be identified by information such as an identifier. The agency information may be omitted from the linking information D10.

A data format of the linking information D10 may not be particularly limited and may be selected as appropriate according to an embodiment. The linking information D10 may be retained by any database base. In an example, the linking information D10 may be retained by a relational database of a table format or the like. In another example, the linking information D10 may be retained by a blockchain base. In this case, transactions of the respective linking setting and release are accumulated in a block chain as the linking information D10. For example, the transaction of the linking setting may include the first identifier I10, the second identifier I20, and the setting time. The transaction of the linking release may include the first identifier I10, the second identifier I20, and the release time (or the information indicating the release).

### (First Target Information)

The first target information O10 may include any information concerning the first target. The first target information O10 may include, for example, the first identifier I10, attribute information of the first target, information concerning an authority (authority information), and information concerning a set agency (agency information). In the example illustrated in FIG. 2, the user information O10A is an example of the first target information O10.

FIG. 3B schematically illustrates an example of the user information O10A according to the present embodiment. In the example illustrated in FIG. 3B, the user information O10A includes a user ID (the first identifier I10), attribute information, and authority information of a user corresponding thereto. The attribute information may include any information concerning an attribute of the corresponding user. The attribute information may include personal information such as a name, an address, age, sex, and a contact. The authority information relates to an authority of the corresponding user. The authority information may include, for example, information for cooperating with a server that executes information processing concerning an authority of a target and information indicating correlation with various kinds of information E10.

When the corresponding user acts as a proxy requesting user and sets an agency, the user information O10A may further include agency information concerning the set agency. In an example, the agency information may include a user ID of a proxy user (the first identifier I10 of the proxy individual PI), an expiration date, and an effective authority of the proxy user. The agency information may be correlated with the authority information.

Note that the configuration of the user information O10A may not be limited to the example illustrated in FIG. 3B and may be changed as appropriate according to an embodiment. For example, the user information O10A (the first target information O10) may further include information (for example, registered specific information) used for authentication for the user (the first target). The agency information may be omitted from the user information O10A (the first target information O10). As exemplified in FIG. 3A and FIG. 3B, the agency information may be stored in correlation with at least one of the linking information D10 and the first target information O10 or may be stored separately from the linking information D10 and the first target information O10.

A data format of the first target information O10 (the user information O10A) may not be particularly limited and may be selected as appropriate according to an embodiment. The first target information O10 (the user information O10A) may be retained by any database base. In an example, the first target information O10 (the user information O10A) may be retained by a relational database of a table format or the like. In another example, the first target information O10 (the user information O10A) may be retained by a block chain base.

### (Second Target Information)

The second target information O20 may include any information concerning the second target. The second target information O20 may include, for example, information concerning the second identifier I20, attribute information of the second target, and information concerning an authority. In the example illustrated in FIG. 2, the mobile body information O20A is an example of the second target information O20.

FIG. 3C schematically illustrates an example of the mobile body information O20A according to the present embodiment. In the example illustrated in FIG. 3C, the mobile body information O20A includes a mobile body ID (the second identifier I20) and attribute information. The attribute information includes a number, a type, and owner information. When the mobile body is a vehicle, the number may be a car registration number. The type may be optionally specified. In an example, the type may be specified to indicate categories capable of distinguishing an object to be always used and an object to be temporarily used such as a private car, a rent-a-car, a shared car, and a mobile body of a public transportation. The type may include a type of the mobile body such as a car model. The owner information may include any information concerning an owner of the mobile body. The owner information may include personal information of the owner such as a name, an address, age, sex, and a contact. The owner may be a corporation.

Note that the configuration of the mobile body information O20A may not be limited to the example illustrated in FIG. 3C and may be changed as appropriate according to an embodiment. For example, the mobile body information O20A (the second target information O20) may further include information (for example, registered specific information) used for authentication for the mobile body (the second target). The configuration of the attribute information may also be changed as appropriate. For example, the mobile body information O20A (the attribute information) may further include information concerning the mobile body terminal such as a contact of the mobile body terminal. When a form in which a proxy is allowed for the second target is adopted, the second target information O20 may further include agency information.

The data format of the second target information O20 (the mobile body information O20A) may not be particularly limited and may be selected as appropriate according to an embodiment. The second target information O20 (the mobile body information O20A) may be retained by any database base. In an example, the second target information O20 (the mobile body information O20A) may be retained by a relational database of a table format or the like. In another example, the second target information O20 (the mobile body information O20A) may be retained by a block chain base.

### (Authentication Processing)

The authentication for the proxy requesting individual PR of the first target may be carried out by any method (specifically explained later). The executing the authentication processing includes determining success of the authentication. The authentication processing may be executed by any computer. In an example, success of the authentication responding to the authentication request may be determined by the management server 1 or the external server (for example, the first server 2). By executing the authentication processing on the server side, it can be expected that security is ensured.

This authentication processing may be executed at any timing before a correspondence relation is set. In an example, the authentication processing for the proxy requesting individual PR may be executed as a trigger for transmitting a linking demand before the linking demand is issued. The linking demand may be transmitted separately from the authentication request according to success of the authentication for the proxy requesting individual PR responding to the authentication request. The linking demand including the authentication request may include executing the authentication request as preprocessing of issuance of the linking demand (a case of a 3-2-th authentication method explained later). In another example, the authentication processing for the proxy requesting individual

PR may be requested together with the linking demand and executed together with the processing concerning the linking setting (a case of a first authentication method and the like explained later). In still another example, the authentication processing for the proxy requesting individual PR may be started according to a demand from the management server 1 or the external server after the linking demand is transmitted.

According to the above, in the management server 1, an authentication result may be acquired together with the linking demand or may be acquired after the linking demand. When the authentication is successful, the acquiring the authentication result in the management server 1 may include acquiring an authentication result indicating that the authentication is successful and acquiring indirect information such as the linking demand (that is, indirectly acquiring the authentication result) according to the success of the authentication. On the other hand, when the authentication is unsuccessful, the acquiring the authentication result in the management server 1 may include acquiring an authentication result indicating that the authentication is unsuccessful and the authentication result not reaching the management server 1 (the authentication result not being acquired).

Note that a computer that executes the authentication processing may be changed as appropriate according to an embodiment. Authentication for at least one of the proxy individual PI of the first target and the target individual TA of the second target may be executed together with the authentication for the proxy requesting individual PR of the first target. Authentication processing for the proxy individual PI may be executed in the same manner as the authentication processing for the proxy requesting individual PR. When the authentication processing for the proxy individual PI is executed, setting of a correspondence relation may be performed according to the proxy individual PI being successfully authenticated together with the proxy requesting individual PR. The authentication processing for the second target may be executed by any computer in the same manner as the authentication processing for the first target. In an example, success of the authentication for the second target (the target individual TA) may be determined by the management server 1 or the external server (for example, the second server 3).

When the authentication processing for the target individual TA of the second target is executed, the setting of the correspondence relation may be performed according to the target individual TA being successfully authenticated together with the proxy requesting individual PR.

The order of the authentication processing for the first target and the second target may not be particularly limited and may be determined as appropriate according to an embodiment. The authentication processing for the first target may be at least partially executed in parallel to the authentication processing for the second target. Authentication requests of the targets may include data (for example, identifiers, specific information, and certificates) used for the authentication for the targets. When the authentication processing for the targets is executed by the management server 1 or the external server, the acquiring the authentication result in the management server 1 may include executing the authentication processing in the management server 1 to acquire the authentication result or acquiring the authentication result from the external server. For example, the management server 1 may execute the authentication processing according to the received authentication request or may transmit the authentication request to the external server to request the external server to execute the authentication processing. For example, the terminal of at least one of the first target and the second target may transmit the authentication request to the external server. The external server may execute the authentication processing in response to the received authentication request or may transmit the authentication request to the management server 1 to request the management server 1 to execute the authentication processing. When the authentication processing is executed, the external server may directly transmit the authentication result to the management server 1 or may transmit the authentication result to the management server 1 through an external computer (for example, at least one terminal).

### (Data Exchange)

In the present embodiment, a series of processing concerning the linking setting in the proxy route may be started with data exchange between the first terminal 4 and the second terminal 5 as a trigger. That is, when a use relation occurs between the proxy individual PI and the target individual TA in response to the request of the proxy requesting individual PR, the first terminal 4 and the second terminal 5 may execute data exchange as appropriate. The occurrence of the use relation (a use start) may be detected by this data exchange. According to an example of the present embodiment, it can be expected that the occurrence of the use relation can be easily detected by the data exchange.

A method of the data exchange may not be particularly limited and may be selected as appropriate according to an embodiment. In an example, the data exchange between the first terminal 4 and the second terminal 5 may be performed by wireless or wired data communication. The wireless communication may be performed by, for example, NFC (Near Field Communication), Bluetooth (registered trademark), or Wi-fi (registered trademark). The wired communication may be performed by, for example, a wired LAN (Local Area Network) or a USB (Universal Serial Bus). The data communication may be directly performed between the first terminal 4 and the second terminal 5 or may be indirectly performed via another computer. In another example, the data exchange may be performed by a method other than the data communication such as reading of a two-dimensional code. For example, the data exchange may be performed by one of the first terminal 4 and the second terminal 5 displaying data on a display and the other reading the displayed data using a sensor such as an image sensor.

FIG. 4 schematically illustrates an example of data exchange according to the present embodiment. In an example of the present embodiment, the first terminal 4 of the proxy individual PI may include a short-range wireless communication module 431. The second terminal 5 of the target individual TA may include a short-range wireless communication module 531. Accordingly, data exchange between the terminals may be performed by short-range wireless communication. Note that a type of the short-range wireless communication modules (431 and 531) may not be particularly limited and may be selected as appropriate according to an embodiment. The short-range wireless communication may include, for example, Bluetooth (registered trademark), Wi-fi (registered trademark), RFID (Radio-Frequency Identification), ZigBee (registered trademark), and infrared transmission. In an example of the present embodiment, it is possible to detect occurrence of a use relation with the data exchange by the short-range wireless communication as a trigger. Since it is possible to guarantee that the first terminal 4 and the second terminal 5 are present in a range in which the short-range wireless communication is possible, it can be expected that occurrence of the use relation between the proxy individual PI and the target individual TA can be properly detected.

Note that the linking demand may include at least one of the first identifier I10 of the proxy requesting individual PR and the second identifier I20 of the target individual TA. When the linking demand includes the first identifier I10 of the proxy requesting individual PR, the first identifier I10 may be transmitted from at least one of the first terminal 4 and the second terminal 5. When the first identifier I10 is transmitted from the first terminal 4, the first terminal 4 may acquire the first identifier I10 at any timing. In an example, the first identifier I10 of the proxy requesting individual PR may be given to the first terminal 4 from the terminal 6 or the external server (the first server 2 or the like) in the proxy request or may be retained in advance by an address book or the like. Accordingly, the first terminal 4 may store the first identifier I10 of the proxy requesting individual PR in a memory resource of the first terminal 4 in advance. The first terminal 4 may acquire the first identifier I10 of the proxy requesting individual PR from the memory resource. In another example, the first terminal 4 may acquire the first identifier I10 of the proxy requesting individual PR using an input device, a sensor, or the like. When the first identifier I10 of the proxy requesting individual PR is transmitted from the second terminal 5, in the data exchange, the second terminal 5 may be given the first identifier I10 of the proxy requesting individual PR from the first terminal 4 or may acquire the first identifier I10 with a spontaneous operation. In an example, the second terminal 5 may acquire the first identifier I10 from the first terminal 4 by data communication. In another example, the second terminal 5 may acquire the first identifier I10 of the proxy requesting individual PR from the first terminal 4 with a method other than the data communication such as reading the first identifier I10 displayed as a two-dimensional code in the first terminal 4. In another example, the second terminal 5 may acquire the first identifier I10 of the proxy requesting individual PR from any one of the first target (the proxy individual PI or the proxy requesting individual PR) and the first terminal 4 using a device such as an input device or a sensor. The acquiring the first identifier I10 from the first target may include, when a human relating to the second target is present (for example, the second target is a human or the second target is operated by a human) and the first target is an object, the human relating to the second target operating the device by proxy to acquire the first identifier I10. In still another example, the second terminal 5 may acquire the first identifier I10 of the proxy requesting individual PR from the terminal 6 or the external server (the first server 2 or the like).

When the linking demand includes the second identifier I20, the second identifier I20 may be transmitted from at least one of the first terminal 4 and the second terminal 5. When the second identifier I20 is transmitted from the second terminal 5, the second terminal 5 may acquire the second identifier I20 at any timing. In an example, the second identifier I20 may be stored in a memory resource of the second terminal 5 in advance. The second terminal 5 may acquire the second identifier I20 from the memory resource. In another example, the second terminal 5 may acquire the second identifier I20 using an input device, a sensor, or the like. When the second identifier I20 is transmitted from the first terminal 4, in the data exchange, the first terminal 4 may be given the second identifier I20 from the second terminal 5 or may acquire the second identifier I20 with a spontaneous operation.

In an example, the first terminal 4 may acquire the second identifier I20 from the second terminal 5 by data communication. In another example, the first terminal 4 may acquire the second identifier I20 from the second terminal 5 with a method other than the data communication such as reading the second identifier I20 displayed as a two-dimensional code in the second terminal 5. In still another example, the first terminal 4 may acquire the second identifier I20 from one of the second target and the second terminal 5 using a device such as an input device or a sensor. The acquiring the second identifier I20 from the second target may include, when a human relating to the first target is present (for example, the first target is a human or the first target is operated by a human) and the second target is an object, the human relating to the first target operating the device by proxy to acquire the second identifier I20.

The linking demand may include the first identifier I10 of the proxy individual PI. When the linking demand includes the first identifier I10 of the proxy individual PI, the first identifier I10 of the proxy individual PI may be transmitted from at least one of the first terminal 4 and the second terminal 5. When the first identifier I10 of the proxy individual PI is transmitted from the first terminal 4, the first terminal 4 may acquire the first identifier I10 at any timing. In an example, the first identifier I10 of the proxy individual PI may be stored in the memory resource of the first terminal 4 in advance. The first terminal 4 may acquire the first identifier I10 of the proxy individual PI from the memory resource. In another example, the first terminal 4 may acquire the first identifier I10 of the proxy individual PI using an input device, a sensor, or the like. When the first identifier I10 of the proxy individual PI is transmitted from the second terminal 5, in the data exchange, the second terminal 5 may be given the first identifier I10 of the proxy individual PI from the first terminal 4 or may acquire the first identifier I10 with a spontaneous operation. In an example, the second terminal 5 may acquire the first identifier I10 of the proxy individual PI from the first terminal 4 by data communication. In another example, the second terminal 5 may acquire the first identifier I10 of the proxy individual PI with a method other than the data communication such as reading the first identifier I10 displayed as a two-dimensional code in the first terminal 4. In still another example, the second terminal 5 may acquire the first identifier I10 of the proxy individual PI from one of the first target (the proxy individual PI) and the first terminal 4 using a device such as an input device or a sensor.

For example, in the example illustrated in FIG. 2 explained above, the first terminal 4 may perform data communication or read a code to acquire the second identifier I20 (the mobile body identifier) from the second terminal 5. When the second identifier I20 is the car registration number, the first terminal 4 may image a license plate with the image sensor and analyze an obtained image to acquire the second identifier I20. The first terminal 4 may acquire the second identifier I20 via the input device. The second terminal 5 may acquire the second identifier I20 as appropriate. The second terminal 5 may perform data communication or read a code to acquire the first identifier I10 (the user identifier). When the first identifier 110 is a personal ID number or the like described in a card, the second terminal 5 may image the card with the image sensor and analyze an obtained image to acquire the first identifier I10. The second terminal 5 may acquire the first identifier I10 via the input device. The first terminal 4 may acquire the first identifier I10 as appropriate.

When the input device is used to acquire data such as the identifiers (I10 and I20), one terminal acquiring data from the other target may include one target operating the input device to acquire data of the other target in addition to the other target operating the input device to acquire data of the other target. For example, in the example illustrated in FIG. 2 explained above, when the second identifier I20 is the car registration number and the input device is used to acquire the car registration number, the first terminal 4 may acquire the second identifier I20 from the mobile body (the second target) according to input of the car registration number by the user (the first target) via the input device.

Note that the acquiring data of the other target with one terminal may not always be executed in the data exchange. One terminal may acquire the data of the other target at any timing different from the data exchange. As a data acquisition method, any one of the methods explained above may be adopted. In this case, the data exchange between the first terminal 4 and the second terminal 5 may function as a simple trigger for starting a series of processing concerning the linking setting.

### (Verification Processing)

A verification method for an agency may be selected as appropriate according to an embodiment. A configuration of the authority verification information AU may be determined as appropriate according to the verification method. In this embodiment, verification of the agency may be performed by at least one of the following two methods.

### (1) First Method

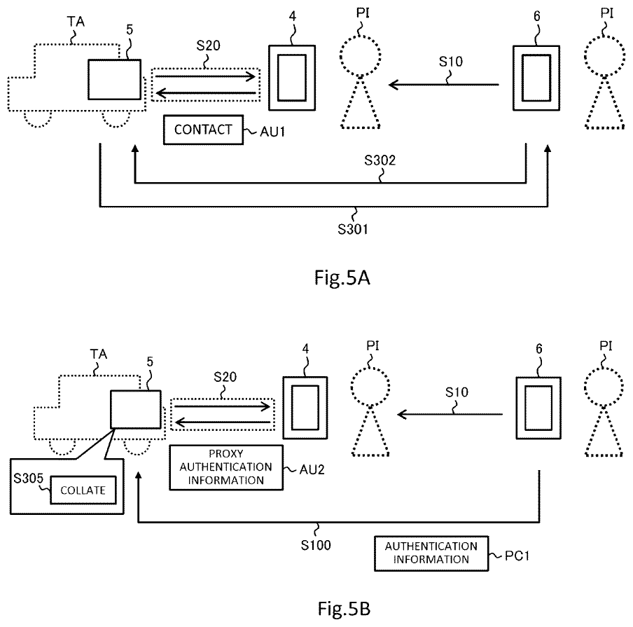

FIG. 5A schematically illustrates an example of a process of verification processing for an agency by a first method. In the first method, the authority verification information AU may include a contact AU1 that executes approval processing. Accordingly, the verifying the agency may be configured by making an inquiry with the contact AU1 included in the authority verification information AU (step S301) and receiving an answer of approval as an execution result of the approval processing (step S302).

The approval processing for the agency may be automatically performed by computer processing or may be manually performed by partially including user operation. Content of the approval processing may be designed as appropriate according to an embodiment. In a simple example, the inquiry may include an approval button and the approval processing may be operating the approval button included in the inquiry. If the inquiry can be notified to a computer that executes the approval processing, the contact AU1 may not be particularly limited and may be selected as appropriate according to an embodiment.

Note that, in the example illustrated in FIG. 5A, the contact AU1 is a contact of the terminal 6. In an example, the approval processing may be executed in the terminal 6. In this case, the contact AU1 (the contact of the terminal 6) may be, for example, a telephone number, an electronic mail address, account information of a communication system application (for example, an application of Social Networking Service), or an identification number. However, the computer that executes the approval processing may not be limited to the terminal 6. In another example, the approval processing may be executed by the external computer such as the first server 2. In this case, the contact AU1 may be an address of the external computer such as a URL (Uniform Resource Locator). The address may be a one-time address. The contact AU1 may be communicated to the second terminal 5 as appropriate. In an example, the authority imparting information AG may include the authority verification information AU (the contact AU1). In the data exchange, the first terminal 4 may give the contact AU1 included in the authority imparting information AG to the second terminal 5.

When the approval processing is automatically executed by the terminal 6 or the external computer, authenticity of the agency may be verified by any method. In an example, the authenticity of the agency may be verified by authentication for the proxy individual PI. For example, according to designation of the proxy individual PI by the terminal 6, the terminal 6 or the external computer may retain information (the first identifier I10, data used for authentication, and the like) concerning the proxy individual PI in advance. The second terminal 5 may acquire the information concerning the proxy individual PI from the proxy individual PI or the first terminal 4 and notify an inquiry including the acquired information to the terminal 6 or the external computer. The information concerning the proxy individual PI may include authentication information for authenticating the proxy individual PI. The authentication information may be selected as appropriate according to an embodiment. In an example, the authentication information may include specific information. The specific information may include, for example, information deriving from a target (an individual), information deriving from a terminal, temporarily generated information, and information generated by other any methods. The information deriving from the target may be, for example, biological information or uniquely imparted identification information. The biological information may be, for example, a face image, a fingerprint, or a voiceprint. The temporarily generated information may be configured by, for example, a timestamp, a random number, or a hash value. The terminal 6 or the external computer may collate designation information of the proxy individual PI retained in advance and acquired information of the proxy individual PI notified from the second terminal 5 to verify the authenticity of the agency. According to success of the collation of the information, the terminal 6 or the external computer may return an answer indicating approval to the second terminal 5. On the other hand, when the collation of the information is unsuccessful, the terminal 6 or the external computer may return an answer indicating disapproval to the second terminal 5 and urge reacquisition of information concerning the proxy individual PI.

In the example illustrated in FIG. 5A, after the inquiry (an approval request) is notified to the terminal 6 in step S301, when a response of the terminal 6 is not received within a fixed period, the second terminal 5 may notify a reminder to the terminal 6 and urge the response in step S302. When a response is not received within the fixed period, instead of the reminder, the second terminal 5 may making an inquiry with the external computer to cause the external computer to execute alternative approval processing. After the reminder, when a response is not received, the second terminal 5 may cause the external computer to execute alternative approval.

When the first method is adopted, at least one of the first terminal 4 and the second terminal 5 may acquire, at any timing, data (for example, the first identifier I10, specific information, and a certificate) used for authentication for the proxy requesting individual PR. In an example, in step S302, the terminal 6 or the external computer may give the data used for the authentication for the proxy requesting individual PR to the second terminal 5 together with the answer indicating the approval. However, a transmission route of the data used for the authentication for the proxy requesting individual PR may not be limited to such an example and may be selected as appropriate according to an embodiment. In another example, the terminal 6 or the external computer may give the data used for the authentication for the proxy requesting individual PR to the first terminal 4.

Basically, the data exchange in step S301 and step S302 may be performed by direct or indirect data communication by radio or wire. However, the data exchange between the second terminal 5 and the computer (the terminal 6 or the external computer) of the contact AU1 may not be limited to such an example and may be selected as appropriate according to an embodiment. Depending on a case, a method other than the data communication such as reading of a two-dimensional code may be used for the data exchange between the second terminal 5 and the computer of the contact AU1.

The second terminal 5 may acquire information for checking the proxy individual PI from the first terminal 4 or the proxy individual PI and, in the inquiry of the approval, notify the acquired information to the terminal 6. The terminal 6 may output the information concerning the proxy individual PI (for example, display the information on a display) simultaneously with the inquiry of the approval to urge check of the proxy individual PI. In an example, the information for checking the proxy individual PI may be, for example, the first identifier I10 of the proxy individual PI. When the first target is the user, the information for checking the proxy individual PI may include, for example, information used for authentication for a face image or the like of the proxy individual PI (the proxy user). In the first terminal 4 and the second terminal 5, this information may be acquired in order to authenticate the proxy individual PI in the linking demand. That is, data acquired for the authentication for the proxy individual PI may also be used to check the proxy individual PI in the approval processing. Accordingly, efficiency of data acquisition can be expected.

### (2) Second Method

FIG. 5B schematically illustrates an example of a process of verification processing for an agency by a second method. In the second method, the second terminal 5 is further configured to receive notification of authentication information PC1 from the terminal 6 of the proxy requesting individual PR (step S100). The authority verification information AU may include proxy authentication information AU2 corresponding to the authentication information PC1. Verifying the agency may be configured by collating the proxy authentication information AU2 included in the authority verification information AU and the authentication information PC1 notified from the terminal 6 of the proxy requesting individual PR (step S305).

The authentication information PC1 may be the same as the authentication information of the proxy individual PI in the first method. In an example, the authentication information PC1 may be configured by temporarily generated information. The authentication information PC1 may include specific information of the proxy individual PI. The proxy authentication information AU2 corresponds to the authentication information PC1. In an example, the authentication information PC1 retained by the terminal 6 or the external computer (the first server 2 or the like) may be communicated to the first terminal 4 together with the authority imparting information AG. The authentication information PC1 communicated to the first terminal 4 may be used as the proxy authentication information AU2. That is, the authority imparting information AG may include the authentication information PC1 as the authority verification information AU (the proxy authentication information AU2). In the data exchange, the first terminal 4 may give the proxy authentication information AU2 included in the authority imparting information AG to the second terminal 5. In another example, the authentication information PC1 may be registered in advance. When the agency is verified, the proxy authentication information AU2 may be acquired according to the authentication information PC1. The authentication information PC1 may be retained in the first target information O10. For example, when the first target is the user, the authentication information PC1 may be a registered face image and the proxy authentication information AU2 may be a face image acquired in the verification of the agency. That is, the authority verification information AU (the proxy authentication information AU2) may be acquired in the verification of the agency.

The second terminal 5 may directly and indirectly receive the authentication information PC1. The second terminal 5 may acquire the authentication information PC1 at any timing before the verification processing for the agency is executed. The target individual TA of the second target may be designated by the proxy requesting individual PR or may be selected by the proxy individual PI.

In an example, the terminal 6 may include a short-range wireless communication module and may execute data exchange by short-range wireless communication between the terminal 6 and the second terminal 5. An individual of the second terminal 5 acting as a counterparty of the data exchange may be designated as the target individual TA. The second terminal 5 may receive the authentication information PC1 in the data exchange. The data exchange may be performed by data communication by radio or wire other than the short-range wireless communication or may be performed by a method other than the data communication such as reading of a two-dimensional code.

In another example, the terminal 6 may access a list of the second target in the setting concerning the proxy and designate an individual (the target individual TA) for which proxy linking is permitted from an individual registered in the list. The list may include identification information of the individuals of the second target and information such as a contact of the terminal (the second terminal 5). The list may be retained in the terminal 6 or the external computer (for example, the second server 3). The designation of the target individual TA may be automatically performed by computer processing or may be manually performed by at least partially including user operation. After the target individual TA is designated, the terminal 6 may notify the authentication information PC1 to the terminal (the second terminal 5) of the designated target individual TA. Accordingly, the second terminal 5 may receive the authentication information PC1.

In still another example, the target individual TA may not be designated by the proxy requesting individual PR but may be designated by the proxy individual PI. For example, the proxy requesting individual PR may designate the second target in any range, for example, belonging to a specific operation institution and the proxy individual PI may select the target individual TA out of the range. As an example in this case, data such as the authentication information PC1 may be retained in the external computer such as the first server 2. When data exchange with the first terminal 4 is started, as the processing in step S100, the second terminal 5 may access the external computer and download the data such as the authentication information PC1. Data to be downloaded may be selected as appropriate. For example, in the external computer, the data such as the authentication information PC1 may be retained in correlation with at least one of the proxy requesting individual PR and the proxy individual PI. According to operation by the proxy individual PI, data (the first identifier I10 or the like) from the first terminal 4, or the like, the second terminal 5 may receive designation of at least one of the proxy requesting individual PR and the proxy individual PI and may download data corresponding to the designated individual. After downloading the data, the second terminal 5 may receive use application by the proxy individual PI and execute the verification processing by step S305. Note that, when the target individual TA is designated by the proxy requesting individual PR, in use by the proxy individual PI, the second terminal 5 may download the data such as the authentication information PC1. For example, when effective start time of the agency is designated in advance by the proxy requesting individual PR, the second terminal 5 may download the data such as the authentication information PC1 according to arrival of the effective start time.

A method of collating the authentication information PC1 and the proxy authentication information AU2 may be determined as appropriate according to information adopted as the information (PC1 and AU2). In an example, the second terminal 5 may determine success of the collation according to a matching degree of the authentication information PC1 and the proxy authentication information AU2. In another example, the second terminal 5 may determine success of the collation according to whether a correspondence relation is established between the authentication information PC1 and the proxy authentication information AU2. As a specific example, in a computer in a communication route, predetermined arithmetic processing (hashing or the like) may be applied to at least one of the authentication information PC1 and the proxy authentication information AU2. For example, the proxy authentication information AU2 may be generated by hashing the authentication information PC1. The predetermined arithmetic processing may be executed in at least any one of the terminal 6, the first terminal 4, the second terminal 5, and the external computer (for example, the first server 2). Accordingly, the second terminal 5 may determine success of the collation according to whether a correspondence relation defined by the predetermined arithmetic processing is established between the authentication information PC1 and the proxy authentication information AU2. For example, the second terminal 5 may hash the authentication information PC1 and determine success of the collation according to whether an obtained hash value and the proxy authentication information AU2 coincide. Collation processing may be executed by the external computer such as the first server 2. The second terminal 5 may acquire a result of the collation from the external computer. The indirectly receiving the authentication information PC1 may include receiving the result of the collation executed by the external computer. When the collation is successful (that is, the verification of the agency is successful), the first terminal 4 and the second terminal 5 may proceed to processing concerning a linking demand. On the other hand, when the collation is unsuccessful, the second terminal 5 may not permit the processing for the proxy linking and may urge the first terminal 4 to retransmit the proxy authentication information AU2.

Note that at least one of the first terminal 4 and the second terminal 5 may acquire, at any timing, data (for example, the first identifier I10, specific information, and a certificate) used for authentication for the proxy requesting individual PR. In an example, in step S100, the second terminal 5 may acquire, from the terminal 6 or the external computer, together with the authentication information PC1, the data used for the authentication for the proxy requesting individual PR. However, a transmission route of the data used for the authentication for the proxy requesting individual PR may not be limited to such an example and may be selected as appropriate according to an embodiment. In another example, the first terminal 4 may acquire, together with the authority imparting information AG, the data used for the authentication for the proxy requesting individual PR. A method of acquiring data used for authentication may not be particularly limited and may be selected as appropriate according to an embodiment. In an example, the data used for authentication may be acquired by any device such as an input device or a sensor. The data used for authentication may be received from a device that already retains the data.

With at least one of the first method and the second method explained above, proper verification of an agency can be expected. Note that, when the first method or the second method is adopted, the authority verification information AU may include the contact AU1 that executes the approval processing or the proxy authentication information AU2 used for the authentication.

### (Notification Processing)

In an example, when at least one processing of the linking setting and the release is executed, the management server 1 may transmit notification indicating an execution result to at least one of the first terminal 4 and the second terminal 5. A transmission route of the notification may not be particularly limited and may be determined as appropriate according to an embodiment. The management server 1 may directly notify the execution result to at least one of the first terminal 4 and the second terminal 5. Alternatively, the management server 1 may indirectly notify the execution result to at least one of the first terminal 4 and the second terminal 5 via an external computer such as the servers (2 and 3).

Note that, when directly notifying the execution result, the management server 1 may acquire contacts of the terminals (4 and 5) as appropriate. The contacts may be telephone numbers, electronic mail addresses, account information of a communication system application (for example, an application of Social Networking Service), or identification numbers. The management server 1 may acquire information indicating the contacts of the terminals (4 and 5) at any timing. In an example, the management server 1 may acquire the information indicating the contacts at timing for receiving a demand such as a linking demand or a release demand. The information indicating the contacts may be transmitted from at least one of the terminals (4 and 5) and the servers (2 and 3).

In an example, when a correspondence relation between the proxy requesting individual PR and the target individual TA is set by the proxy individual PI, the management server 1 may transmit, to the terminal 6 of the proxy requesting individual PR, notification for informing the setting of the correspondence relation. The management server 1 may directly or indirectly transmit this notification to the terminal 6. When directly transmitting the notification, the management server 1 may acquire a contact of the terminal 6 at any timing. In an example, when a form in which the contact of the terminal 6 is used as the contact AU1 is adopted in the first method explained above, at least one of the first terminal 4 and the second terminal 5 may transmit the contact AU1 to the management server 1 together with the linking demand. In another example, the management server 1 may acquire the contact of the terminal 6 as appropriate from the external computer such as the first server 2. In still another example, when a form in which the management server 1 and the terminal 6 perform data communication is adopted, the management server 1 may acquire the contact of the terminal 6 in the data communication. Similarly, when the correspondence relation is released, the management server 1 may transmit, to the terminal 6 of the proxy requesting individual PR, notification for informing the release of the correspondence relation.

### (Linking Release)

In the present embodiment, the management server 1 may release the correspondence relation according to reception of a release demand from at least one of the first terminal 4 and the second terminal 5 or satisfaction of a predetermined release condition. The management server 1 may release the correspondence relation because of a factor relating to the proxy requesting individual PR.

### (1) Release Demand

In an example, the release demand may include at least one of the first identifier I10 of the proxy requesting individual PR and the second identifier I20 of the target individual TA to be configured to indicate a correspondence relation between release targets. When the linking information D10 includes the first identifier I10 of the proxy individual PI as agency information, the release demand may include the first identifier I10 of the proxy individual PI to be configured to indicate the correspondence relation between the release targets. In another example, the release demand may include alternative information to be configured to indicate the correspondence relation between the release targets.

When the first terminal 4 transmits a release demand including the second identifier I20, the first terminal 4 may acquire the second identifier I20 at any timing. In an example, in a linking demand, the first terminal 4 may acquire the second identifier I20 and store the acquired second identifier I20 in the memory resource. In the release demand, the first terminal 4 may acquire the second identifier I20 from the memory resource. When the first terminal 4 transmits a release demand including the first identifier I10 of the proxy requesting individual PR, the first terminal 4 may acquire the first identifier I10 of the proxy requesting individual PR at any timing. In an example, the first terminal 4 may acquire the first identifier I10 of the proxy requesting individual PR together with the authority imparting information AG and may store the acquired first identifier I10 in the memory resource. In the release demand, the first terminal 4 may acquire the first identifier I10 of the proxy requesting individual PR from the memory resource. When relationship is built between the proxy individual PI and the proxy requesting individual PR in advance, the first identifier I10 of the proxy requesting individual PR may be stored in the memory resource in advance. When the first terminal 4 transmits a release demand including the first identifier I10 of the proxy individual PI, the first terminal 4 may acquire the first identifier I10 of the proxy individual PI at any timing. In an example, the first identifier I10 of the proxy individual PI may be stored in the memory resource in advance. The first terminal 4 may acquire the first identifier I10 of the proxy individual PI from the memory resource.

Similarly, when the second terminal 5 transmits the release demand including the first identifier I10 of the proxy requesting individual PR, the second terminal 5 may acquire the first identifier I10 of the proxy requesting individual PR at any timing. In an example, in the verification of the agency or the linking demand, the second terminal 5 may acquire the first identifier I10 of the proxy requesting individual PR and may store the acquired first identifier I10 in the memory resource. In the release demand, the second terminal 5 may acquire the first identifier I10 of the proxy requesting individual PR from the memory resource. When the second terminal 5 transmits an authentication demand including the first identifier I10 of the proxy individual PI, the second terminal 5 may acquire the first identifier I10 of the proxy individual PI with the same method as the method of acquiring the first identifier I10 of the proxy requesting individual PR. When the second terminal 5 transmits a release demand including the second identifier I20, the second terminal 5 may acquire the second identifier I20 at any timing. In an example, the second identifier I20 may be stored in the memory resource in advance. The second terminal 5 may acquire the second identifier I20 from the memory resource.

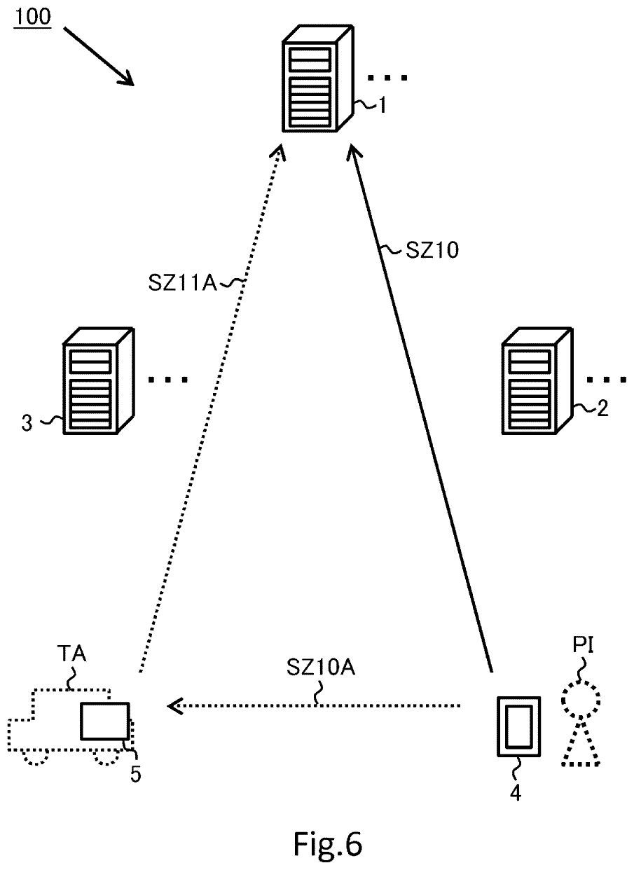

FIG. 6 schematically illustrates an example of a process of linking release according to the present embodiment. In the example illustrated in FIG. 6, as a first route, the first terminal 4 directly transmits a release demand to the management server 1 (step SZ10). As a second route, the first terminal 4 gives an instruction to the second terminal 5 (step SZ10A) and causes the second terminal 5 to directly transmit the release demand to the management server 1 (step SZ110A). However, a transmission route of the release demand may not be limited to such an example. The first terminal 4 may indirectly transmit the release demand to the management server 1 via the external computer such as the first server 2. In the second route, the second terminal 5 may indirectly transmit the release demand to the management server 1 via the external computer such as the second server 3. Note that a start point of the release demand may not be limited to the first terminal 4. In another example, the second terminal 5 may directly or indirectly transmit the release demand to the management server 1. The second terminal 5 may give an instruction to the first terminal 4 and cause the first terminal 4 to directly or indirectly transmit the release demand to the management server 1. After receiving the release demand, the management server 1 refers to the linking information D10 and releases a correspondence relation designated by an identifier included in the release demand. After this release processing, as at the time of the linking setting, the management server 1 may transmit notification indicating a result of the release processing to at least one of the first terminal 4 and the second terminal 5. The management server 1 may transmit, to the terminal 6 of the proxy requesting individual PR, notification for informing that the correspondence relation has been released.

In an example, the processing of the release demand may include authentication processing for at least one of the first target and the second target. The authentication processing in the release may be the same as the authentication processing in the linking setting explained above. However, in the release demand, the authentication processing may not always be executed. In another example, the processing of the release demand may be simplified by omitting the authentication processing.

A trigger of the release demand may be set as appropriate according to an embodiment. In an example, when at least one of the first target and the second target is the user, the release demand may be transmitted from at least one of the first terminal 4 and the second terminal 5 by operation of at least one of the first terminal 4 and the second terminal 5 by the user (including the proxy user). That is, the trigger of the release demand may be the operation by the user. In another example, any information processing may be executed in at least one of the first terminal 4 and the second terminal 5 according to extinction of a use relation. The release demand may be transmitted from at least one of the first terminal 4 and the second terminal 5 with the execution of the information processing as a trigger. For example, any information processing may be data exchange between the first terminal 4 and the second terminal 5. A method of data exchange in the linking release may be the same as the method of the data exchange in the linking setting. The data exchange at the time of the linking setting and the data exchange at the time of the linking release may be distinguished as appropriate. For example, in the example illustrated in FIG. 2, the second terminal 5 may include different sensor devices at an entrance and an exit such as a doorway of a bus and a ticket gate of a railroad. In this case, the data exchange at the time of the linking setting and the data exchange at the time of the linking release may be distinguished according to the sensor device used for the data exchange. For example, when the data exchange is executed by an application of a terminal, the application may be configured to be capable of switching a mode of the application to a linking setting mode and a linking release mode. In this case, the linking setting time and the linking release time may be distinguished according to the mode of the application.

### (II) Release Condition

The release condition indicates a condition for releasing a correspondence relation between targets. The release condition may be defined as appropriate according to an embodiment.

In an example, the release condition may be defined to release the correspondence relation at optionally set release time. The release time may be given by, for example, designation by the user or designation from another application (a scheduler or the like). In this case, the management server 1 may release the correspondence relation between the targets according to arrival of the release time. The release time may be set as the expiration date of the linking information D10 explained above. When the release time is set as the expiration date, the management server 1 may treat the correspondence relation between the targets as being released according to the arrival of the release time.

In another example, the number of correspondence relations that can be set for the same individuals of targets may be infinite or may be finite. When the number of correspondence relations that can be set is finite, an upper limit value (a threshold) may be provided for the number of the correspondence relations that can be set for the same individuals. The threshold may be given as appropriate. When the number of correspondence relations set for a relevant individual of at least one of the first target and the second target exceeds the upper limit value, the management server 1 may release at least any one of the correspondence relations set for the relevant individual. Which correspondence relation should be released may be determined as appropriate according to priority, order, a type of a target, or the like. The management server 1 may transmit an inquiry concerning release to at least one of the first terminal 4 and the second terminal 5 and determine, according to an obtained answer, a correspondence relation to be released.

For example, as in the example illustrated in FIG. 2, the scene in which the first target is the user and the second target is the object to be used is assumed. In this case, the number of users who can be linked with the same object to be used may be infinite or may be finite. When the number of users who can be linked is finite, an upper limit value of the number of users who can be linked may be given as appropriate by a threshold. The threshold may be set according to an attribute (for example, the number of available passengers) of the object to be used. When receiving anew setting of a correspondence relation for a relevant individual of the object to be used, the management server 1 may refer to the linking information D10 and extract preceding correspondence relations set for the relevant individual of the object to be used and maintained. When redundancy of the setting of the correspondence relation for the relevant individual of the object to be used exceeds the threshold, the management server 1 discards a demand for the setting of the correspondence relation received anew or release at least any one of the extracted preceding correspondence relations. When releasing the preceding correspondence relation, the management server 1 may determine, according to priority, order (for example, a correspondence relation set earlier is released), or the like of the user, a correspondence relation to be released.

As a specific example, in the example illustrated in FIG. 2, it is assumed that the mobile body is a private car and the first user and the second user are, for example, a family and, therefore, share a target private car. The private car may be replaced with an object to be always used. For convenience of explanation, it is assumed that the number of users who can be linked with the target private car is one. In this case, while a correspondence relation between one of the first user and the second user and the target private car is set, in response to reception of setting of a correspondence relation between the other and the target private car, the management server 1 may release a preceding correspondence relation (a correspondence relation between the one and the target private car).

The same may be applied to the user. That is, the number of objects to be used that can be linked with the same user may be infinite or may be finite. When the number of objects to be used that can be linked is finite and the number of correspondence relations set for a relevant user exceeds an upper limit value, the management server 1 may discard a demand for setting of a correspondence relation received anew or release at least any one of extracted preceding correspondence relations. When releasing the preceding correspondence relation, the management server 1 may determine, according to priority, a type (for example, an object to be always used or an object to be temporarily used), and the like of an object to be used, a correspondence relation to be released.

### (III) Release by the Proxy Requesting Individual

In the case of the proxy, the correspondence relation between the proxy requesting individual PR and the target individual TA set by the proxy individual PI may be released by the proxy requesting individual PR. A method of releasing the correspondence relation with the proxy requesting individual PR may be designed as appropriate according to an embodiment. In the present embodiment, at least one method of the following two methods may be adopted.

(III-1) Release Demand from the Proxy Requesting Individual

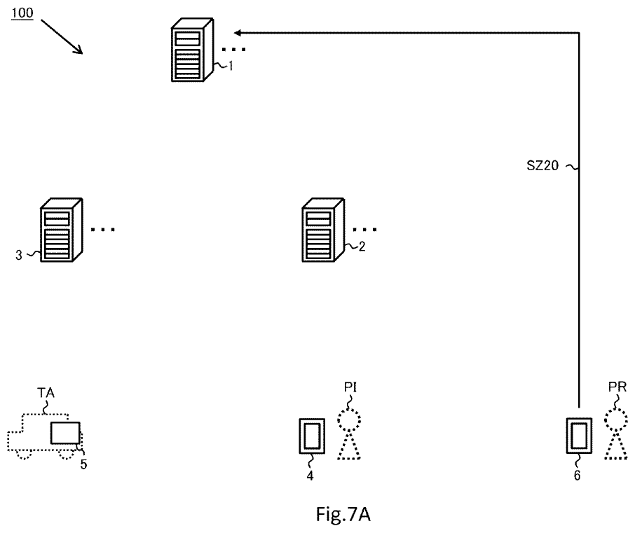

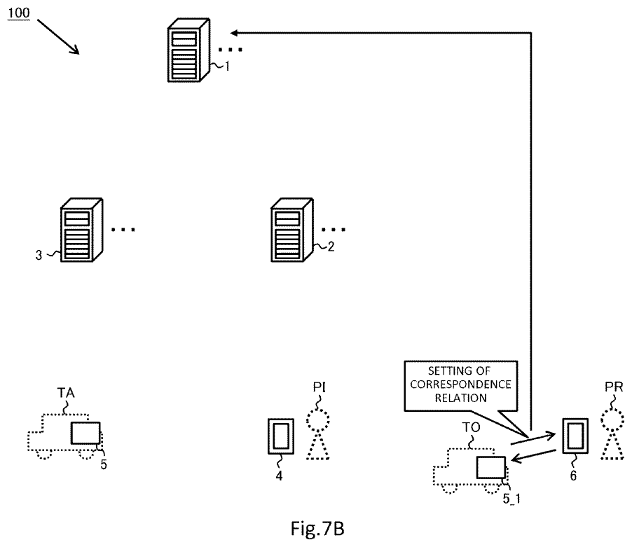

FIG. 7A schematically illustrates an example of a process of the linking release by the proxy requesting individual PR (a first release method). In the first release method, the management server 1 may receive a release demand from the terminal 6 of the proxy requesting individual PR. Accordingly, the management server 1 may be further configured to release the correspondence relation between the proxy requesting individual PR and the target individual TA according to the reception of the release demand from the terminal 6.

Like the release demand from at least one of the first terminal 4 and the second terminal 5 explained above, the release demand from the terminal 6 may include at least one of the first identifier I10 of the proxy requesting individual PR, the first identifier I10 of the proxy individual PI, and the second identifier I20 of the target individual TA to be configured to indicate a correspondence relation between release targets. The release demand from the terminal 6 may include alternative information to be configured to indicate the correspondence relation between the release targets.

A transmission route of the release demand may be selected as appropriate according to an embodiment. In the example illustrated in FIG. 7A, the terminal 6 directly transmits the release demand to the management server 1 (step SZ200). The transmission route of the release demand may not be limited to such an example. The terminal 6 may indirectly transmit the release demand to the management server 1 through the first server 2, the first terminal 4, the second terminal 5, and the like. The terminal 6 may give an instruction to at least one of the first terminal 4 and the second terminal 5 and cause at least one of the first terminal 4 and the second terminal 5 to directly or indirectly transmit the release demand to the management server 1. The other components of the release demand from the terminal 6 may be the same as the components of the release demand from at least one of the first terminal 4 and the second terminal 5.

### (III-2) Setting of a New Correspondence Relation by the Proxy Requesting Individual

FIG. 7B schematically illustrates an example of a process of the linking release by the proxy requesting individual PR (a second release method). In the second release method, the management server 1 may be further configured to release the correspondence relation between the proxy requesting individual PR and the target individual TA according to the correspondence relation between the proxy requesting individual PR and the other individual TO of the second target being set by the proxy requesting individual PR. That is, the management server 1 may release a correspondence relation with the target individual TA set earlier by the proxy individual PI according to a new correspondence relation being set by the proxy requesting individual PR.

The correspondence relation between the proxy requesting individual PR and the other individual TO of the second target may be set by the processing of the normal route. In an example, data exchange may be performed between the terminal 6 of the proxy requesting individual PR and a terminal 5_1 of another individual TO of the second target according to occurrence of a use relation between the proxy requesting individual PR and the other individual TO of the second target. At least one of the terminal 6 of the proxy requesting individual PR and the terminal 5_1 of the second target may transmit a linking demand toward the management server 1. The management server 1 may set, according to the linking demand, a correspondence relation between the proxy requesting individual PR and the other individual TO of the second target.

A new correspondence relation with the other individual TO is set, whereby the proxy requesting individual PR becomes capable of exercising an authority via the other individual TO. In order to prevent the exercise of the authority via the other individual TO and the exercise of the authority via the target individual TA from coexisting, according to the setting of the new correspondence relation, the management server 1 may release the correspondence relation with the target individual TA set earlier. Note that, in another example, the management server 1 may maintain both of the correspondence relation with the other individual TO and the correspondence relation with the target individual TA by the proxy individual PI to allow the exercise of the authority via the other individual TO and the exercise of the authority via the target individual TA to coexist.

As explained above, the management server 1 may release the correspondence relation according to the reception of the release demand from at least one of the first terminal 4 and the second terminal 5 or the satisfaction of the predetermined release condition. The management server 1 may release the correspondence relation because of the factor relating to the proxy requesting individual PR. Accordingly, it is possible to track extinction of the use relation between the first target and the second target. Note that the linking information D10 after the correspondence relation is released may be stored as a history.

### (Check Processing for Use Continuation)

As one of optional configurations, after setting the correspondence relation between the relevant individuals of the first target and the second target, the management server 1 may further executes processing (check processing) for checking whether a use relation between the relevant individuals continues. When the correspondence relation is set by the proxy route, the management server 1 may execute check processing for checking continuation of the use relation between the proxy individual PI and the target individual TA. A method of checking the use continuation may be selected as appropriate according to an embodiment. In the present embodiment, at least any one of the following three methods may be adopted as the method of checking the use relation.

(i-1) Check Processing by Authentication

In an example, the management server 1 may authenticate at least one of the first target (the proxy individual PI) and the second target (the target individual TA) via at least one of the first terminal 4 and the second terminal 5 to check the continuation of the use relation. Like the linking setting or the like, an authentication method may be performed by any method. In the example illustrated in FIG. 2, the authentication for the user may be performed by a method of, for example, performing face authentication for the user using an image sensor included in the mobile body, performing fingerprint authentication for the user using a fingerprint reading device attached to a steering wheel, or causing the user to utter and performing voiceprint authentication using a microphone included in the mobile body. The authentication processing may be executed by at least any one of the terminals (4 and 5), the servers (2 and 3), and the management server 1. When the authentication processing is executed by the servers (2 and 3), data used for the authentication may be directly transmitted from the terminals (4 and 5) to the servers (2 and 3) or may be indirectly transmitted via the external computer such as the management server 1. When the authentication processing is executed by the management server 1, the data used for the authentication may be directly transmitted from the terminals (4 and 5) to the management server 1 or may be indirectly transmitted via the external computer such as the servers (2 and 3). The management server 1 may acquire an authentication result as appropriate and, when authentication for a target is successful in the acquired authentication result, determine that the use relation continues and, when the authentication is unsuccessful, determine that the use relation does not continue.

(i-2) Check Processing by Notification

In another example, when at least one of the first target and the second target is the user (for example, the case of FIG. 2), the management server 1 may directly or indirectly transmit check notification including operation pieces to at least one of the first terminal 4 and the second terminal 5. The operation pieces may be configured by, for example, a check button, a return button, and links. A transmission destination of the check notification may not always correspond to the user. In the case of FIG. 2, the management server 1 may transmit the check notification to at least one of the first terminal 4 and the second terminal 5. The transmission destination of the check notification may overlap or may be different from a transmission destination of notification indicating a result of the processing concerning the linking. The check notification may be configured to directly or indirectly return a response to the management server 1 according to operation of the operation piece by the user. When receiving the response by the operation of the operation piece within a predetermined period, the management server 1 may determine that the use relation continues. When not receiving the response, the management server 1 may determine that the use relation does not continue.

(i-3) Check Processing by Position Information

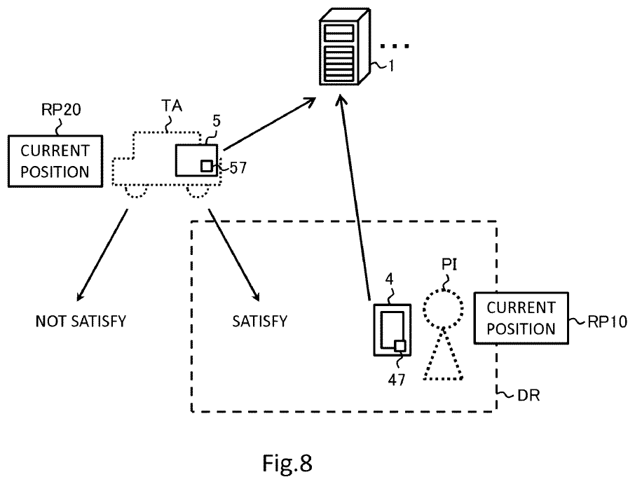

FIG. 8 schematically illustrates an example of check processing for use continuation according to the present embodiment. When a use relation in the real world is tracked, the first terminal 4 may include a positioning module 47. The first terminal 4 may be further configured to measure a current position of the first terminal 4 with the positioning module 47 of the first terminal 4 and transmit a measurement result of the current position of the first terminal 4 toward the management server 1. The second terminal 5 may include a positioning module 57. The second terminal 5 may be further configured to measure a current position of the second terminal 5 with the positioning module 57 of the second terminal 5 and transmit a measurement result of the current position of the second terminal 5 to the management server 1.

Accordingly, the management server 1 may be further configured to, after setting the correspondence relation between the proxy requesting individual PR and the target individual TA, receive measurement results of current positions (RP10 and RP20) of the terminals (4 and 5) from the terminals (4 and 5), determine, in real time, whether the received measurement results of the current positions (RP10 and RP20) of the terminals (4 and 5) satisfy a condition of a use relation, and, when the measurement results of the current positions (RP10 and RP20) of the terminals (4 and 5) satisfy the condition of the use relation, determine that the use relation between the proxy individual PI and the target individual TA continues and, otherwise, determine that the use relation does not continue.

The condition of the use relation may be set as appropriate according to an embodiment to, for example, the user approaching the mobile body to a degree of riding on the mobile body. In an example, the condition of the use relation may be specified by a range DR of a distance based on the current position RP10 of the first terminal 4 and the current position RP20 of the second terminal 5. In this case, it may be determined according to whether the user is present within the range DR, whether the condition of the user relation is satisfied. In FIG. 8, a scene in which the current position RP10 of the first terminal 4 is used as a reference is assumed.

In this scene, when the current position RP20 of the second terminal 5 is within the range DR, it may be determined that the condition of the use relation is satisfied. On the other hand, when the current position RP20 of the second terminal 5 is outside the range DR, it may be determined that the condition of the use relation is not satisfied.

Note that the range DR may be set as appropriate such that the second target in which a use relation occurs can be determined. A shape of the range DR may be optionally specified. In the range DR, distances in the directions may be specified the same or may be specified to be different in at least some of the directions.

A type of the positioning modules (47 and 57) may not be particularly limited and may be selected as appropriate according to an embodiment. The positioning modules (47 and 57) may be, for example, GPS (Global Positioning Satellite) modules or GNSS (Global Navigation Satellite System) modules.

The current positions (RP10 and RP20) of the terminals (4 and 5) may be transmitted toward the management server 1 at any timing before the check processing is executed. In an example, as spontaneous information processing for, for example, periodically transmitting current positions, the terminals (4 and 5) may report information concerning the current positions to the management server 1. In this case, using, as the current positions (RP10 and RP20), current positions reported from the terminals (4 and 5) most recently, the management server 1 may determine whether the condition of the use relation is satisfied. In another example, the management server 1 may directly or indirectly transmit a request to the terminals (4 and 5) at any timing before the check processing is executed. In response to the request, the terminals (4 and 5) may report the most recent current positions (RP10 and RP20) to the management server 1 in real time. The management server 1 may determine, from information concerning the most recent current positions (RP10 and RP20) reported in real time, whether the condition of the use relation is satisfied.

Note that, in all the forms, when information concerning a most recent current position of at least one of the first terminal 4 and the second terminal 5 cannot be obtained because of, for example, a power supply being off, the management server 1 may determine that the condition of the use relation is not satisfied.

A report destination of the information concerning the current positions may be selected as appropriate according to an embodiment. In an example, the report destination of the information concerning the current positions may be the management server 1. Accordingly, the information concerning the current positions may be managed by the management server 1. In another example, the report destination of the information concerning the current positions may be the external servers (the first server 2, the second server 3, and the like). Accordingly, the information concerning the current positions may be managed by the external servers. The management server 1 may acquire the information concerning the current positions (RP10 and RP20) from the external servers. The reporting to the management server 1 may include directly reporting to the management server 1 and indirectly reporting to the management server 1 via the external servers. The reported information concerning the current positions may be discarded after not being used for the check processing or may be stored as a history for at least a predetermined period. When a form of directly reporting to the management server 1 is adopted, the information concerning the current positions may be stored in the management server 1 or may be stored in the external servers (the first server 2, the second server 3, the NAS, and the like). Similarly, when a form of indirectly reporting to the management server 1 is adopted, the information concerning the current positions may be stored in the management server 1 or may be stored in the external servers. According to an example of the present embodiment, it is possible to appropriately check the continuation of the use relation by using relationship between the positions of the first terminal 4 and the second terminal 5.

(ii)

When determining that the use relation continues, the management server 1 may maintain setting of a correspondence relation between relevant individuals. On the other hand, when determining that the use relation does not continue, the management server 1 may release the correspondence relation between the relevant individuals. In the case of the proxy, according to the determination that the use relation between the proxy individual PI and the target individual TA continues, the management server 1 may maintain the setting of the correspondence relation between the proxy requesting individual PR and the target individual TA. On the other hand, according to the determination that the use relation between the proxy individual PI and the target individual TA does not continue, the management server 1 may release the correspondence relation between the proxy requesting individual PR and the target individual TA. The management server 1 may be configured to, after the correspondence relation is set, until the correspondence relation is released, repeatedly execute the relevant check processing periodically or nonperiodically to update a state of the correspondence relation.

Note that, when determining that the use relation does not continue, the management server 1 may immediately release the relevant correspondence relation or may release the relevant correspondence relation after putting the relevant correspondence relation on hold for a predetermined period. Timing for releasing the relevant correspondence relation may be determined as appropriate according to an embodiment. When the latter method is adopted, the management server 1 may revive the setting of the correspondence relation when, while the correspondence relation is put on hold, the continuation of the use relation is confirmed by at least any one of the methods explained above. Accordingly, for example, when the proxy requesting individual PR and the target individual TA are temporarily separated, it is possible to recover the setting of the correspondence relation at an early stage without immediately releasing the correspondence relation.

### (Use Scene of the Linking Information)

As explained above, the linking information D10 may be used in various scene. In an example, the linking information D10 may be used to simply track occurrence and extinction of a relation between the first target and the second target.

In another example, the linking information D10 may be used to make it possible to exercise at least a part of an authority linked with one of the first target and the second target from the other while the correspondence relation is set between the first target and the second target. For example, the management server 1 may be configured to, according to the correspondence relation between the first target and the second target being established, further execute enabling exercise of an authority via the second target for which the correspondence relation is set, the exercise of the authority being correlated with the corresponding first target. The management server 1 may be configured to further execute disabling the exercise of the authority according to the correspondence relation being released. In the case of the proxy, according to the correspondence relation between the proxy requesting individual PR and the target individual TA being set by the proxy individual PI, the management server 1 may enable proxy exercise of at least a part of the authority of the proxy requesting individual PR by the proxy individual PI via the target individual TA. On the other hand, according to the correspondence relation being released, the management server 1 may disable the proxy exercise of the authority. In the example illustrated in FIG. 2, the linking information D10 may be used to make it possible to exercise at least a part of an authority linked with the user from the mobile body while a correspondence relation is set between the user and the mobile body. According to an example of the present embodiment, it is possible to control, with the second target, permission and prohibition of authority exercise of the first target according to the setting and the release of the correspondence relation.

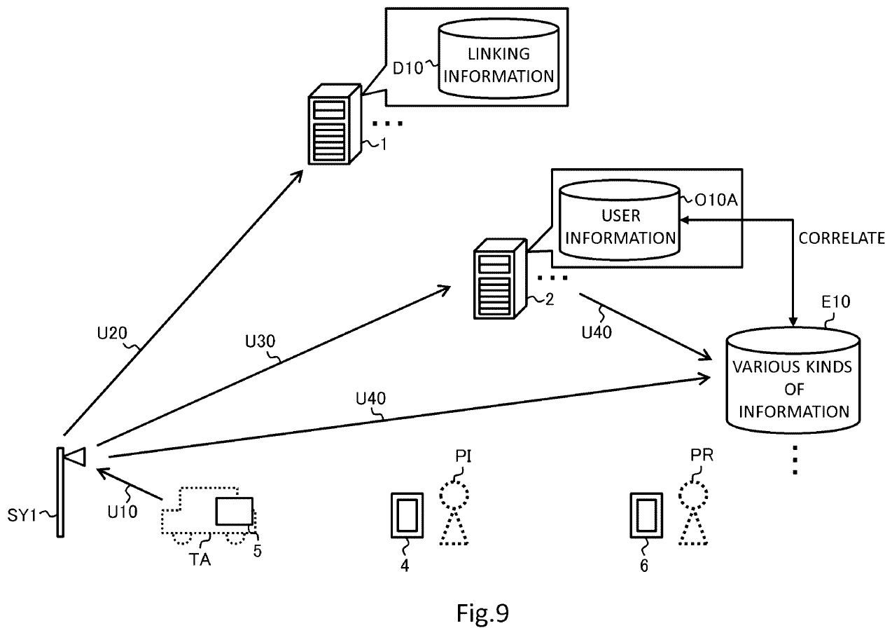

FIG. 9 schematically illustrates an example of a use scene of the linking information D10 according to the present embodiment. In FIG. 9, a scene in which the authority linked with the user is exercised from the mobile body is assumed in the example illustrated in FIG. 2. In the case of the proxy, the user who attempts the exercise of the authority is the proxy user (the proxy individual PI). It is assumed that the linking information D10 includes the first identifier I10 and the second identifier I20 to be configured to indicate the first target (the user) and the second target (the mobile body) for which the correspondence relation is set. Further, a scene in which information concerning the user is managed by the first server 2 and information concerning the mobile body is managed by the second server 3 is assumed. An external system SY1 is disposed in a place (for example, a parking lot) where various services are exercised and is configured to execute information processing for providing a service of a target to a user having an authority of the target. The configuration and the service of the external system SY1 may not be particularly limited and may be selected as appropriate according to an embodiment.

First, in step U10, the external system SY1 may acquire the second identifier I20 (the mobile body identifier) from a target mobile body. A method of acquiring the second identifier I20 may be selected as appropriate according to an embodiment. In an example, the external system SY1 may exchange data with the second terminal 5 to acquire the second identifier I20 from the second terminal 5. A method of the data exchange may be the same as the method of the data exchange between the first terminal 4 and the second terminal 5. In another example, when the second identifier I20 is a car registration number, the external system SY1 may image a license plate with an image sensor and analyze an obtained image to acquire the second identifier I20.

In step U20, the external system SY1 may use the acquired second identifier I20 as a query and inquire the management server 1 whether a correspondence relation effective at a target date and time is present for the target mobile body. Effective means that setting of a correspondence relation is maintained at the target date and time. Basically, the target date and time is the present (immediate time). However, the target date and time may not be limited to this. For example, when settlement processing for a date and time in the past is executed, the target date and time may be the date and time in the past. When an effective correspondence relation is present, the first identifier I10 (a user identifier) of a user linked with the target mobile body is extracted. In the case of the proxy, a user identifier of the proxy requesting user (the first identifier I10 of the proxy requesting individual PR) is extracted. On the other hand, when an effective correspondence relation is absent and a user liked with the target mobile body is not extracted, this processing may end.

In step U30, the external system SY1 may use the extracted first identifier I10 as a query and inquire the first server 2 about an authority exercisable for the user linked with the target mobile body. The first server 2 may refer to the first target information O10 (the user information O10A) and extract an authority that is correlated with the target user and is exercisable. When an exercisable authority is not extracted, this processing may end. Note that, in the first target information O10 (the user information O10A), whether to permit exercise of an authority by the mobile body may be set for each authority. An exercisable authority may be extracted according to this setting. When a target authority that the external system SY1 is about to exercise is not included in the exercisable authority, this processing may also end. The exercise target authority may be designated as appropriate at any timing. In an example, the exercise target authority may be designated in advance in the external system SY1 or may be designated by the user.

In step U40, when the target authority is included in the exercisable authority, the external system SY1 may execute processing for exercising the target authority. Accordingly, an authority linked with the user is exercised from the mobile body. The user can receive a service via the mobile body. For example, when the authority information includes information concerning public personal authentication and the target authority relates to the public personal authentication, the user can receive a public service via the mobile body. For example, when the authority information includes settlement information and the target authority relates to settlement, the user can receive a settlement service via the mobile body. The settlement service may be payment of a fee such as a usage fee of a parking lot, a fee of a freeway, a fee of drive-through, a fee of a public transportation, or a rental fee. For example, when the authority information includes information concerning an electronic prescription and the target authority is a way of receiving a drug prescribed by the electronic prescription, the user can exercise the electronic prescription via the mobile body and receive the drug.

In the case of the proxy, the proxy user (the proxy individual PI) can exercise the authority linked with the proxy requesting user (the proxy requesting individual PR) via the target mobile body (the target individual TA) and receive a service corresponding to a result of executing the authority. For example, a scene in which the authority information includes information concerning an electronic prescription and the target authority is reception of a drug prescribed by the electronic prescription is assumed. In this case, the proxy requesting user can request another user (a proxy user) such as a driver of a taxi to receive the prescribed drug via the mobile body by imparting an agency to the other user even if the proxy requesting user does not go for the prescribed drug by himself or herself.

Note that the processing procedure in exercising the authority explained above is only an example. The steps may be changed as much as possible. Concerning the processing procedure, it is possible to omit, substitute, and add steps as appropriate according to an embodiment. In the processing procedure explained above, the user may be replaced with the first target and the mobile body may be replaced with the second target. Further, in the processing procedure explained above, “first” and “second” may be changed.

### (Data Communication Among the Devices)

Data communication among the devices (the management server 1, the first server 2, the second server 3, the first terminal 4, the second terminal 5, and the terminal 6) may not be particularly limited and may be selected as appropriate according to an embodiment. A network among the devices may be selected as appropriate from, for example, the Internet, a wireless communication network, a mobile communication network, a telephone network, a dedicated network, and a local area network. The data communication among the devices may be encrypted by a method such as SSL (Secure Socket Layer) or TLS (Transport Layer Security). In an example, the terminals (4, 5, and 6) may include SIMs (Subscriber Identity Modules). Data communication between the terminals (4, 5, and 6) and the servers (the management server 1, the first server 2, and the second server 3) may be performed by encrypted communication using the SIMS.

### 2 Configuration Example

### [Hardware Configuration]

### (Management Server)

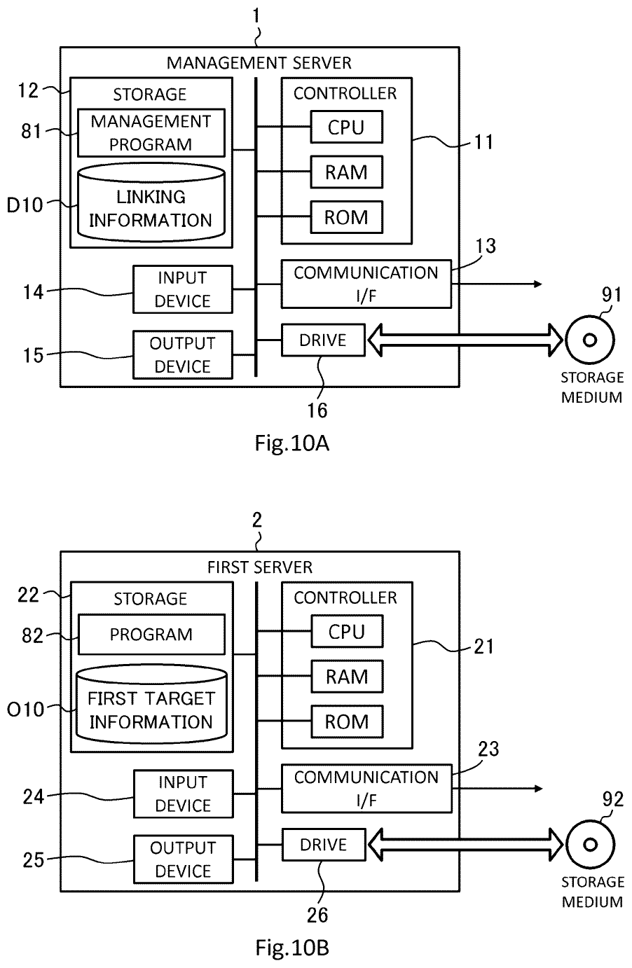

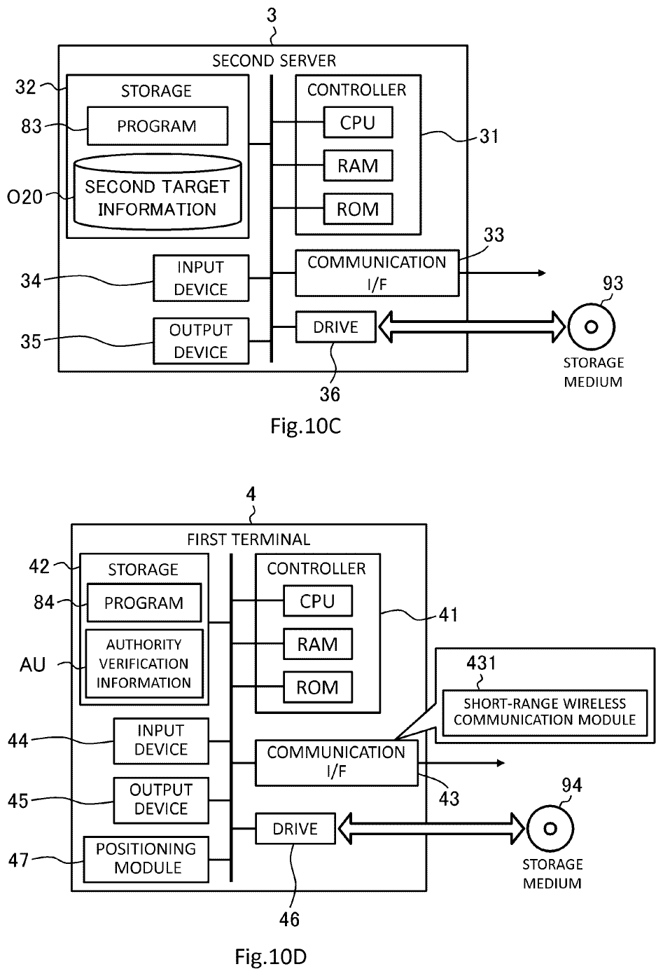

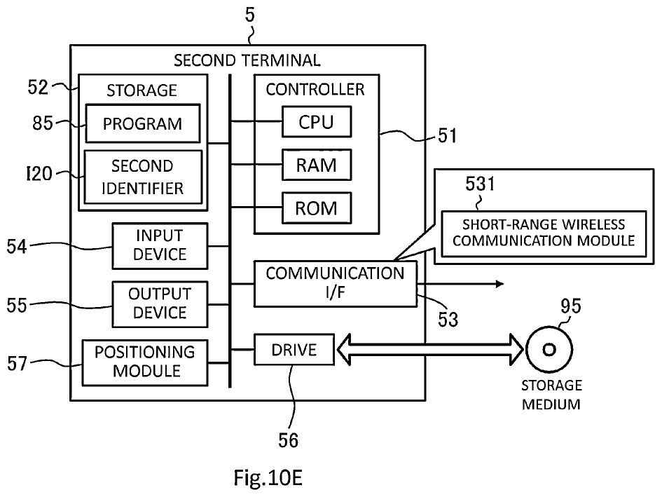

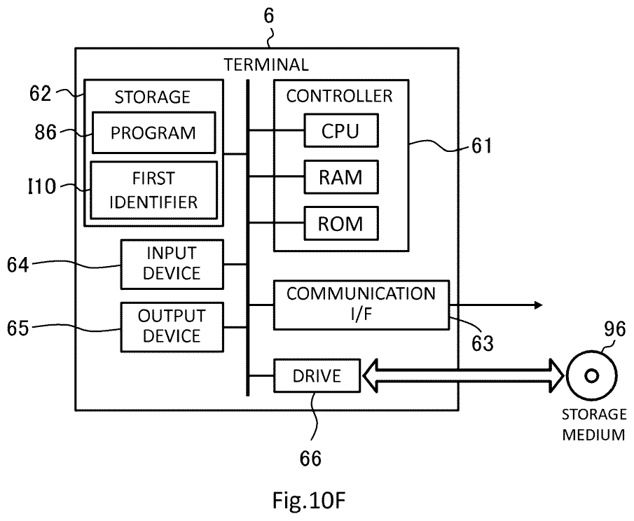

FIG. 10A schematically illustrates an example of a hardware configuration of the management server 1 according to the present embodiment. The management server 1 according to the present embodiment is a computer in which a controller 11, a storage 12, a communication interface 13, an input device 14, an output device 15, and a drive 16 are electrically connected.

The controller 11 includes a CPU (Central Processing Unit), which is a hardware processor, a RAM (Random Access Memory), and a ROM (Read Only Memory) and is configured to execute any information processing based on a program and various data. The controller 11 (the CPU) is an example of a processor resource of the management server 1.

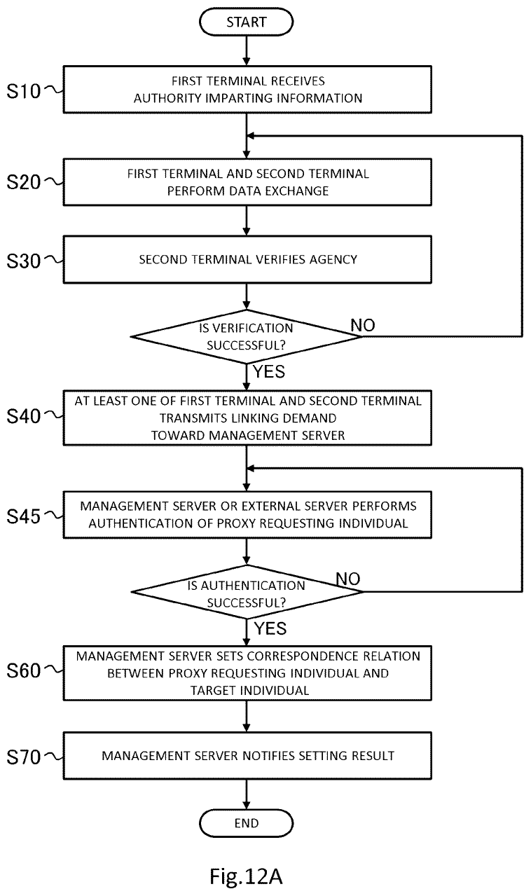

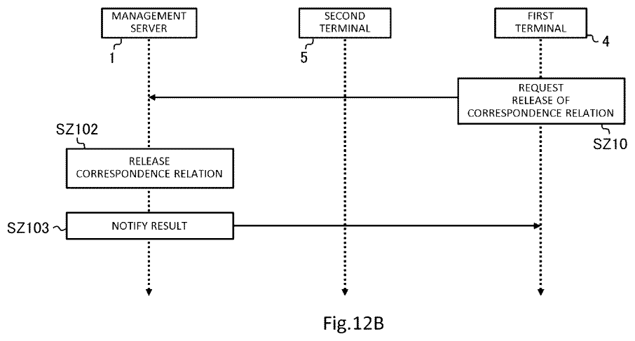

The storage 12 may be configured by, for example, a hard disk drive, a solid state drive, or a semiconductor memory. The storage 12 (and the RAM and the ROM) is an example of a memory resource. In the present embodiment, the storage 12 stores various kinds of information such as a management program 81 and the linking information D10. The management program 81 is a program for causing the management server 1 to execute information processing (FIGS. 12A and 12B referred to later) concerning setting and release of a correspondence relation between the first target and the second target. The management program 81 includes a series of instructions of the information processing.

The communication interface 13 is configured to perform wired or wireless communication via a network. The communication interface 13 may be configured by, for example, a wired LAN (Local Area Network) module or a wireless LAN module. The management server 1 may execute data communication with other computers (the first terminal 4, the second terminal 5, and the like) via the communication interface 13.

The input device 14 is a device for performing input such as a mouse, a keyboard, or an operation button. The output device 15 is a device for performing output such as a display or a speaker. An operator can operate the management server 1 by using the input device 14 and the output device 15. The input device 14 and the output device 15 may be integrally configured by, for example, a touch panel display. The input device 14 and the output device 15 may be connected via an external interface. The external interface may be configured as appropriate to be connected to an external device by wire or radio by, for example, a USB (Universal Serial Bus) port, a dedicated port, or a wireless communication port.

The drive 16 is a device for reading various kinds of information such as programs stored in a storage medium 91. At least one of the management program 81 and the linking information D10 explained above may be stored in the storage medium 91 instead of the storage 12 or in addition to the storage 12. The storage medium 91 is configured to accumulate, to enable a machine such as a computer to read the various kinds of information (the stored programs and the like), the information with electric, magnetic, optical, mechanical, or chemical action. The management server 1 may acquire at least one of the management program 81 and the linking information D10 explained above from the storage medium 91. Note that the storage medium 91 may be a disk-type storage medium such as a CD or a DVD or may be a storage medium other than the disk type such as a semiconductor memory (for example, a flash memory). A type of the drive 16 may be selected as appropriate according to the type of the storage medium 91. The drive 16 may be connected via the external interface.

Note that, concerning a specific hardware configuration of the management server 1, components can be omitted, substituted, and added according to an embodiment. For example, the controller 11 may include a plurality of hardware processors. The hardware processor may be configured by a microprocessor, an FPGA (field-programmable gate array), a DSP (digital signal processor), a GPU (Graphics Processing Unit), an ASIC (application specific integrated circuit), or the like. At least one of the input device 14, the output device 15, and the drive 16 may be omitted. The linking information D10 may be stored not in the storage 12 but in an external computer (for example, a NAS) accessible by the management server 1. The management server 1 may be configured by a plurality of computers. In this case, hardware configurations of the computers may coincide or may not coincide. The management server 1 may be a general-purpose server device, a general-purpose computer, or the like besides an information processing device designed exclusively for a service to be provided.

### (First Server)

FIG. 10B schematically illustrates an example of a hardware configuration of the first server 2 according to the present embodiment. The first server 2 according to the present embodiment is a computer in which a controller 21, a storage 22, a communication interface 23, an input device 24, an output device 25, and a drive 26 are electrically connected. The controller 21 to the drive 26 of the first server 2 and a storage medium 92 are respectively configured the same as the controller 11 to the drive 16 of the management server 1 and the storage medium 91.

The controller 21 (the CPU) is an example of a processor resource of the first server 2. The storage 22 (and the RAM and the ROM) is an example of a memory resource of the first server 2. In the present embodiment, the storage 22 stores various kinds of information such as a program 82 and the first target information O10. The program 82 is a program for causing the first server 2 to execute information processing concerning authentication for the first target. The program 82 includes a series of instructions of the information processing. At least one of the program 82 and the first target information O10 may be stored in the storage medium 92 instead of the storage 22 or in addition to the storage 22. The first server 2 may acquire at least one of the program 82 and the first target information O10 from the storage medium 92. The first server 2 may perform data communication between the first server 2 and other computers via the communication interface 23. The first server 2 may be operated via the input device 24 and the output device 25.

Note that, concerning a specific hardware configuration of the first server 2, components can be omitted, substituted, and added as appropriate according to an embodiment. For example, the controller 21 may include a plurality of hardware processors. The hardware processor may be configured by a microprocessor, an FPGA, a DSP, a GPU, an ASIC, or the like. At least any one of the input device 24, the output device 25, and the drive 26 may be omitted. The first target information O10 may be stored not in the storage 22 but in an external computer (for example, a NAS) accessible by the first server 2. The first server 2 may be configured by a plurality of computers. In this case, hardware configurations of the computers may coincide or may not coincide. The first server 2 may be a general-purpose server device, a general-purpose computer, or the like besides an information processing device designed exclusively for a service to be provided.

### (Second Server)

FIG. 10C schematically illustrates an example of a hardware configuration of the second server 3 according to the present embodiment. The second server 3 according to the present embodiment is a computer in which a controller 31, a storage 32, a communication interface 33, an input device 34, an output device 35, and a drive 36 are electrically connected. The controller 31 to the drive 36 of the second server 3 and a storage medium 93 may be respectively configured the same as the controller 11 to the drive 16 of the management server 1 and the storage medium 91.

The controller 31 (the CPU) is an example of a processor resource of the second server 3. The storage 32 (and the RAM and the ROM) is an example of a memory resource of the second server 3. In the present embodiment, the storage 32 stores various kinds of information such as a program 83 and the second target information O20. The program 83 is a program for causing the second server 3 to execute information processing concerning authentication for the second target. The program 83 includes a series of instructions of the information processing. At least one of the program 83 and the second target information O20 may be stored in the storage medium 93 instead of the storage 32 or in addition to the storage 32. The second server 3 may acquire at least one of the program 83 and the second target information O20 from the storage medium 93. The second server 3 may perform data communication with other computers via the communication interface 33. The second server 3 may be operated via the input device 34 and the output device 35.

Note that, concerning a specific hardware configuration of the second server 3, components can be omitted, substituted, and added as appropriate according to an embodiment. For example, the controller 31 may include a plurality of hardware processors. The hardware processor may be configured by a microprocessor, an FPGA, a DSP, a GPU, an ASIC, or the like. At least any one of the input device 34, the output device 35, and the drive 36 may be omitted. The second target information O20 may be stored not in the storage 32 but in an external computer (for example, a NAS) accessible by the second server 3. The second server 3 may be configured by a plurality of computers. In this case, hardware configurations of the computers may coincide or may not coincide. The second server 3 may be a general-purpose server device, a general-purpose computer, or the like besides an information processing device designed exclusively for a service to be provided.

### (First Terminal)

FIG. 10D schematically illustrates an example of a hardware configuration of the first terminal 4 according to the present embodiment. The first terminal 4 according to the present embodiment is a computer in which a controller 41, a storage 42, a communication interface 43, an input device 44, an output device 45, a drive 46, and the positioning module 47 are electrically connected. The controller 41 to the drive 46 of the first terminal 4 and a storage medium 94 may be respectively configured the same as the controller 11 to the drive 16 of the management server 1 and the storage medium 91.

The controller 41 (the CPU) is an example of a processor resource of the first terminal 4. The storage 42 (and the RAM and the ROM) is an example of a memory resource of the first terminal 4. In this embodiment, the storage 42 stores various kinds of information such as a program 84 and the authority verification information AU. The program 84 is a program for causing the first terminal 4 to execute information processing concerning linking (FIGS. 12A and 12B referred to later). The program 84 includes a series of instructions of the information processing. The program 84 may be stored in the storage medium 94 instead of the storage 42 or in addition to the storage 42. The first terminal 4 may acquire the program 84 from the storage medium 94. The first terminal 4 may be operated via the input device 44 and the output device 45.

The first terminal 4 may perform data communication between the first terminal 4 and other computers via the communication interface 43. In an example, the communication interface 43 may be configured by a plurality of types of modules. For example, the communication interface 43 may include the short-range wireless communication module 431 and another wireless communication module (for example, a cellular communication module). The first terminal 4 may perform data communication with the second terminal 5 via the short-range wireless communication module 431 and perform data communication with the servers (the management server 1, the first server 2, the second server 3, and the like) via the other wireless communication module.

Note that, concerning a specific hardware configuration of the first terminal 4, components can be omitted, substituted, and added as appropriate according to an embodiment. For example, the controller 41 may include a plurality of hardware processors. The hardware processor may be configured by a microprocessor, an FPGA, a DSP, a GPU, an ASIC, an ECU (Electronic Control Unit), or the like. At least any one of the input device 44, the output device 45, the drive 46, and the positioning module 47 may be omitted. The storage 42 may store the first identifier I10 of the proxy individual PI. Alternatively, the first identifier 110 of the proxy individual PI may not be stored in the storage 42 and may be acquired every time. In order to acquire data such as an identifier and information used for authentication, the first terminal 4 may further include a data acquisition device such as a sensor or a reading device. The first terminal 4 may be configured by a plurality of computers. In this case, hardware configurations of the computers may coincide or may not coincide. The first terminal 4 may be a general-purpose computer or a terminal device (for example, a smartphone or a tablet PC) besides an information processing device designed exclusively for a service to be provided.

### (Second Terminal)

FIG. 10E schematically illustrates an example of a hardware configuration of the second terminal 5 according to the present embodiment. The second terminal 5 according to the present embodiment is a computer in which a controller 51, a storage 52, a communication interface 53, an input device 54, an output device 55, a drive 56, and the positioning module 57 are electrically connected. The controller 51 to the drive 56 of the second terminal 5 and a storage medium 95 are respectively configured the same as the controller 11 to the drive 16 of the management server 1 and the storage medium 91.

The controller 51 (the CPU) is an example of a processor resource of the second terminal 5. The storage 52 (the RAM and the ROM) is an example of a memory resource of the second terminal 5. In the present embodiment, the storage 52 stores various kinds of information such as a program 85 and the second identifier 120 of the target individual TA. The program 85 is a program for causing the second terminal 5 to execute information processing concerning linking (FIGS. 12A and 12B referred to later). The program 85 includes a series of instructions of the information processing. At least one of the program 85 and the second identifier 120 may be stored in the storage medium 95 instead of the storage 52 or in addition to the storage 52. The second terminal 5 may acquire at least one of the program 85 and the second identifier I20 from the storage medium 95. The second terminal 5 may be operated via the input device 54 and the output device 55.

The second terminal 5 may perform data communication between the second terminal 5 and other computers via the communication interface 53. In an example, as in the first terminal 4, the communication interface 53 may be configured by a plurality of types of modules. For example, the communication interface 53 may include the short-range wireless communication module 531 and another wireless communication module. The second terminal 5 may perform data communication with the first terminal 4 via the short-range wireless communication module 531 and perform data communication with a server via the other wireless communication module.

Note that, concerning a specific hardware configuration of the second terminal 5, components can be omitted, substituted, and added as appropriate according to an embodiment. For example, the controller 51 may include a plurality of hardware processors. The hardware processor may be configured by a microprocessor, an FPGA, a DSP, a GPU, an ASIC, an ECU, or the like. At least any one of the input device 54, the output device 55, the drive 56, and the positioning module 57 may be omitted. The second identifier I20 may not be stored in the storage 52 and may be acquired every time. In order to acquire data such as an identifier and information used for authentication, the second terminal 5 may further include a data acquisition device such as a sensor or a reading device. The second terminal 5 may be configured by a plurality of computers. In this case, hardware configurations of the computers may coincide or may not coincide. The second terminal 5 may be a general-purpose computer, a terminal device, or the like besides an information processing device designed exclusively for a service to be provided.

### (Terminal)

FIG. 10F schematically illustrates an example of a hardware configuration of the terminal 6 according to the present embodiment. The terminal 6 according to the present embodiment is a computer in which a controller 61, a storage 62, a communication interface 63, an input device 64, an output device 65, and a drive 66 are electrically connected. The controller 61 to the drive 66 of the terminal 6 and a storage medium 96 may be respectively configured the same as the controller 11 to the drive 16 of the management server 1 and the storage medium 91.

The controller 61 (the CPU) is an example of a processor resource of the terminal 6. The storage 62 (and the RAM and the ROM) is an example of a memory resource of the terminal 6. In the present embodiment, the storage 62 stores various kinds of information such as a program 86 and the first identifier I10 of the proxy requesting individual PR. The program 86 is a program for causing the terminal 6 to execute information processing concerning setting and release of a correspondence relation by a proxy. The program 86 includes a series of instructions of the information processing. At least one of the program 86 and the first identifier I10 may be stored in the storage medium 96 instead of the storage 62 or in addition to the storage 62. The terminal 6 may acquire at least one of the program 86 and the first identifier I10 from the storage medium 96. The terminal 6 may perform data communication between the terminal 6 and another computer via the communication interface 63. The terminal 6 may be operated via the input device 64 and the output device 65.

Note that, concerning a specific hardware configuration of the terminal 6, components can be omitted, substituted, and added as appropriate according to an embodiment. For example, the controller 61 may include a plurality of hardware processors. The hardware processor may be configured by a microprocessor, an FPGA, a DSP, a GPU, an ASIC, an ECU (Electronic Control Unit), or the like. At least any one of the input device 64, the output device 65, and the drive 66 may be omitted. The first identifier I10 may not be stored in the storage 62 and may be acquired every time. Like the first terminal 4 and the second terminal 5, in order to acquire data such as an identifier or a certificate, the terminal 6 may further include a data acquisition device such as a sensor or a reading device. The communication interface 63 may include a short-range wireless communication module and another wireless communication module. The terminal 6 may include a positioning module to be configured to be capable of measuring a current position of the terminal 6. The terminal 6 may be configured by a plurality of computers. In this case, hardware configurations of the computers may coincide or may not coincide. The terminal 6 may be a general-purpose computer, a terminal device, or the like besides an information processing device designed exclusively for a service to be provided.

### Software Configuration Example

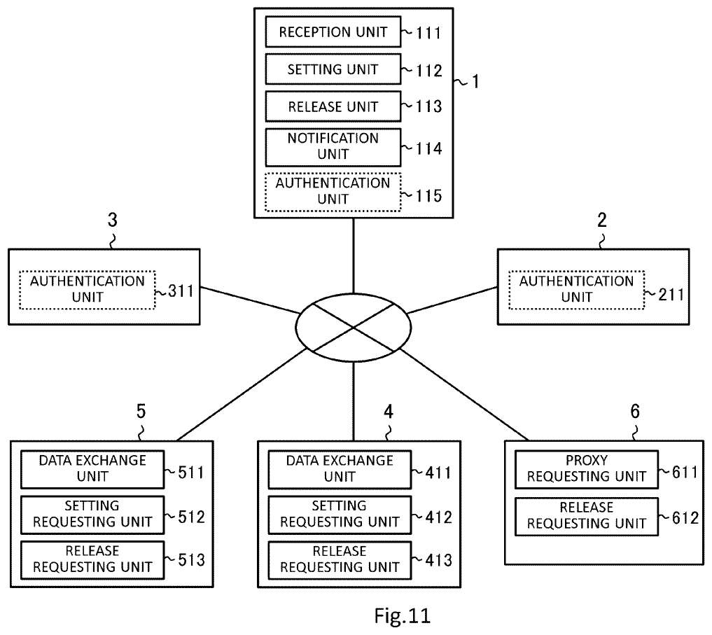

FIG. 11 schematically illustrates an example of software configurations of the devices (the management server 1, the first server 2, the second server 3, the first terminal 4, the second terminal 5, and the terminal 6) according to the present embodiment.

### (Management Server)

The controller 11 of the management server 1 loads, in the RAM, the management program 81 stored in the storage 12 and executes, with the CPU, an instruction included in the management program 81. Accordingly, the management server 1 operates as a computer including a reception unit 111, a setting unit 112, a release unit 113, and a notification unit 114 as software modules.

The reception unit 111 is configured to directly or indirectly receive a linking demand from a terminal of at least one of the first target and the second target according to occurrence of a use relation between relevant individuals of the first target and the second target. The reception unit 111 is configured to receive the linking demand to receive a setting request for a correspondence relation between the relevant individuals of the first target and the second target. In the case of the proxy, the reception unit 111 is configured to receive a linking demand from at least one of the first terminal 4 and the second terminal 5 according to occurrence of a use relation between the proxy individual PI of the first target and the target individual TA of the second target. The reception unit 111 is configured to receive the linking demand to receive a setting request for a correspondence relation between the proxy requesting individual PR of the first target and the target individual TA of the second target.

The setting unit 112 is configured to execute, based on the linking demand, setting processing for a correspondence relation between the relevant individuals of the first target and the second target. In the case of the proxy, the setting unit 112 is configured to set a correspondence relation between the proxy requesting individual PR and the target individual TA according to success of authentication for the proxy requesting individual PR. The release unit 113 is configured to execute release processing for the correspondence relation according to reception of a release demand from at least one of the first terminal 4 and the second terminal 5 or satisfaction of a predetermined release condition. The release unit 113 is configured to execute the release processing for the correspondence relation because of a factor concerning the proxy requesting individual PR.

The notification unit 114 is configured to transmit, to at least one of the first terminal 4 and the second terminal 5, notification indicating a result of executing the setting processing for the correspondence relation. The notification unit 114 is configured to transmit, to at least one of the first terminal 4 and the second terminal 5, notification indicating a result of executing the release processing for the correspondence relation. The notification unit 114 is configured to transmit, to the terminal 6, notification indicating that the correspondence relation has been set. The notification unit 114 is configured to transmit, to the terminal 6, notification indicating that the correspondence relation has been released.

When a form of executing authentication processing for at least one of the first target and the second target in the management server 1 is adopted, the management server 1 may be configured to further include an authentication unit 115 as a software module. The authentication unit 115 may be configured to execute the authentication processing for at least one of the first target and the second target.

### (First Server)

When a form of executing the authentication processing for the first target in the first server 2 is adopted, the controller 21 of the first server 2 may execute, with the CPU, an instruction included in the program 82. Accordingly, the first server 2 may operate as a computer including an authentication unit 211 as a software module. The authentication unit 211 is configured to execute the authentication processing for the first target according to authentication request for the first target.

### (Second Server)

When a form of executing the authentication processing for the second target in the second server 3 is adopted, the controller 31 of the second server 3 may execute, with the CPU, an instruction included in the program 83. Accordingly, the second server 3 may operate as a computer including an authentication unit 311 as a software module. The authentication unit 311 is configured to execute the authentication processing for the second target according to an authentication request for the second target.

### (First Terminal)

The controller 41 of the first terminal 4 executes, with the CPU, an instruction included in the program 84. Accordingly, the first terminal 4 operates as a computer including a data exchange unit 411, a setting requesting unit 412, and a release requesting unit 413 as software modules. The data exchange unit 411 is configured to execute data exchange with the second terminal 5. The setting requesting unit 412 is configured to transmit a linking demand (a request for linking setting) toward the management server 1. The release requesting unit 413 is configured to transmit a release demand (a request for linking release) toward the management server 1.

### (Second Terminal)

The controller 51 of the second terminal 5 executes, with the CPU, an instruction included in the program 85. Accordingly, the second terminal 5 operates as a computer including a data exchange unit 511, a setting requesting unit 512, and a release requesting unit 513 as software modules. The data exchange unit 511 is configured to execute data exchange with the first terminal 4. The setting requesting unit 512 is configured to transmit a linking demand toward the management server 1. The release requesting unit 513 is configured to transmit a release demand toward the management server 1.

### (Terminal)

The controller 61 of the terminal 6 executes, with the CPU, an instruction included in the program 86. Accordingly, the terminal 6 operates as a computer including a proxy requesting unit 611 and a release requesting unit 612 as software modules. The proxy requesting unit 611 is configured to receive setting concerning imparting of an agency including designation of the proxy individual PI and directly or indirectly transmit the authority imparting information AG to the first terminal 4 of the designated proxy individual PI. The release requesting unit 612 is configured to transmit a release demand toward the management server 1.

### (Others)

In the present embodiment, an example is explained in which all of the software modules of the devices are implemented by the general-purpose CPUs. However, some or all of the software modules may be implemented by one or a plurality of dedicated processors. The modules explained above may be implemented as hardware modules. Concerning the software configurations of the devices, modules may be omitted, substituted, and added as appropriate according to an embodiment. For example, when a form of transmitting a linking demand from only one terminal of the first terminal 4 and the second terminal 5 is adopted, the setting requesting unit may be omitted from the other terminal. Similarly, when a form of transmitting the release demand from only one terminal of the first terminal 4 and the second terminal 5 is adopted, the release requesting unit may be omitted from the other terminal. The authentication unit may be omitted from the device in which the execution of the authentication processing is omitted.

### 3 Operation Example

### (Linking Setting)

FIG. 12A illustrates an example of a processing procedure of linking setting by the system 100 according to the present embodiment. The processing procedure explained below is an example of an information processing method executed by a computer. A processing procedure of the management server 1 in the processing procedure explained below is an example of a management method executed by the computer.

In step S10, the controller 61 of the terminal 6 operates as the proxy requesting unit 611 and receives setting concerning imparting of an agency including designation of the proxy individual PI. The controller 61 directly or indirectly notifies the authority imparting information AG to the first terminal 4 of the designated proxy individual PI. In response to the notification, the controller 41 of the first terminal 4 receives the authority imparting information AG.

In step S20, according to occurrence of a use relation between the proxy individual PI and the target individual TA, the controller 41 of the first terminal 4 operates as the data exchange unit 411 and executes data exchange with the second terminal 5. The controller 51 of the second terminal 5 operates as the data exchange unit 511 and executes data exchange with the first terminal 4. This data exchange may be performed by short-range wireless communication. In the data exchange, the controller 41 of the first terminal 4 gives the authority verification information AU to the second terminal 5 to request verification of an agency.

In step S30, the controller 51 of the second terminal 5 verifies the agency using the authority verification information AU in response to the request from the first terminal 4. As an agency verification method, at least one of the two methods explained above may be used. When the first method is adopted, the processing in step S301 and step S302 explained above is an example of the processing in step S30. When the second method is adopted, the processing in step S305 explained above is an example of the processing in step S30. In step S35, a branch destination of the processing is determined according to success of the verification of the agency. When the verification is successful, the controller 51 of the second terminal 5 advances the processing to the next step S40. On the other hand, when the verification is unsuccessful, the controller 51 of the second terminal 5 returns the processing to step S20 and urges the first terminal 4 to retransmit the authority verification information AU. Note that, when the verification is unsuccessful, the first terminal 4 and the second terminal 5 may end, as appropriate, the processing procedure concerning the linking setting according to the present operation example.

In step S40, at least one of the first terminal 4 and the second terminal 5 transmits a linking demand including an authentication request for the proxy requesting individual PR toward the management server 1. The controller 41 of the first terminal 4 may operate as the setting requesting unit 412 and transmit the linking demand to the management server 1. The controller 51 of the second terminal 5 may operate as the setting requesting unit 512 and transmit the linking demand toward the management server 1. The first terminal 4 and the second terminal 5 may transmit the linking demand in cooperation or one of the first terminal 4 and the second terminal 5 may transmit the linking demand. One terminal of the first terminal 4 and the second terminal 5 may give an instruction to the other terminal and the other terminal may transmit the linking demand. The linking demand may be directly transmitted to the management server 1 or may be indirectly transmitted via the external server. The controller 11 of the management server 1 operates as the reception unit 111 and receives the linking demand.

Note that, in step S40, when a form in which the first terminal 4 and the second terminal 5 transmit the linking demand in cooperation is adopted, one linking demand may be dividedly transmitted from the first terminal 4 and the second terminal 5 or the same linking demand may be transmitted from the first terminal 4 and the second terminal 5. When the one linking demand is dividedly transmitted, a part of data of the linking demand may be transmitted from the first terminal 4 and the remaining data may be transmitted from the second terminal 5. Partial overlapping may be allowed between a part of the data and the remaining data. In step S20, in order to specify the combination of the relevant individuals of the first target and the second target actually demanding the setting of the correspondence relation, the management server 1 may specify association of this data as appropriate (that is, discriminate a combination of corresponding data).

The association of the data may be specified by any method. In an example, data transmitted from the terminals (4 and 5) may include shared information for specifying association of the data. The shared information may be configured by information having a relationship of, for example, coinciding or a correspondence relation being established. The management server 1 may specify the association of the data according to a relationship being established between shared information included in data received from one of the first terminal 4 and the second terminal 5 and shared information included in data received from the other.

The shared information may be optionally configured. In an example, the shared information may be configured by a combination of the first identifier I10 of the proxy requesting individual PR and the second identifier I20 of the target individual TA. The management server 1 may specify the association of the data according to coincidence of a combination of the identifiers (I10 and I20) included in data received from the first terminal 4 and a combination of the identifiers (I10 and I20) included in data received from the second terminal 5. The shared information may include the first identifier I10 of the proxy individual PI. In another example, the shared information may be configured by temporary information such as a random number, a timestamp, or a hash value. In this case, the management server 1 may specify the association of the data according to a relationship being established between temporary information included in the data received from the first terminal 4 and temporary information included in the data received from the second terminal 5. Note that the shared information may be shared at any timing between the first terminal 4 and the second terminal 5. In a typical example, the first terminal 4 and the second terminal 5 may share the shared information at the time of data exchange.

In step S45, the management server 1 and the external server perform authentication for the proxy requesting individual PR in response to an authentication request. The first server 2 is an example of the external server. In the present embodiment, authentication processing for the proxy requesting individual PR may be executed by the management server 1 or the first server 2. In an example, the controller 11 of the management server 1 may operate as the authentication unit 115 and perform the authentication for the proxy requesting individual PR. In another example, the controller 21 of the first server 2 may operate as the authentication unit 211 and perform the authentication for the proxy requesting individual PR. The management server 1 or the first server 2 may acquire data used for the authentication for the proxy requesting individual PR from at least one of the first terminal 4 and the second terminal 5 or may acquire the data from the terminal 6 of the proxy requesting individual PR.

Note that processing order of step S40 and step S45 may be determined as appropriate according to an embodiment. In an example, at least one of the first terminal 4 and the second terminal 5 may transmit an authentication request to the management server 1 or the first server 2. The management server 1 or the first server 2 may perform the authentication for the proxy requesting individual PR in response to the authentication request. The management server 1 or the first server 2 may return an authentication result for the proxy requesting individual PR to at least one of the first terminal 4 and the second terminal 5. At least one of the first terminal 4 and the second terminal 5 may transmit a linking demand toward the management server 1 according to the authentication for the proxy requesting individual PR being successful in the authentication result. In another example, at least one of the first terminal 4 and the second terminal 5 may transmit the linking demand including the authentication request to the first server 2. The first server 2 may perform the authentication for the proxy requesting individual PR in response to the authentication request. When the authentication for the proxy requesting individual PR is successful, the first server 2 may transmit the linking demand including the authentication result for the proxy requesting individual PR to the management server 1. In still another example, at least one of the first terminal 4 and the second terminal 5 may transmit the linking demand including the authentication request to the management server 1. The management server 1 may perform the authentication for the proxy requesting individual PR in response to the authentication request. Alternatively, the management server 1 may transfer the authentication request to the first server 2 to request the first server 2 to perform the authentication for the proxy requesting individual PR. The first server 2 may perform the authentication for the proxy requesting individual PR in response to the request and return the authentication result to the management server 1. Accordingly, the management server 1 may acquire the authentication result for the proxy requesting individual PR.

A target for which the authentication processing is performed may not be limited to the proxy requesting individual PR. In an example, authentication for at least one of the proxy individual PI and the target individual TA may be performed together with the authentication for the proxy requesting individual PR. The controller 11 of the management server 1 may operate as the authentication unit 115 and perform the authentication for at least one of the proxy individual PI and the target individual TA. The controller 21 of the first server 2 may operate as the authentication unit 211 and perform the authentication for the proxy individual PI. The controller 31 of the second server 3 may operate as the authentication unit 311 and perform the authentication for the target individual TA.

In step S50, a branch destination of the processing is determined according to success of the authentication. When the authentication for the proxy requesting individual PR is successful, the controller 11 of the management server 1 advances the processing to the next step S60. On the other hand, when the authentication for the proxy requesting individual PR is unsuccessful, the controller 11 of the management server 1 may return the processing to step S45 and demand at least any one of the first terminal 4, the second terminal 5, and the terminal 6 to retransmit the data used for the authentication for the proxy requesting individual PR. Note that, when the authentication is unsuccessful, the management server 1 may end, as appropriate, the processing procedure concerning the linking setting according to the present operation example.

In step S60, the controller 11 of the management server 1 operates as the setting unit 112 and updates the linking information D10 to establish setting of a correspondence relation between the first target (the proxy requesting individual PR) and the second target (the target individual TA) designated by the linking demand.

In an example, updating the linking information D10 according to the setting of the correspondence relation may be configured by generating new linking information D10 indicating a designated correspondence relation. In the present embodiment, the management server 1 sets the correspondence relation between the proxy requesting individual PR and the target individual TA to enable proxy exercise of the authority of the proxy requesting individual PR by the proxy individual PI via the target individual TA.

In step S70, the controller 11 operates as the notification unit 114 and directly or indirectly transmits notification indicating a result of executing the setting processing for the correspondence relation to at least one of the first terminal 4 and the second terminal 5. The controller 11 may directly or indirectly transmit, to the terminal 6, notification indicating that the correspondence relation has been set. When the notification of the result is completed, the processing procedure concerning the linking setting according to the present operation example ends.

Note that the processing procedure explained above is only an example and the steps may be changed as much as possible. Concerning the processing procedure explained above, steps can be omitted, substituted, and added as appropriate according to an embodiment.

### (Linking Release)

FIG. 12B illustrates an example of a processing procedure of linking release by the system 100 according to the present embodiment. The processing procedure explained below is an example of an information processing method executed by a computer. A processing procedure of the management server 1 in the processing procedure explained below is an example of a management method executed by the computer. Note that, in the example illustrated in FIG. 12B, a scene in which the first terminal 4 directly transmits a release demand to the management server 1 is assumed.

In step SZ10, the controller 41 of the first terminal 4 operates as the release requesting unit 413 and transmits a release demand for a correspondence relation to the management server 1. In response to the transmission, the controller 11 of the management server 1 receives the release demand. A correspondence relation for which release is requested may be designated as appropriate. A trigger of the release demand may be selected as appropriate according to an embodiment.

In step SZ102, the controller 11 operates as the release unit 113 and updates the linking information D10 to release setting of the correspondence relation designated by the received release request. In an example, the updating the linking information D10 according to the release of the correspondence relation may be configured by recording information indicating that the correspondence relation has been released. For example, when the linking information D10 has the configuration illustrated in FIG. 3A, the controller 11 may add release time to or set a flag of the release in the corresponding linking information D10 to release the target correspondence relation. When the linking information D10 is configured by a blockchain base, the controller 11 may generate a transaction indicating the linking release and add the generated transaction to a blockchain to release the target correspondence relation.

In step SZ103, the controller 11 operates as the notification unit 114 and transmits an execution result of the linking release processing to the first terminal 4. When the notification of the result is completed, the processing procedure concerning the linking release according to the present operation example ends.

Note that the processing procedure explained above is only an example. The steps may be changed as much as possible. Concerning the processing procedure explained above, steps can be omitted, substituted, and added as appropriate according to an embodiment. For example, as explained above, a transmission route of the release demand may not be limited to the example illustrated in FIG. 12B and may be selected as appropriate according to an embodiment. The release demand may be transmitted from the second terminal 5 (the release requesting unit 513) or the terminal 6 (the release requesting unit 612). The management server 1 (the notification unit 114) may transmit, to the terminal 6, the notification indicating that the correspondence relation has been released. The processing of the release demand may include the authentication processing for at least one of the first target and the second target. Instead of step SZ102 explained above, the controller 11 of the management server 1 may operate as the release unit 113 and release the correspondence relation according to satisfaction of a predetermined release condition. The controller 11 may operate as the release unit 113 and release the correspondence relation with the target individual TA according to setting of a correspondence relation with the other individual TO Of the second target by the proxy requesting individual PR. Further, the controller 11 may operate as the release unit 113 and, after setting the correspondence relation, execute the use continuation check processing explained above on the set correspondence relation at any timing.

### [Characteristics]

In the present embodiment, according to the processing in step S60, the information indicating the setting of the correspondence relation between the proxy requesting individual PR of the first target and the target individual TA of the second target is recorded. According to the recording, a use relation between the proxy individual PI and the target individual TA responding to a request of the proxy requesting individual PR can be tracked. In addition, security can be ensured by the verification processing in step S30 and the authentication processing in step S45. Further, the proxy exercise of the authority of the proxy requesting individual PR by the proxy individual PI via the target individual TA is enabled according to the setting of the correspondence relation between the proxy requesting individual PR and the target individual TA. Accordingly, the proxy individual PI can exercise at least a part of the authority of the proxy requesting individual PR by proxy. Therefore, according to the present embodiment, it is possible to track a use relation between the first target and the second target while ensuring security and, while the use relation is established, impart, to the proxy individual PI, a proxy authority for exercising at least a part of the authority of the proxy requesting individual PR by proxy.

### 4 Modifications

The embodiment of the present disclosure is explained in detail above. However, the above explanation is only exemplification of the present disclosure in all aspects. It goes without saying that various improvements or modifications can be made without departing from the scope of the present disclosure. For example, changes explained below are possible. Note that, in the following explanation, the same reference numerals and signs are used concerning the same components as the components in the embodiment and explanation is omitted as appropriate concerning similarities to the embodiment. Modifications explained below can be combined as appropriate.

In the embodiment explained above, the authentication processing may be executed in at least one of the management server 1 and the external server (the first server 2, the second server 3, or the like). The data communication at the time when the authentication processing is executed may be designed as appropriate according to an embodiment. As an example, at least any one of three authentication methods explained below may be adopted.

### (A) First Authentication Method

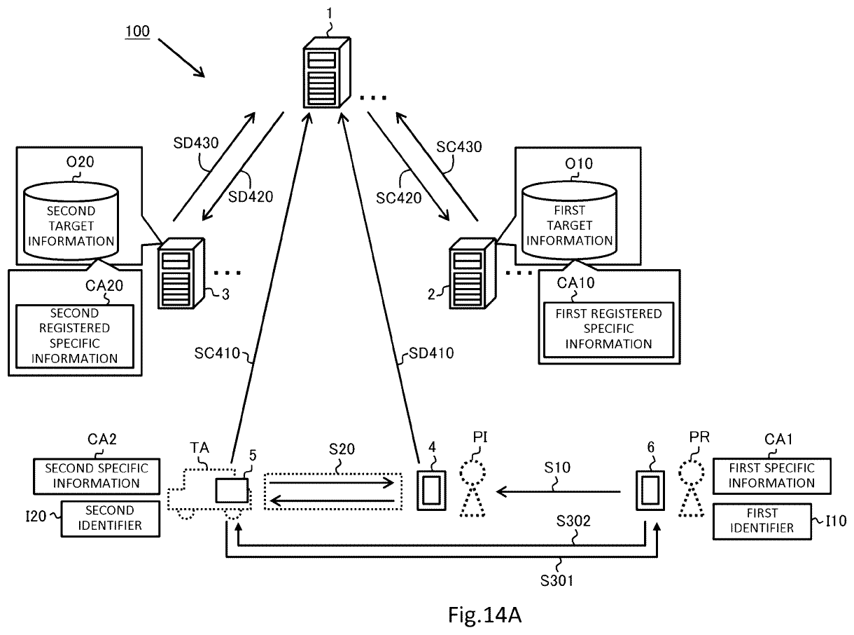

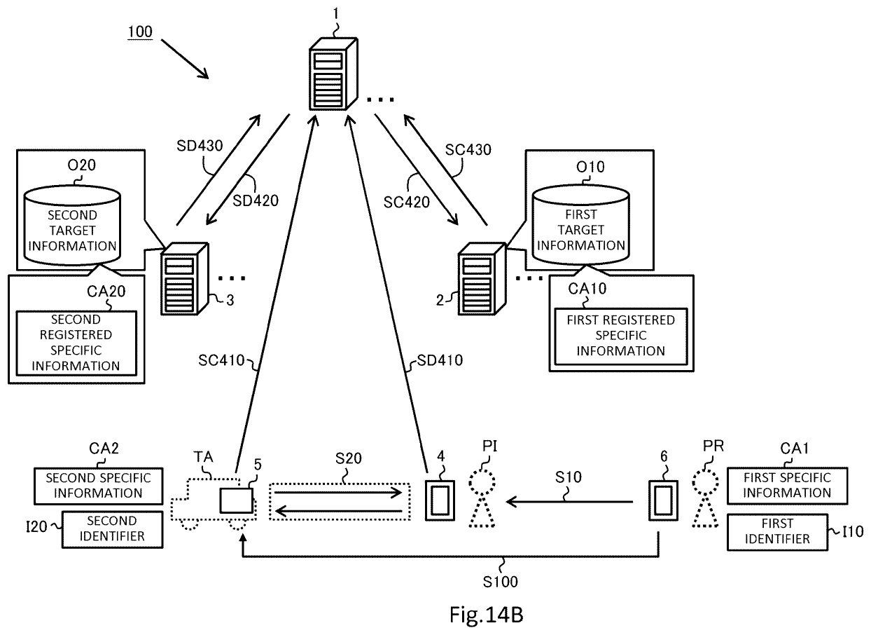

FIG. 14A schematically illustrates an example of a processing process for linking setting in the case in which a first authentication method is adopted. In the example illustrated in FIG. 14A, a scene in which the first method explained above is adopted as an agency verification method and a form of performing authentication for the proxy requesting individual PR and the target individual TA in linking setting is adopted is assumed. In the first authentication method, the second terminal 5 executes authentication processing for the second target in response to a demand (an authentication request) of the terminal of the first target. The first server 2 executes authentication processing for the first target in response to a demand (an authentication request) of the terminal of the second target. As a linking demand, the first terminal 4 and the second terminal 5 request the first server 2 and the second server 3 to authenticate the proxy requesting individual PR and the target individual TA and causes the first server 2 and the second server 3 to report a result of the authentication to the management server 1. Accordingly, the first terminal 4 and the second terminal 5 transmit linking demands toward the management server 1. Demands transmitted from the terminals (4 and 5) to the servers (2 and 3) are examples of a linking demand including an authentication request. The processing until the terminals (4 and 5) transmit the authentication requests to the servers (2 and 3) and cause the servers (2 and 3) to transmit the authentication results to the management server 1 is an example of processing in which the first terminal 4 and the second terminal 5 transmit the linking demand in cooperation.

The first server 2 is configured to be accessible to a first main memory that stores first registered specific information CA10 for authentication for the first target. The first main memory may be configured by at least one of the memory resource of the first server 2 and an external storage device (a NAS or the like). The first registered specific information CA10 may be included in the first target information O10. The second server 3 may be configured to be accessible to a second main memory that stores second registered specific information CA20 for authentication for the second target. The second main memory may be configured by at least one of the memory resource of the second server 3 and an external storage device (a NAS or the like). The second registered specific information CA20 may be included in the second target information O20.

Each piece of the registered specific information (CA10 and CA20) is specific information registered beforehand for authentication for the targets. If the specific information can be used for authentication, a data format and a configuration of the specific information may not be particularly limited and may be selected as appropriate according to an embodiment. The specific information may be configured by any information such as target deriving information, terminal deriving information, temporarily generated information, or information generated by any other method.

The target deriving information may be, for example, biological information or uniquely imparted identification information. The biological information may be, for example, a face image, a fingerprint, or a voiceprint. The uniquely imparted identification information may be, for example, a car registration number, a vehicle identification number, or a personal ID number. When an IC tag is attached to a target, the uniquely imparted identification information may include information retained by the IC tag. The terminal deriving information may be, for example, a MAC address or terminal identification information. The temporarily generated information may be, for example, a one-time password or a private address (a dynamically generated address). The temporarily generated information may be configured by a timestamp, a random number, or a hash value. The information generated by any other method may include, for example, a password, a passcode, as well as information other than a symbol string.

First, in step S10, the controller 61 of the terminal 6 performs setting concerning imparting of an agency and notifies the authority imparting information AG to the first terminal 4 of the designated proxy individual PI. In an example, the controller 61 of the terminal 6 may notify, to the first terminal 4, the authority imparting information AG including the first identifier I10 and the contact AU1 of the proxy requesting individual PR. In response to the notification, the first terminal 4 receives the authority imparting information AG.

In step S20, the first terminal 4 and the second terminal 5 perform data exchange. In the data exchange, the controller 41 of the first terminal 4 may give the first identifier I10 and the contact AU1 of the proxy requesting individual PR to the second terminal 5. The controller 51 of the second terminal 5 may acquire the first identifier I10 and the contact AU1 of the proxy requesting individual PR from the proxy individual PI or the first terminal 4. In the data exchange, the controller 41 of the first terminal 4 may acquire the second identifier I20 and the second specific information CA2 of the target individual TA from one of the target individual TA and the second terminal 5. A method of acquiring the second identifier I20 and the second specific information CA2 may be selected as appropriate according to an embodiment. In an example, the controller 41 of the first terminal 4 may acquire at least one of the second identifier I20 and the second specific information CA2 of the target individual TA using an input device, a sensor, or the like. In another example, the second identifier I20 and the second specific information CA2 may be retained by the second terminal 5 in advance. The controller 41 of the first terminal 4 may acquire the second identifier I20 and the second specific information CA2 through data exchange with the second terminal 5.

In step S301, the controller 51 of the second terminal 5 transmits an inquiry to the contact AU1. In step S302, the controller 51 of the second terminal 5 receives an answer of approval as an execution result of approval processing. In an example, the contact AU1 may be a contact of the terminal 6. The controller 51 of the second terminal 5 may transmit the inquiry to the terminal 6. In response to reception of the inquiry, the controller 61 of the terminal 6 may execute the approval processing and transmit the answer of approval to the second terminal 5. The controller 61 of the terminal 6 may transmit the first specific information CA1 of the proxy requesting individual PR to the second terminal 5 together with the answer of approval. In response to the transmission, the controller 51 of the second terminal 5 may receive the answer of approval and the first specific information CA1 of the proxy requesting individual PR from the terminal 6. In another example, the controller 51 of the second terminal 5 may transmit the inquiry to an external computer and may receive the first specific information CA1 of the proxy requesting individual PR from the external computer together with the answer of approval. A method of acquiring the first specific information CA1 may be selected as appropriate according to an embodiment. In an example, the controller 61 of the terminal 6 may acquire the first specific information CA1 from the proxy requesting individual PR using an input device, a sensor, or the like. The terminal 6 may retain the first specific information CA1 in advance. The controller 51 of the second terminal 5 may directly or indirectly receive the first specific information CA1 from the terminal 6. The identifiers (I10 and I20) and the specific information (CA1 and CA2) are examples of data used for authentication. When the answer indicating approval is obtained, the verification of the agency is successful.

In step SA410, the controller 51 of the second terminal 5 transmits an authentication request including the first identifier I10 and the first specific information CA1 of the proxy requesting individual PR to the first server 2. In response to the transmission, the controller 21 of the first server 2 receives the authentication request for the proxy requesting individual PR. The controller 21 of the first server 2 operates as the authentication unit 211 and executes authentication processing for the proxy requesting individual PR. In an example, the controller 21 may search through the first target information O10 using, as a query, the first identifier I10 included in the authentication request to extract the first registered specific information CA10 of the proxy requesting individual PR from the first target information O10. The controller 21 may collate the extracted first registered specific information CA10 and the first specific information CA1 included in the authentication request. The collation may be performed as appropriate according to specific information in use. The controller 21 may determine success of the authentication for the proxy requesting individual PR according to a result of the collation. In step SA420, the controller 21 reports an authentication result for the proxy requesting individual PR to the management server 1. In an example, the controller 21 may transmit the authentication result for the proxy requesting individual PR to the management server 1 with the first identifier I10 of the proxy requesting individual PR attached to the authentication result. The controller 21 may transmit the authentication result to the management server 1 irrespective of success or failure of the authentication or may transmit the authentication result to the management server 1 only when the authentication is successful.

On the other hand, in step SB410, the controller 41 of the first terminal 4 transmits an authentication request including the second identifier I20 and the second specific information CA2 of the target individual TA to the second server 3. In response to the transmission, the controller 31 of the second server 3 receives the authentication request for the target individual TA. The controller 31 of the second server 3 operates as the authentication unit 311 and executes authentication processing for the target individual TA. In an example, the controller 31 may search through the second target information O20 using, as a query, the second identifier I20 included in the authentication request to extract the second registered specific information CA20 of the target individual TA from the second target information O20. The controller 31 may collate the extracted second registered specific information CA20 and the second specific information CA2 included in the authentication request. The collation may be performed as appropriate according to specific information in use. The controller 31 may determine success of the authentication for the target individual TA according to a result of the collation. In step SB420, the controller 31 reports an authentication result for the target individual TA to the management server 1. In an example, the controller 31 may transmit the authentication result for the target individual TA to the management server 1 with the second identifier I20 of the target individual TA attached to the authentication result. The controller 31 may transmit the authentication result to the management server 1 irrespective of success or failure of the authentication or may transmit the authentication result to the management server 1 only when the authentication is successful.

The second terminal 5 giving the authentication request to the first server 2 and causing the first server 2 to transmit the authentication result to the management server 1 is an example of the second terminal 5 transmitting the linking demand toward the management server 1. The first terminal 4 giving the authentication request to the second server 3 and causing the second server 3 to transmit the authentication result to the management server 1 is an example of the first terminal 4 transmitting the linking demand toward the management server 1. That is, when the first authentication method is adopted in the linking setting, the processing in step SA410, step SA420, step SB410, and step SB420 is an example of the processing in step S40 and step S45. The form of the authentication request is an example of a form of executing the authentication processing together with the linking demand.

The controller 11 of the management server 1 receives the authentication results for the individuals (PR and TA) from the servers (2 and 3). In order to specify a combination of relevant individuals of the first target and the second target actually demanding setting of a correspondence relation, the controller 11 may specify association of data of the authentication results with a method of, for example, using the shared information. When both of the authentications for the proxy requesting individual PR and that for the target individual TA are successful in the received authentication results, the controller 11 sets a correspondence relation between the proxy requesting individual PR and the target individual TA. Setting processing for the correspondence relation may be the same as the setting processing in the embodiment explained above. Note that a series of processing from the data exchange between the terminals (4 and 5) to the linking setting may be executed in real time according to occurrence of a use relation.

In the first authentication method, authentication for the first target and the second target is respectively performed by the first server 2 and the second server 3 according to a use relation occurring between the first target and the second target. At this time, the authentication for the first target is requested from the second terminal 5 of the second target. The authentication for the second target is requested from the first terminal 4 of the first target. That is, the first target and the second target do not perform authentication for themselves but a crossed authentication for each of the first target and the second target performing authentication for the other is performed. Accordingly, it can be expected that security is ensured.

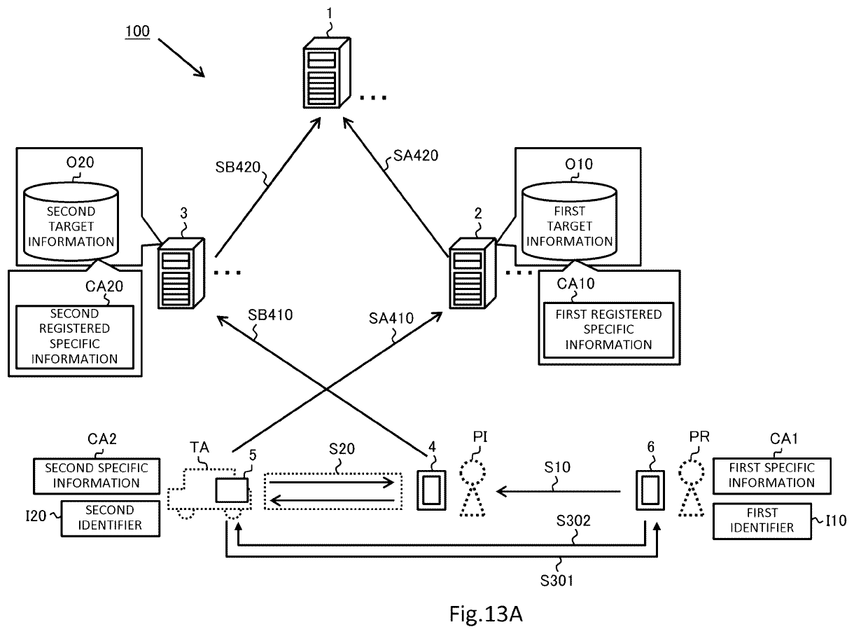

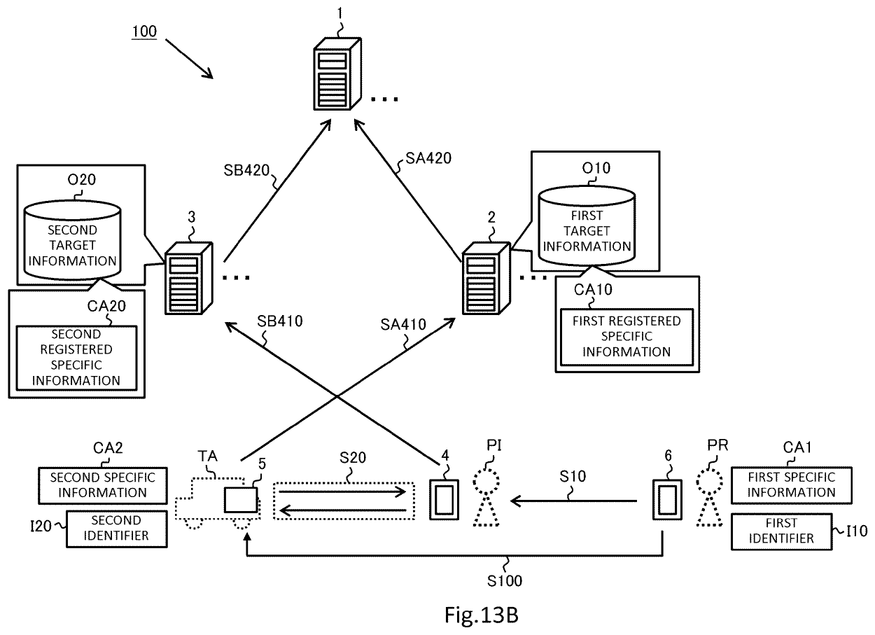

FIG. 13B schematically illustrates an example of a processing process of linking setting in the case in which the first authentication method is adopted as the authentication method and the second method explained above is adopted as an agency verification method. When the first authentication method is adopted, the system 100 may adopt the second method as the agency verification method instead of the first method explained above. When the second method is adopted, in step S20, the controller 41 of the first terminal 4 may give the proxy authentication information AU2 to the second terminal 5. The proxy authentication information AU2 may be acquired as appropriate. In an example, in step S10, the first terminal 4 may receive, from the terminal 6, the authority imparting information AG including the authentication information PC1 as the proxy authentication information AU2. In another example, the first terminal 4 may acquire the proxy authentication information AU2 from the proxy individual PI at any timing.

At any timing before the processing in step S305 is executed, the controller 51 of the second terminal 5 may acquire the authentication information PC1 according to the processing in step S100. In an example, the target individual TA may be designated in the setting in step S10. The terminal 6 may transmit the authentication information PC1 to the second terminal 5 of the designated target individual TA. Accordingly, the controller 51 of the second terminal 5 may acquire the authentication information PC1. In another example, the controller 51 of the second terminal 5 may download the authentication information PC1 from an external computer according to a use relation between the target individual TA and the proxy individual PI occurring (for example, data exchange with the first terminal 4 being started). The controller 51 of the second terminal 5 may acquire the first specific information CA1 of the proxy requesting individual PR together with the authentication information PC1.

In step S305, the controller 51 of the second terminal 5 collates the proxy authentication information AU2 and the authentication information PC1 to perform verification of an agency. When the collation is successful (the verification is successful), the controller 51 of the second terminal 5 may executes, together with the controller 41 of the first terminal 4, the processing in step SA410 and step SB410 and subsequent steps. On the other hand, when the collation is unsuccessful, the controller 51 of the second terminal 5 may urge the first terminal 4 to retransmit the proxy authentication information AU2. When the collation is unsuccessful, the controller 51 of the second terminal 5 may end, as appropriate, the processing procedure concerning the linking setting. The other processing procedure in the case in which the second method is adopted as the verification method may be the same as the processing procedure in the case in which the first method illustrated in FIG. 13A explained above is adopted.

Note that the processing procedures illustrated in FIGS. 13A and 13B are only examples. The steps may be changed as much as possible. Concerning the processing procedures explained above, steps can be omitted, substituted, and added as appropriate according to an embodiment. For example, the authentication for the second target (the target individual TA) may be omitted. Authentication for the proxy individual PI may be performed by the same method as the method of authenticating the proxy requesting individual PR.

The first identifier I10 of the proxy individual PI may be transmitted from the first terminal 4 or the first server 2 to the management server 1 irrespective of whether the authentication for the proxy individual PI is executed. In an example, the first identifier I10 of the proxy individual PI may be transmitted to the management server 1 in at least one of an authentication route for the first target (step SA410 and step SA420) and an authentication route for the second target (step SB410 and SB420). In response to the transmission, as the setting processing for the correspondence relation between the proxy requesting individual PR and the target individual TA, the management server 1 may generate the linking information D10 further including the first identifier I10 of the proxy individual PI.

A transmission path for the authentication result may not be limited to the examples illustrated in FIGS. 13A and 13B. In another example, the first terminal 4 may receive the authentication result for the target individual TA from the second server 3. The second terminal 5 may receive the authentication result for the proxy requesting individual PR from the first server 2. In response to the reception, the terminals (4 and 5) may transmit a linking demand including the received authentication results for the individuals (PR and TA) to the management server 1. Alternatively, one terminal of the first terminal 4 and the second terminal 5 may perform data exchange of the authentication result with the other terminal. The other terminal may transmit the linking demand including the authentication results for the individuals (PR and TA) to the management server 1.

A transmission path for the first specific information CA1 of the proxy requesting individual PR may be changed as appropriate according to an embodiment. In another example, the second terminal 5 may transmit the authentication request for the proxy requesting individual PR to the first server 2 while the first specific information CA1 of the proxy requesting individual PR remains absent. The first server 2 may demand, in response to the authentication request, the terminal 6 of the proxy requesting individual PR to transmit the first specific information CA1. The terminal 6 may acquire the first specific information CA1 as appropriate and transmit the first specific information CA1 to the first server 2. Accordingly, the first server 2 may acquire the first specific information CA1 used for the authentication for the proxy requesting individual PR.

### (B) Second Authentication Method

FIG. 14B schematically illustrates an example of a processing process of linking setting in the case in which the second authentication method is adopted. In the example illustrated in FIG. 14B, a scene in which the first method is adopted as the agency verification method and authentication for the proxy requesting individual PR and the target individual TA is performed in the linking setting is assumed. In the second authentication method, the management server 1 requests, in response to a demand from at least one of the first terminal 4 and the second terminal 5, the servers (2 and 3) to perform authentication. That is, the external servers (the first server 2 and the second server 3) perform authentication for the individuals (PR and TA) in response to an authentication request included in a linking demand transmitted from at least one of the first terminal 4 and the second terminal 5. Data (specific information) used for the authentication is the same as the data in the first authentication method. Demands transmitted from the first terminal 4 and the second terminal 5 to the management server 1 are examples of the linking demand including the authentication request.

First, the processing in step S10, step S20, step S301, and step S302 may be executed in the same manner as in the first authentication method. After the second terminal 5 receives the answer indicating approval, at least one of the first terminal 4 and the second terminal 5 transmits, as a linking demand, to the management server 1, an authentication request including the first identifier I10 of the proxy requesting individual PR, the first specific information CA1 of the proxy requesting individual PR, the second identifier I20 of the target individual TA, and the second specific information CA2 of the target individual TA (step SC410 and step SD410). In response to the transmission, the controller 11 of the management server 1 receives the authentication request including the first identifier I10, the first specific information CA1, the second identifier I20, and the second specific information CA2. The processing in step SC410 and step SD410 is an example of the processing in step S40 explained above.

Sharing of data transmission may be determined as appropriate according to an embodiment. In an example, the second terminal 5 may take charge of the transmission of the first identifier I10 and the first specific information CA1 and the first terminal 4 may take charge of the transmission of the second identifier I20 and the second specific information CA2. For example, in one of step S20 and step S302, the controller 51 of the second terminal 5 may acquire the first identifier I10 and the first specific information CA1 of the proxy requesting individual PR. In step SC410, the controller 51 of the second terminal 5 may transmit a linking demand including the acquired first identifier I10 and the acquired first specific information CA1 of the proxy requesting individual PR to the management server 1. On the other hand, in step S20, the controller 41 of the first terminal 4 may acquire the second identifier I20 and the second specific information CA2 of the target individual TA from one of the target individual TA and the second terminal 5. In step SD410, the controller 41 of the first terminal 4 may transmit a linking demand including the acquired second identifier I20 and the acquired second specific information CA2 of the target individual TA to the management server 1.

Note that the sharing of the data transmission may not be limited to such an example. In another example, at least one of the first identifier I10 and the first specific information CA1 may be transmitted from the first terminal 4. At least one of the second identifier I20 and the second specific information CA2 may be transmitted from the second terminal 5. When a form of dividedly transmitting the identifiers and the specific information from the first terminal 4 and the second terminal 5 is adopted, in order to specify a combination of relevant individuals of the first target and the second target actually demanding setting of a correspondence relation, the management server 1 may specify association of data of an authentication request with the method of, for example, using the shared information explained above. In still another example, the first identifier I10, the first specific information CA1, the second identifier I20, and the second specific information CA2 may be transmitted from only one of the first terminal 4 and the second terminal 5.

In step SC420, the controller 11 of the management server 1 transmits the first identifier I10 and the first specific information CA1 in the received data to the first server 2 to request the first server 2 to perform authentication for the proxy requesting individual PR. In response to the request, the controller 21 of the first server 2 may operate as the authentication unit 211, collate the first specific information CA1 and the first registered specific information CA10, and determine, according to a result of the collation, success of authentication for the proxy requesting individual PR. In step SC430, the controller 21 of the first server 2 returns an authentication result for the proxy requesting individual PR to the management server 1.

Similarly, in step SD420, the controller 11 of the management server 1 transmits the second identifier I20 and the second specific information CA2 to the second server 3 to request the second server 3 to perform authentication for the target individual TA. In response to the request, the controller 31 of the second server 3 may operate as the authentication unit 311, collate the second specific information CA2 and the second registered specific information CA20, and determine, according to a result of the collation, success of the authentication for the target individual TA. In step SD430, the controller 31 of the second server 3 transmits an authentication result for the target individual TA to the management server 1.

The controller 11 of the management server 1 receives authentication results for the individuals (PR and TA) from the servers (2 and 3). When both of the authentications for the proxy requesting individual PR and that for the target individual TA are successful in the received authentication results, the controller 11 sets a correspondence relation between the proxy requesting individual PR and the target individual TA. Setting processing for the correspondence relation may be the same as the setting processing in the embodiment explained above. Note that a series of processing from the data exchange between the terminals (4 and 5) to the linking setting may be executed in real time according to occurrence of a use relation. The other components may be the same as the components of the first authentication method.

In the second authentication method, the authentications for the first target and the second target are respectively performed by the first server 2 and the second server 3 according to the use relation occurring between the first target and the second target. According to the two authentications, it can be expected that security is ensured.

FIG. 14B schematically illustrates an example of a processing process of linking setting in the case in which the second authentication method is adopted as the authentication method and the second method explained above is adopted as the agency verification method. When the second authentication method is adopted, the system 100 may adopt the second method as the agency verification method instead of the first method explained above. As in the first authentication method explained above, in step S20, the controller 41 of the first terminal 4 may give the proxy authentication information AU2 to the second terminal 5. At any timing before the processing in step S305 is executed, the controller 51 of the second terminal 5 may acquire the authentication information PC1 according to the processing in step S100. The controller 51 of the second terminal 5 may acquire the first specific information CA1 of the proxy requesting individual PR together with the authentication information PC1. In step S305, the controller 51 of the second terminal 5 collates the proxy authentication information AU2 and the authentication information PC1 to perform verification of an agency. When the collation is successful (the verification is successful), the processing in step SC410 and step SD410 and subsequent steps may be executed. The other procedures may be the same as the procedures in the case of FIGS. 13B and 14A explained above.

Note that the processing procedures illustrated in FIGS. 14A and 14B are only examples. The steps may be changed as much as possible. About the processing procedures explained above, steps can be omitted, substituted, and added as appropriate according to an embodiment. For example, as in the first authentication method explained above, the authentication for the second target (the target individual TA) may be omitted. Authentication for the proxy individual PI may be performed by the same method as the method of the authentication for the proxy requesting individual PR. The management server 1 may generate the linking information D10 further including the first identifier I10 of the proxy individual PI. A transmission path for the first specific information CA1 of the proxy requesting individual PR may be changed as appropriate according to an embodiment. In another example, the first specific information CA1 of the proxy requesting individual PR may be transmitted from the terminal 6 to the first server 2.

A transmission path for the authentication result may not be limited to the examples illustrated in FIGS. 14A to 14B. In another example, the authentication processing for at least one of the first target and the second target may be executed not by the external server but by the management server 1. For example, the management server 1 may retain at least one of the first registered specific information CA10 and the second registered specific information CA20. Alternatively, the management server 1 may make an inquiry with at least one of the first server 2 and the second server 3 to acquire at least one of the first registered specific information CA10 and the second registered specific information CA20. Accordingly, the controller 11 of the management server 1 may operate as the authentication unit 115 and execute the authentication processing for at least one of the first target and the second target.

### (C-1) 3-1-Th Authentication Method

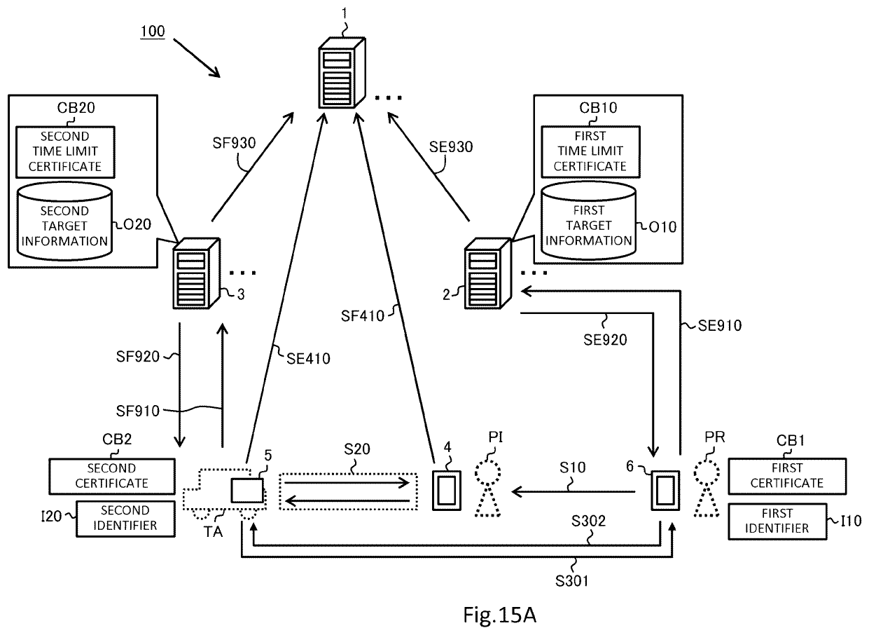

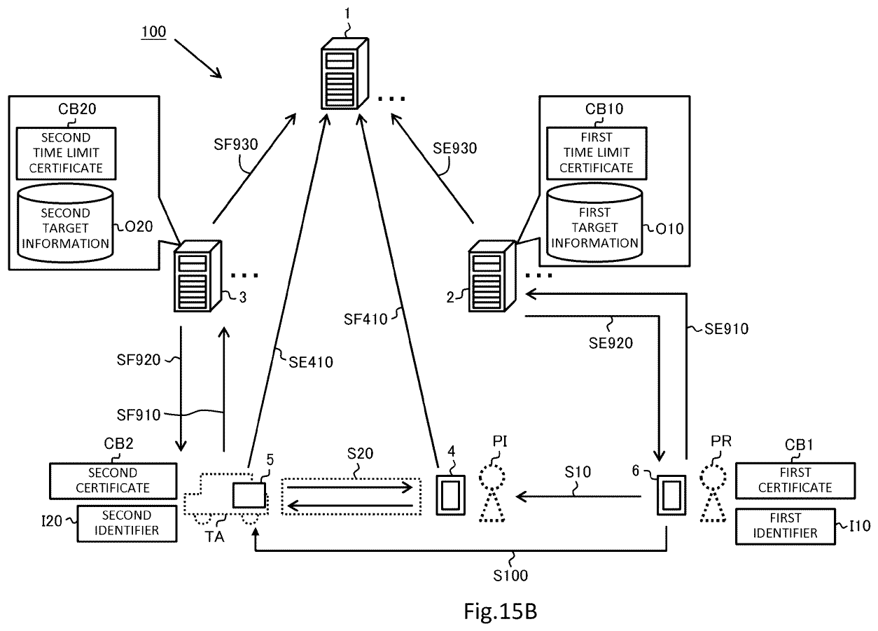

FIG. 15A schematically illustrates an example of a processing process of linking setting in the case in which a 3-1-th authentication method is adopted. In the example illustrated in FIG. 15A, a scene in which the first method is adopted as the agency verification method and authentication for the proxy requesting individual PR and the target individual TA is performed in the linking setting is assumed. In the 3-1-th authentication method, a time limit certificate is used for authentication instead of the specific information. The authentication processing is executed by the management server 1.

The first server 2 is configured to issue a first time limit certificate CB10 to the individuals of the first target. The second server 3 is configured to issue a second time limit certificate CB20 to the individuals of the second target.

The time limit certificates (CB10 and CB20) are configured to expire when an expiration date elapses. If it is possible to control expiration due to the elapse of the expiration date, the configuration of the time limit certificates (CB10 and CB20) may not be particularly limited and may be selected as appropriate according to an embodiment. Any information may be included in the time limit certificates (CB10 and CB20). In an example, the time limit certificates (CB10 and CB20) may be configured by a random number, a timestamp, a hash value, or the like. The time limit certificates (CB10 and CB20) may be configured by temporary information such as a one-time password.

The expiration date of the time limit certificates (CB10 and CB20) may be managed as appropriate. The expiration due to the elapse of the expiration date may be specified as appropriate. For example, according to an expiration date set by the time limit certificate having elapsed, a time limit certificate being added to an expiration list, the time limit certificate being deleted from an effective list, the time limit certificate being updated to a new time limit certificate, or information indicating expiration (for example, a timestamp) being imparted, it may be specified whether the target time limit certificate has been expired. When reference information such as the expiration list or the effective list is used for the management of the expiration date, the reference information may be stored in any storage device accessible from the system 100. Typically, reference information of the time limit certificates (CB10 and CB20) may be stored in the servers (2 and 3).

First, in step SE910, in relation to the first identifier I10 of the proxy requesting individual PR, the controller 61 of the terminal 6 of the proxy requesting individual PR transmits a request for issuance of the first time limit certificate CB10 to the first server 2. In response to reception of the request, the controller 21 of the first server 2 issues the first time limit certificate CB10 in relation to the first identifier I10. In step SE920, the controller 21 of the first server 2 returns the issued first time limit certificate CB10 to the terminal 6. In response to the return, the terminal 6 receives the issued first time limit certificate CB10 from the first server 2. The controller 61 of the terminal 6 stores the received first time limit certificate CB10 to be usable as a first certificate CB1. In step SE930, the controller 21 of the first server 2 notifies the issued first time limit certificate CB10 to the management server 1 as well. The controller 21 may notify the first time limit certificate CB10 with the first identifier I10 attached thereto.

Similarly, in step SF910, in relation to the second identifier I20 of the target individual TA, the controller 51 of the second terminal 5 of the target individual TA transmits a request for issuance of the second time limit certificate CB20 to the second server 3. In response to reception of the request, the controller 31 of the second server 3 issues the second time limit certificate CB20 in relation to the second identifier I20. In step SF920, the controller 31 of the second server 3 returns the issued second time limit certificate CB20 to the second terminal 5. In response to the return, the second terminal 5 receives the issued second time limit certificate CB20 from the second server 3. The controller 51 of the second terminal 5 stores the received second time limit certificate CB20 to be usable as a second certificate CB2. In step SF930, the controller 31 of the second server 3 notifies the issued second time limit certificate CB20 to the management server 1 as well. The controller 31 may notify the second time limit certificate CB20 with the second identifier I20 attached thereto.

The processing in step S10, step S20, step S301, and step S302 may be executed in the same manner as the processing in the first authentication method and the like explained above. After the second terminal 5 receives the answer indicating approval, at least one of the first terminal 4 and the second terminal 5 transmits, as a linking demand, an authentication request including the first certificate CB1 of the proxy requesting individual PR and the second certificate CB2 of the target individual TA to the management server 1 (step SE410 and step SF410). In response to the transmission, the management server 1 receives the first certificate CB1 corresponding to the first time limit certificate CB10 and the second certificate CB2 corresponding to the second time limit certificate CB20. The processing in step SE410 and step SF410 is an example of the processing in step S40 explained above. The demand transmitted from at least one of the first terminal 4 and the second terminal 5 is an example of the linking demand including the authentication request.

Sharing of data transmission may be determined as appropriate according to an embodiment. In an example, the second terminal 5 may take charge of the transmission of the first certificate CB1 of the proxy requesting individual PR and the first terminal 4 may take charge of the transmission of the second certificate CB2 of the target individual TA. That is, in step SE410, the controller 51 of the second terminal 5 may transmit a linking demand including the first certificate CB1 of the proxy requesting individual PR to the management server 1. In step SF410, the controller 41 of the first terminal 4 may transmit a linking demand including the second certificate CB2 of the target individual TA to the management server 1.

However, the sharing of the data transmission may not be limited to the example explained above. In another example, the first certificate CB1 may be transmitted from the first terminal 4. The second certificate CB2 may be transmitted from the second terminal 5. The identifiers (I10 and I20) of the individuals (PR and TA) may be transmitted to the management server 1 together with the certificates (CB1 and CB2). In this case, the identifiers (I10 and I20) and the certificates (CB1 and CB2) are examples of data used for authentication. The identifiers (I10 and I20) may be transmitted from at least one of the first terminal 4 and the second terminal 5. When a form of dividedly transmitting the identifiers and the certificates from the first terminal 4 and the second terminal 5 is adopted, in order to specify a combination of relevant individuals of the first target and the second target actually demanding setting of a correspondence relation, the management server 1 may specify association of data of an authentication request with a method of, for example, using the shared information. In still another example, the first certificate CB1 and the second certificate CB2 may be transmitted only from one of the first terminal 4 and the second terminal 5.

Note that the terminals (4 and 5) may acquire the certificates (CB1 and CB2) as appropriate. When the second terminal 5 transmits the first certificate CB1 of the proxy requesting individual PR, the second terminal 5 may acquire the first certificate CB1 together with the answer of approval in step S302 or may acquire the first certificate CB1 via the first terminal 4 according to step S10 and step S20. When the first terminal 4 transmits the first certificate CB1 of the proxy requesting individual PR, the first terminal 4 may acquire the first certificate CB1 together with the authority imparting information AG in step S10 or may acquire the first certificate CB1 via the second terminal 5 according to step S302 and step S20. When the first terminal 4 transmits the second certificate CB2 of the target individual TA, the first terminal 4 may acquire the second certificate CB2 from the second terminal 5 in step S20.

The controller 11 of the management server 1 operates as the authentication unit 115 and collates the received first certificate CB1 and the first time limit certificate CB10 notified from the first server 2. The controller 11 of the management server 1 operates as the authentication unit 115 and collates the received second certificate CB2 and the second time limit certificate CB20 notified from the server 3. The controller 11 may specify, as appropriate, association of data to be collated. The specifying association of data to be collated is discriminating a combination of the first time limit certificate CB10 and the first certificate CB1 to be collated and a combination of the second time limit certificate CB20 and the second certificate CB2 to be collated. Like the association of the data of the authentication request, the controller 11 may specify, with a method of, for example, using the shared information, the association of the data to be collated. The shared information may be the identifiers (I10 and I20).

A method of collating a certificate and a time limit certificate may be selected as appropriate according to a relation between the certificate and the time limit certificate. In an example, the time limit certificates (CB10 and CB20) may be directly used as the certificates (CB1 and CB2). In this case, success of the collation in the authentication may be determined according to whether the time limit certificates (CB10 and CB20) and the certificates (CB1 and CB2) coincide. In another example, the time limit certificates (CB10 and CB20) may be optionally converted and the time limit certificates (CB10 and CB20) after the conversion may be used as the certificates (CB1 and CB2). In this case, success of the collation in the authentication may be determined according to whether a predetermined relationship is established between the time limit certificates (CB10 and CB20) and the certificates (CB1 and CB2). For example, the first time limit certificate CB10 may be converted into a hash value and the obtained hash value may be used as the first certificate CB1. Accordingly, whether the relationship is established may be determined according to whether the hash value of the first time limit certificate CB10 and the first certificate CB1 coincide. The conversion may include data operation such as deletion and addition. At least one of the first time limit certificate CB10 and the second time limit certificate CB20 may be directly used as a certificate and the other may be used as a certificate after being converted. Note that the conversion processing may be executed by the terminals (4, 5, and 6) or may be executed by the servers (2 and 3). When the conversion processing is executed by the servers (2 and 3), the terminals (5 and 6) may receive the time limit certificates (CB10 and CB20) after the conversion from the servers (2 and 3).

The controller 11 of the management server 1 may determine success of the authentications for the individuals (PR and TA) according to results of the collations. When the collations are unsuccessful, the authentications are unsuccessful. When the first time limit certificate CB10 and the second time limit certificate CB20 have expired because the expiration date has elapsed, the collations of the first target and the second target are unsuccessful. On the other hand, when the first time limit certificate CB10 and the second time limit certificate CB20 are effective and the collations are successful, both of the authentications of the proxy requesting individual PR and the target individual TA are successful. When both of the authentications of the proxy requesting individual PR and the target individual TA are successful, the controller 11 of the management server 1 sets a correspondence relation between the proxy requesting individual PR and the target individual TA. Setting processing for the correspondence relation may be the same as the setting processing in the embodiment explained above. Note that a series of processing from the data exchange between the terminals (4 and 5) to the linking setting may be executed in real time according to occurrence of a use relation. The other components may be the same as the components of the first authentication method and the like.

In the 3-1-th method, the respective authentications of the first target and the second target are performed using the time limit certificates (CB10 and CB20) according to the use relation occurring between the first target and the second target. The time limit certificates (CB10 and CB20) are configured to expire when the expiration date expires. For that reason, it is possible to prevent the same certificate from being permanently used. Accordingly, it can be expected that security is ensured.

FIG. 15B schematically illustrates a processing process of linking setting in the case in which the 3-1-th authentication method is adopted as the authentication method and the second method is adopted as the agency verification method. When the 3-1-th authentication method is adopted, the system 100 may adopt the second method as the agency verification method instead of the first method explained above. As in the first authentication method and the like explained above, in step S20, the controller 41 of the first terminal 4 may give the proxy authentication information AU2 to the second terminal 5. At any timing before the processing in step S305 is executed, the controller 51 of the second terminal 5 may acquire the authentication information PC1 according to the processing in step S100. The controller 51 of the second terminal 5 may acquire the first certificate CB1 of the proxy requesting individual PR together with the authentication information PCI. In step S305, the controller 51 of the second terminal 5 collates the proxy authentication information AU2 and the authentication information PC1 to perform verification of an agency. When the collation is successful (the verification is successful), the processing in step SE410 and step SF410 and subsequent steps may be executed. The other procedures may be the same as the procedures in the case of FIG. 15A explained above.

Note that the processing procedures illustrated in FIGS. 15A and 15B are only examples. The steps may be changed as much as possible. Concerning the processing procedures explained above, steps can be omitted, substituted, and added as appropriate according to an embodiment. For example, as in the first authentication method and the like explained above, the authentication for the second target (the target individual TA) may be omitted. The authentication for the proxy individual PI may be performed by the same method as the method of authenticating the proxy requesting individual PR. The management server 1 may generate the linking information D10 further including the first identifier I10 of the proxy individual PI.

The time limit certificates (CB10 and CB20) do not always have to be issued in response to the request (a demand) from the terminals (4 and 5). The servers (2 and 3) may spontaneously generate the time limit certificates (CB10 and CB20). In this case, the processing in step SE910 and step SF910 may be omitted. The issuance of the time limit certificates (CB10 and CB20) (step SE910 to step SE930 and step SF910 to step SF930) may be executed at any timing before the request for the linking setting (step SE410 and step SF410). In an example, the issuance of the time limit certificates (CB10 and CB20) may be executed beforehand before the data exchange between the first terminal 4 and the second terminal 5 is executed (step S20). In another example, the issuance of the time limit certificates (CB10 and CB20) may be executed at timing before the linking demand is transmitted after the data exchange between the first terminal 4 and the second terminal 5 is started. From the viewpoint of reducing processes in the linking setting, the issuance of the time limit certificates (CB10 and CB20) is preferably executed at the former timing.

In the 3-1-th authentication method explained above, the collation processing for the certificates (CB1 and CB2) and the time limit certificates (CB10 and CB20), that is, the authentication processing for the targets is executed by the management server 1. However, an entity that executes the collation processing may not be limited to the management server 1. In another example, the management server 1 may transmit the certificates (CB1 and CB2) to the servers (2 and 3) to request the servers (2 and 3) to perform the collation processing. Accordingly, the collation processing may be executed by the servers (2 and 3). That is, the authentication processing for at least one of the first target and the second target may be executed by the external server. In an example, the controller 21 of the first server 2 may operate as the authentication unit 211 and collate the first certificate CB1 and the first time limit certificate CB10 received from the management server 1 to determine success of the authentication for the first target. The controller 21 may return the authentication result for the first target to the management server 1. The controller 31 of the second server 3 may operate as the authentication unit 311 and collate the second certificate CB2 and the second time limit certificate CB20 received from the management server 1 to determine success of the authentication for the second target. The controller 31 may return the authentication result for the second target to the management server 1. In this case, the notification of the time limit certificates (CB10 and CB20) (step SE930 and step SF930) may be omitted. In another example, the management server 1 may execute the authentication processing for at least one of the first target and the second target and the external server may execute the authentication processing for the other.

The transmission path for the first certificate CB1 of the proxy requesting individual PR may be changed as appropriate according to an embodiment. In another example, at least one of the first terminal 4 and the second terminal 5 may transmit the authentication request for the proxy requesting individual PR to the management server 1 while the first certificate CB1 of the proxy requesting individual PR remains absent. The management server 1 may directly or indirectly demand, via the external server such as the first server 2, the terminal 6 to transmit the first certificate CB1. The terminal 6 may directly or indirectly transmit the first certificate CB1 to the management server 1 in response to the demand. In this way, the management server 1 may acquire the first certificate CB1 used for the authentication for the proxy requesting individual PR.

### (C-2) 3-2-Th Authentication Method

In the 3-1-th authentication method explained above, the authentication processing for the individuals (PR and TA) is executed in the management server 1 in response to the linking demand by at least one of the first terminal 4 and the second terminal 5. However, timing for executing the authentication processing may not be limited to such an example. In a 3-2-th authentication method, as a trigger for transmitting a linking demand to the management server 1, authentication processing for at least one of the proxy requesting individual PR and the target individual TA may be executed between the management server 1 and at least one of the first server 2 and the second server 3 by at least one of the first terminal 4 and the second terminal 5.

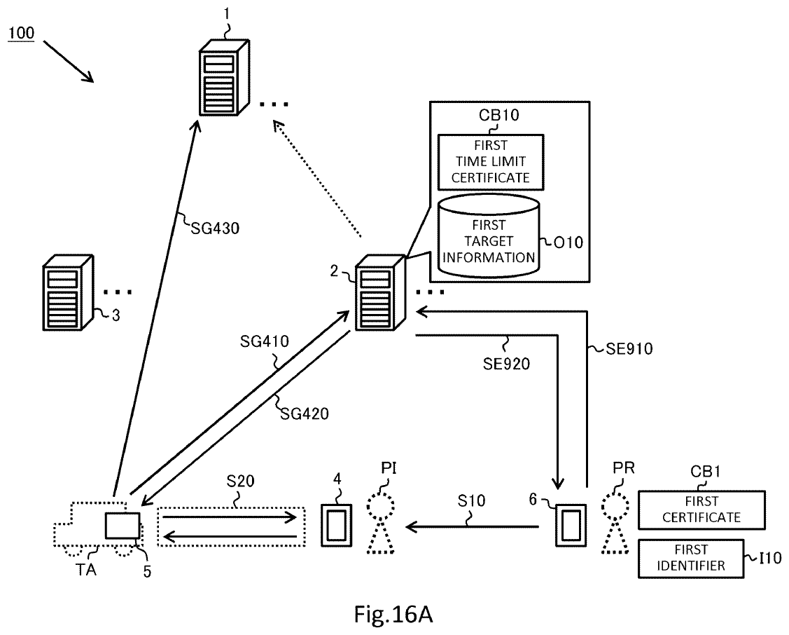

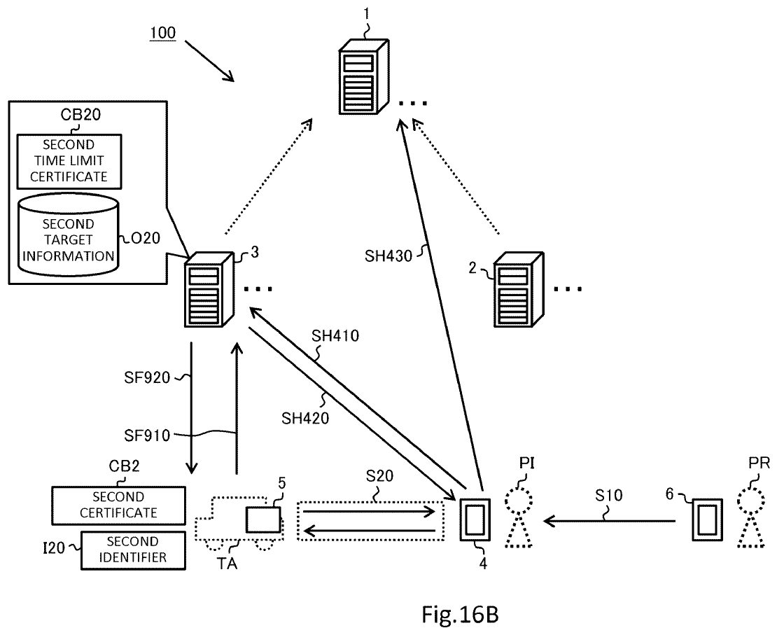

FIG. 16A schematically illustrates an example of a processing process of linking setting in the case in which the 3-2-th authentication method is adopted. FIG. 16A assumes a scene in which authentication processing for the first target (the proxy requesting individual PR) is executed.

First, the processing in step SE910 and step SE920 may be executed between the terminal 6 and the first server 2 in the same manner as the processing in the 3-1-th authentication method explained above. As a result of the execution, the first time limit certificate CB10 is issued and the issued first time limit certificate CB10 is notified to the terminal 6. At this time, the first server 2 may store the issued first time limit certificate CB10 in correlation with the first identifier I10. The first time limit certificate CB10 may be stored as the first target information O10. The notification to the management server 1 (step SE930) may be omitted. The processing in step S10, step S20, and step S30 may be executed in the same manner as the processing in the 3-1-th authentication method explained above. Whichever of the first method and the second method may be adopted as the agency verification method. Accordingly, the second terminal 5 acquires the first identifier I10 and the first certificate CB1.

In step SG410, the controller 51 of the second terminal 5 transmits an authentication request including the first identifier I10 and the first certificate CB1 to the first server 2. In response to reception of the authentication request, the controller 21 of the first server 2 operates as the authentication unit 211 and collates the received first certificate CB1 and the first time limit certificate CB10 corresponding thereto. The corresponding first time limit certificate CB10 may be acquired as appropriate. In an example, the issued first time limit certificate CB10 may be stored as the first target information O10. The controller 21 of the first server 2 may search through the first target information O10 using the first identifier 110 as a query to extract the first time limit certificate CB10 corresponding to the first identifier I10. In step SG420, the controller 21 of the first server 2 returns a result of the collation to the second terminal 5. In response to the return, the controller 51 of the second terminal 5 receives the result of the collation.

When the collation of the first certificate CB1 and the first time limit certificate CB10 is unsuccessful in the received result of the collation, the controller 51 of the second terminal 5 may end the processing procedure of the linking setting as appropriate. In an example, the controller 51 may demand the terminal 6 to retransmit the first certificate CB1. On the other hand, when the collation is successful, the controller 51 transmits a linking demand including the first identifier 110 and the second identifier I20 to the management server 1 (step SG430). The processing in step SG410, step SG420, and step SG430 is an example of the processing in step S40 and step S45 explained above.

In response to the transmission, the management server 1 receives the linking demand from the second terminal 5. The controller 11 of the management server 1 sets a correspondence relation between the first target (the proxy requesting individual PR) and the second target (the target individual TA) in response to the linking demand. The setting processing for the correspondence relation may be the same as the setting processing in the embodiment. Note that a series of processing from the data exchange between the terminals (4 and 5) to the linking setting may be executed in real time according to occurrence of a use relation. The other components may be the same as the components of the first authentication method and the like.

Note that an authentication target by the 3-2-th authentication method may not be limited to the first target. The second target may be authenticated by the same method.

FIG. 16B schematically illustrates another example of the processing process for the linking setting in the case in which the 3-2-th authentication method is adopted. FIG. 16B assumes a scene in which authentication processing for the second target (the target individual TA) is executed. The processing procedure illustrated in FIG. 16B may be the same as the processing procedure illustrated in FIG. 16A except that the first target and the second target are changed and the processing concerning the proxy is omitted.

That is, the processing in step SF910 and step SF920 is executed between the second terminal 5 and the second server 3, whereby the second time limit certificate CB20 is issued and the issued second time limit certificate CB20 is notified to the second terminal 5. In step S20, the controller 51 of the second terminal 5 gives the issued second time limit certificate CB20 to the first terminal 4 as the second certificate CB2. The controller 51 of the second terminal 5 gives the second identifier I20 to the first terminal 4. In step SH410, the controller 41 of the first terminal 4 transmits an authentication request including the second identifier I20 and the second certificate CB2 to the second server 3. In response to the transmission, the controller 31 of the second server 3 operates as the authentication unit 311 and executes collation processing for the second certificate CB2 and the second time limit certificate CB20. In step SH420, the controller 31 of the second server 3 returns a result of the collation to the first terminal 4. When the collation of the second certificate CB2 and the second time limit certificate SB20 is successful in the result of the collation, the controller 41 of the first terminal 4 transmits a linking demand including the first identifier I10 and the second identifier I20 to the management server 1 (step SH430). In response to the transmission, the management server 1 receives the linking demand from the first terminal 4. The controller 11 of the management server 1 sets a correspondence relation between relevant individuals of the first target (the proxy requesting individual PR) and the second target (the target individual TA) in response to the linking demand.

In the 3-2-th authentication method, the authentication processing is executed before the linking demand. Accordingly, a processing load of the management server 1 can be reduced. A processing time from the linking demand to the setting processing can be reduced.

Note that the processing procedures illustrated in FIGS. 16A and 16B are only examples and may be changed as much as possible. Concerning the processing procedures explained above, steps can be omitted, substituted, and added as appropriate according to an embodiment. Processing order of the authentication for the first target and the authentication for the second target may not be particularly limited and may be determined as appropriate according to an embodiment.

In the processing procedure illustrated in FIG. 16A, the management server 1 may verifies, as appropriate, that the collation is successful in the first server 2. In an example, the first server 2 may transmit a result of the collation to the management server 1 as well. For example, the second identifier I20 may be further included in the authentication request. When the collation is successful, the first server 2 may transmit a result of the collation including the first identifier I10 and the second identifier I20 to the management server 1. In response to the transmission, the first server 2 may cause the management server 1 to enable a linking demand for a combination of the first identifier I10 and the second identifier 120 designated by the result of the collation. That is, in an example, the verification of the collation success may be configured by the reception of the collation result. The management server 1 may be configured to retain the result of the collation transmitted from the first server 2, accept a request for linking setting to a combination of the first identifier I10 and the second identifier I20 designated by the result of the collation, and reject a request for linking setting other than the request. Similarly, in the processing procedure illustrated in FIG. 16B, the management server 1 may verify, as appropriate, that the collation is successful in the second server 3.

In the processing procedures illustrated in FIGS. 16A and 16B, the servers (2 and 3) may not return the authentication result to the terminals (4 and 5) but may transmit the authentication result to the management server 1. This transmission form is an example of a form of transmitting the linking demand to the management server 1 through the external server and a form of executing the authentication processing together with the linking demand.

### 5 Supplement

The processing and the means explained in the present disclosure can be freely combined and carried out as long as a technical contradiction does not occur.

The processing explained as being performed by one device may be shared and executed by a plurality of devices. Alternatively, the processing explained as being performed by different devices may be executed by one device. In a computer system, it is possible to flexibly change what kinds of hardware are used to implement respective functions.

The present disclosure can also be implemented by supplying a computer program implemented with the functions explained in the embodiment to a computer and one or more processors included in the computer reading out and executing the program. Such a computer program may be provided to the computer by a non-transitory computer-readable storage medium connectable to a system bus of the computer or may be provided to the computer via a network. The non-transitory computer-readable storage medium includes, for example, disks/discs of any types such as a magnetic disk (a floppy (registered trademark) disk, a hard disk drive (HDD), and the like), and an optical disc (a CD-ROM, a DVD disc, a Blu-ray disc, and the like), a read only memory (ROM), a random access memory (RAM), an EPROM, an EEPROM, a magnetic card, a flash memory, an optical card, a semiconductor drive (a solid state drive and the like), and a medium of any type suitable for storing an electronic instruction.

1. A system comprising:
a management server;
a first terminal of a proxy individual of a first target; and
a second terminal of a target individual of a second target, wherein
the first terminal is configured to:
receive, from a terminal of a proxy requesting individual of the first target, authority imparting information for notifying imparting of an agency;
perform data exchange between the first terminal and the second terminal when a use relation occurs between the proxy individual and the target individual; and
give authority verification information to the second terminal in the data exchange to request verification of the agency,
the second terminal is configured to verify the agency using the authority verification information in response to the request from the first terminal,
at least one of the first terminal and the second terminal is configured to transmit a linking demand including an authentication request for the proxy requesting individual toward the management server according to success of the verification by the second terminal, and
the management server is configured to set, according to authentication for the proxy requesting individual responding to the authentication request being successful, a correspondence relation between the proxy requesting individual and the target individual to thereby enable proxy exercise of an authority of the proxy requesting individual by the proxy individual via the target individual.

2. The system according to claim 1, wherein
an expiration date is set for the agency, and
the management server is further configured to release the correspondence relation between the proxy requesting individual and the target individual according to arrival of the expiration date.

3. The system according to claim 1, wherein
an effective authority is set for the agency, and
the management server is further configured to release a correspondence relation between the proxy requesting individual and the target individual according to exercise or extinction of the effective authority by the proxy individual.

4. The system according to claim 1, wherein the management server is further configured to release the correspondence relation between the proxy requesting individual and the target individual in response to reception of a release demand from the terminal of the proxy requesting individual.

5. The system according to claim 1, wherein the management server is further configured to release the correspondence relation between the proxy requesting individual and the target individual according to a correspondence relation between the proxy requesting individual and another individual of the second target being set by the proxy requesting individual.

6. The system according to claim 1, wherein
the authority verification information includes a contact that executes approval processing, and
the verifying the agency is configured by:
making an inquiry with the contact included in the authority verification information; and
receiving an answer of approval as an execution result of the approval processing.

7. The system according to claim 1, wherein
the second terminal is further configured to receive notification of authentication information from the terminal of the proxy requesting individual,
the authority verification information includes proxy authentication information corresponding to the authentication information, and
the verifying the agency is configured by collating the proxy authentication information included in the authority verification information and the authentication information notified from the terminal of the proxy requesting individual.

8. The system according to claim 1, wherein the transmitting the linking demand toward the management server is configured by directly transmitting the linking demand to the management server or indirectly transmitting the linking demand to the management server via an external server.

9. The system according to claim 1, wherein success of authentication responding to the authentication request is determined by the management server or an external server.

10. The system according to claim 1, wherein the data exchange is performed by short-range wireless communication.

11. The system according to claim 1, wherein
the first terminal includes a positioning module,
the first terminal is further configured to:
measure a current position of the first terminal with the positioning module of the first terminal; and
transmit a measurement result of the current position of the first terminal toward the management server,
the second terminal includes a positioning module,
the second terminal is further configured to:
measure a current position of the second terminal with the positioning module of the second terminal; and
transmit a measurement result of the current position of the second terminal toward the management server, and
the management server is further configured to:
after setting the correspondence relation between the proxy requesting individual and the target individual, receive the measurement results of the current positions of the first terminal and the second terminal from the first terminal and the second terminal;
determine, in real time, whether the received measurement results of the current positions of the first terminal and the second terminal satisfy a condition of the use relation; and
when the measurement results of the current positions of the first terminal and the second terminal satisfy the condition of the use relation, maintain the setting of the correspondence relation between the proxy requesting individual and the target individual and, otherwise, release the correspondence relation.

12. The system according to claim 1, wherein
the first target is a user,
the proxy individual of the first target is a proxy user,
the proxy requesting individual of the first target is a proxy requesting user, and
the second target is an object to be used by the user.

13. The system according to claim 12, wherein the object to be used is a mobile body.

14. A non-transitory storage medium storing a program for causing a first terminal of a proxy individual of a first target to execute:
receiving, from a terminal of a proxy requesting individual of the first target, authority imparting information for notifying imparting of an agency;
performing data exchange between the first terminal and a second terminal of a target individual of a second target when a use relation occurs between the proxy individual and the target individual;
giving authority verification information to the second terminal in the data exchange to request verification of the agency; and
transmitting, according to success of the verification by the second terminal, a linking demand including an authentication request for the proxy requesting individual toward a management server, transmitting the linking demand in cooperation with the second terminal, or causing the second terminal to transmit the linking demand to thereby cause the management server to set, according to authentication for the proxy requesting individual responding to the authentication request being successful, a correspondence relation between the proxy requesting individual and the target individual to enable proxy exercise of an authority of the proxy requesting individual by the proxy individual via the target individual.

15. The non-transitory storage medium according to claim 14, wherein at least one of an expiration date and an effective authority is set for the agency.

16. The non-transitory storage medium according to claim 14, wherein the authority verification information includes a contact that executes approval processing or proxy authentication information used for the verification.

17. A non-transitory storage medium storing a program for causing a second terminal of a target individual of a second target to execute:
performing data exchange between the second terminal and a first terminal of a proxy individual of a first target when a use relation occurs between the proxy individual and the target individual;
receiving a request for verification of an agency involving authority verification information from the first terminal in the data exchange;
verifying the agency using the authority verification information in response to the request from the first terminal; and
transmitting, according to success of the verification, a linking demand including an authentication request for the proxy requesting individual toward a management server, transmitting the linking demand in cooperation with the first terminal, or causing the first terminal to transmit the linking demand to thereby cause the management server to set, according to authentication for the proxy requesting individual responding to the authentication request being successful, a correspondence relation between the proxy requesting individual and the target individual to enable proxy exercise of an authority of the proxy requesting individual by the proxy individual via the target individual.

18. The non-transitory storage medium according to claim 17, wherein at least one of an expiration date and an effective authority is set for the agency.

19. The non-transitory storage medium according to claim 17, wherein
the authority verification information includes a contact that executes approval processing, and
the verifying the agency is configured by:
making an inquiry with the contact included in the authority verification information; and
receiving an answer of approval as an execution result of the approval processing.

20. The non-transitory storage medium according to claim 17, further causing the second terminal to receive notification of authentication information from a terminal of the proxy requesting individual, wherein
the authority verification information includes proxy authentication information corresponding to the authentication information, and
the verifying the agency is configured by collating the proxy authentication information included in the authority verification information and the authentication information notified from the terminal of the proxy requesting individual.
